(19) United States
(12) Patent Application Publication
(10) Pub. No.: US 2019/0019179 A1
(43) Pub. Date: Jan. 17, 2019

(54) Vpew digital wallet

(71) Applicants: Amon Rweyemamu Mtaza, Seattle, WA (US); Bruno Real Choiniere, Granby (CA); Eugene Siima Mtaza, Seattle, WA (US)

(72) Inventors: Amon Rweyemamu Mtaza, Seattle, WA (US); Bruno Real Choiniere, Granby (CA); Eugene Siima Mtaza, Seattle, WA (US)

(21) Appl. No.: 15/731,642

(22) Filed: Jul. 11, 2017

(51) Int. Cl. G06Q 20/36; G06Q 20/40

(52) U.S. Cl. CPC G06Q 20/3674; G06Q 20/4012; G06Q 20/4016; G06Q 20/367

(57) ABSTRACT

A versatile-customizable-security-enhanced digital wallet operated through a mobile electronic device (or non-mobile electronic device) operative to receive, from any sources, save, store, maintain, create, edit, manage, and allow the retrieval, displaying, and sharing of, various data and forms of enhancement and data thereof; to process and execute applications using the data and forms of enhancement and data thereof saved, stored, and maintained therein; and to protect the data saved, stored, and maintained therein and funds thereof.

### FIELD OF THE INVENTION

The present invention relates generally to digital wallets, and more particularly, to applications and enhancements to digital wallets.

### DESCRIPTION OF PRIOR ART

In today's electronic commerce (e-commerce) environment, various ways have been proposed to provide security in financial and non-financial transactions made over the Internet, especially with respect to users' banking, bill payments, purchase of goods and services, filing IRS tax returns and receiving refunds, filing insurance applications and claims, and the like.

In addition to provide security measures for financial and non-financial transactions, various schemes have been proposed and implemented that make it easier for a user to provide his means of identification and account information to an outside source.

One particular scheme is known as a “Digital Wallet”. A digital wallet is a software component, typically consisting of various sub-component software components, modules and/or the like, that allow a user to make an electronic payment with a financial instrument (such as a credit card or digital money) typically during an e-commerce transaction, and hide the low-level details of executing the payment protocol that is used to make payment.

The digital wallet may also have other functionalities that allow a user to provide shipping information, personal information, and other information to an outside source, which is necessary for the consummation of the transaction.

The software component is preferably an encryption software.

The digital wallet can thus hold a user's payment information, a digital certification to identify the user, shipping/address information, and the like to speed transaction processing.

The user benefits because his information is encrypted against piracy and because the digital wallet may automatically input shipping information at the outside source's site, as well as give the user the choice of which financial instrument to use.

This scheme provides a benefit to both the user and the outside source in many respects as the prevention of aggravated identity theft and fraud, and overall ease the transaction.

Most digital wallets reside on the user's personal computer (PC) or other web-enabled devices. Current browsers for PCs and other web-enabled devices now support digital wallets. However, this is not necessary. Thus, digital wallets may reside on a remote (i.e. non-user owned/operated) server, such as a financial entity server, a digital wallet company server, and/or the like.

It has been shown above that digital wallets offer various advantages and/or benefits over other forms of performing financial and non-financial transactions over the internet. However, the functionality of the use of digital wallets has been so far focused on e-commerce transactions with e-retailers, when more extensive functionalities with respect to the use of other applications and enhancements through digital wallets are left to be developed and integrated to reach areas beyond e-commerce transactions with e-retailers, such as to also protect financial and government entities against aggravated identity theft and fraud, where as much as a billion of dollars is presently annually lost due to the later.

It is thus an object of this invention to provide additional functionalities and enhancements to a digital wallets.

### SUMMARY OF THE DISCLOSURE

The present invention is a versatile, customizable, and security enhanced digital wallet, which is operative to provide a wide range of functionalities and enhancements; to allow the digital wallet to adapt to society changes and to be customized to meet each user's needs; and to protect the users from aggravated identity theft, fraud, and damages thereof.

In a first form, a digital wallet is operative to generate a Default Digital Wallet Account number using a Unique Personal Identification Number (UPIN), such as an individual's Social Security Number (SSN), an Employer Identification Number (EIN), any other number assigned to an individual or an otherwise entity by a government body, any other number generated by the Digital Wallet Company Server (DWCS) that is unique to an individual or an otherwise entity, and/or the like, for the purpose of the said account to be used, among other transaction functionalities, as the sole destination of deposits of funds in a user's digital wallet.

In a second form, a digital wallet is operative to generate a Digital Wallet Number, which is assigned by the DWCS to a specific digital wallet, for the purpose to be used to locate and connect with a specific user's digital wallet with respect to the various functionalities of this invention.

In a third form, a digital wallet is operative to require a user to set up a “Default Mobile Electronic Device (or non-mobile electronic device)” (MED), for the purpose to be used, among other communicative functionalities, as the sole destination of all security alert messages transmitted as part of the the functionalities of this invention.

In a fourth form, a digital wallet is operative to manage and administer each user's funds held in the user's Default digital wallet account by connecting and interacting with a Fund Account Software Component operating within and/or outside of the fund account software system of a financial entity, typically a bank.

In a fifth form, a digital wallet is operative to implement security protocols, for the purpose of protecting a user from an unauthorized person intruding his digital wallet, by:
(a) verifying a new user's identification information before setting up a digital wallet number and default digital wallet account number and accessing a digital wallet;
(b) requiring a user to identify himself using Secondary Identification Parameters (SIP), such as 3 specific questions, fingerprints, photo, and the like:
   (1) when a user forgets his user name, password and/or Personal Identification Number (PIN);
   (2) before being allowed to change his user name, password, PIN, and/or SIP;
   (3) before running the edit application and being allowed to edit any data within his digital wallet;
   (4) before being allowed to import any data;
   (5) before being allowed to access the server's emergency digital wallet access, freeze, and change of user name, password, PIN and SIP;
(c) alerting a user of his digital wallet being about to be accessed and requiring the user to authorize such access before allowing the user to access his digital wallet;
(d) requiring a user to contact the Digital Wallet Company Server (DWCS) customer service to verify his identity, when the user has forgotten his user name, password, PIN and SIP;
(e) requiring all data imports of identification, licensing and certification instruments to be temporarily held in a storage component awaiting for the user to verify, authorize, save and store the data in the appropriate subcomponent or delete it;
(f) alerting a user that the export of an identification, licensing or certification instrument from his digital wallet is in the process of being executed, and requiring the user to verify and authorize said export, before its execution;
(g) alerting a user that a deposit and transfer of funds is in the process of being executed, and requiring the user to verify and authorize the said transaction, before its execution;
(h) requiring financial and government entity users to verify a user's identity before transferring any funds into the said user's default digital wallet account;
(i) allowing a user to access the DWCS' Emergency Digital Wallet Access, Freeze, and Change of User Name, Password, PIN and/or SIP, when the user is alerted of an intruder having stolen his log-in information and gained access to his digital wallet without his authorization, and in case where the user has lost his default MED and change his default MED if lost;
(j) alerting a user of any fund transaction occurring within and outside of the network of this invention.

In a sixth form, a digital wallet is operative to process an application allowing a user to customize his digital wallet, whether the user is an individual, a company (including financial and government entities), or an individual or entity, who chooses not to provide a UPIN, by activating or deleting specific application(s) and/or subcomponent(s), and activating multiple subcomponent(s) of the same sort.

In a seventh form, a digital wallet is operative to process various applications, which allow a user:
(a) to receive from various sources, create, edit, manage, and allow the retrieval, displaying and sharing of:
   (1) personal data and others;
   (2) identification instruments and data thereof;
   (3) license and certification instruments and data thereof;
   (4) financial instruments and data thereof;
   (5) receipt and confirmation of transactions and data thereof;
   (6) discount coupons and data thereof;
(b) to receive funds from and transfer funds to another user and a non-user of this invention, manage the funds thereof and allow the retrieval, displaying and sharing of the data of all said transactions;
(c) to transfer funds between financial instrument accounts that are stored within the user's digital wallet, manage the funds thereof and allow the retrieval, displaying and sharing of the data of all said transaction;
(d) to receive all funds from users and non-users of this invention into a default digital wallet account, manage the funds thereof and allow the retrieval, displaying and sharing of all said transactions;
(e) to process fund transfer from any financial instrument account stored in the user's digital wallet, manage the funds thereof: and allow the retrieval, displaying and sharing of all said transactions;
(f) to periodically and/or at one time, process the transfer of funds into a One-Way-Sub-Account, which is assigned to a selected bill to be paid, and at the end of the month, when the funds are available to pay the selected bill in full, to automatically transfer the said funds to the payee of the selected bill;
(g) to submit a vote for the purpose of a contest of sorts to another user and non-user of this invention, whether the vote is submitted free of charge and/or for a set fee by the purchase of a selected item;
(h) to use his MED to talk to, send text message to, and chat live with, another user of this invention;
(i) to enter, manage, display and share bill data and fund transfers thereof, for the purpose of keeping track of bill payment status; and
(j) to log-out after a user has consummated a session with his digital wallet and choose to get out of it.

In an eighth form, a digital wallet is operative to process various applications, which allow the DWCS:
(a) to send text messages to a user of this invention, to alert him of any selected activities executed within the user's digital wallet, as part of the DWCS security protocols;
(b) to charge and collect all service fees on selected fund transactions executed within a user's digital wallet;
(c) to add or delete any application and/or subcomponent for the purpose of adapting the digital wallet to society changes; and
(d) to monitor and alert a user of all fund transactions using a user's UPIN and/or any other selected personal data stored in the user's digital wallet that are executed within and outside of the network of this invention.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying drawings, wherein:

FIG. 1 is a diagram of an exemplary system that is operative to implement the various aspects of the present invention in accordance with the principles presented herein.

FIG. 2 is a flow diagram of a manner of operation of an aspect of the present invention illustrating the first time login process of a new user, the generating of a Default Digital Wallet Account number and Digital Wallet number, the setting up of a Default MED, and further illustrating the 1st security level protocol, which compares the new user's personal identification information entered by the user with the DWCS' data bases.

FIG. 3 is a flow diagram of a manner of operation of an aspect of the present invention illustrating the first time login process of a new user, who chooses not to provide a UPIN, the generating of a Digital Wallet number, the setting up of a Default MED, and further illustrating the 1st security level protocol, which compares the new user's personal identification information entered by the user with the DWCS data bases.

FIG. 4 is a flow diagram of a manner of operation of an aspect of the present invention illustrating the process of an application allowing a new user and a user to customize his digital wallet.

FIG. 5 is a flow diagram of a manner of operation of an aspect of the present invention illustrating the process of a user attempting to log-in, but has forgotten his user name, password, PIN, and further illustrating the 2nd security level protocol, which requires the said user to identify himself using SIP, and yet further illustrating the 3rd security level protocol, which alerts the said user of his digital wallet being accessed, and requiring the said user to authorize such access, before the said user could access his wallet.

FIG. 6 is a flow diagram of a manner of operation of an aspect of the present invention illustrating the process of a user attempting to log-in, who not only has forgotten his user name, password and/or PIN, but also has forgotten his SIP, and further illustrating the 2nd security level protocol, as shown in FIG. 5, and yet further illustrating the 4th security level protocol, which requires the said user to contact the DWCS customer service to certify the said user's identity, before granting him access to his digital wallet and allowing him to change his user name, password, PIN and/or SIP.

FIG. 7 is a flow diagram of a manner of operation of an aspect of the present invention illustrating the process of a user (or an unauthorized person) having logged-in a digital wallet, and attempting to change the user name, password, PIN and/or SIP, and further illustrating the 2nd security level protocol, which requires the user to identify himself using SIP, before allowing him to execute the changes.

FIG. 8 is a flow diagram of a manner of operation of an aspect of the present invention illustrating the process of an application allowing a user to edit a selected data stored in the said user's digital wallet, and further illustrating the 2nd security level protocol, which requires the said user to identify himself using SIP, before allowing him to execute the editing of any data, and yet further illustrating the 4th security level protocol, which requires the said user to contact the DWCS customer service to certify the said user's identity, when the said user has forgotten his SIP.

FIG. 9 is a flow diagram of a manner of operation of an aspect of the present invention illustrating the process of an application allowing a user to import, save and store personal data in his digital wallet, and further illustrating the 2nd security level protocol, which requires the said user to identify himself using SIP, before allowing the said user to execute any import of such data.

FIG. 10 is a flow diagram of a manner of operation of an aspect of the present invention illustrating the process of an application allowing a user to import, save and store identification instruments and data thereof using the camera and keys of the said user's MED.

FIG. 11 is a flow diagram of a manner of operation of an aspect of the present invention illustrating the process of an application allowing a user, who submitted a request for an identification instrument to be electronically up-loaded to his digital wallet, to have the identification instrument be received by the DWCS and stored in a storage component to be temporarily held awaiting for the said user to authorize, save and store the said identification instrument or delete it, and further illustrating the 5th security level protocol, wherein upon the receipt of the said identification instrument in the storage component, an alert text message is sent to the said user's default MED, requiring him to authorize the said instrument and up-load it in his digital wallet or delete it.

FIG. 12 is a flow diagram of a manner of operation of an aspect of the present invention illustrating the process of an application allowing a user to export an identification instrument, and further illustrating the 6th security level protocol, wherein an alert text message is sent to the said user's default MED, warning the said user that the export of an identification instrument, stored in his digital wallet, is in the process of being executed, and requiring the said user to authorize the said export, before allowing its execution, or to block the said export.

FIG. 13 is a flow diagram of a manner of operation of an aspect of the present invention illustrating the process of an application allowing a user to retrieve an identification instrument and display it on the screen of the said user's default MED.

FIG. 14 is a flow diagram of a manner of operation of an aspect of the present invention illustrating the process of an application allowing a user to import license and certification instruments using the camera and keys of the said user's MED.

FIG. 15 is a flow diagram of a manner of operation of art aspect of the present invention illustrating the process of application allowing a user who submitted a request for a license/certification instrument to be electronically up-loaded in his digital wallet, to have the license/certification instrument be received by the DWCS and stored in a storage component to be temporarily held awaiting for the said user to authorize, save and store the said license/certification instrument or delete it, and further illustrating the 5th security level protocol, wherein upon the receipt of the license/certification instrument in the storage component, an alert text message is sent to the said user's default MED, requiring him to authorize the said instrument and up-load it in his digital wallet or delete it.

FIG. 16 is a flow diagram of a manner of operation of an aspect of the present invention illustrating the process of an application allowing a user to export a license/certification instrument, and further illustrating the 6th security level protocol, wherein an alert text message is sent to the said user's default MED, warning him that the export of a license/certification instrument, stored in his digital wallet, is in the process of being executed, and requiring the said user to authorize the said export, before allowing its execution, or to block the said export.

FIG. 17 is a flow diagram of a manner of operation of an aspect of the present invention illustrating the process of an application allowing a user to retrieve a license/certification instrument and display it on the screen of the said user's default MED.

FIG. 18 is a flow diagram of a manner of operation of an aspect of the present invention illustrating the process of an application allowing a user to import financial instruments and data thereof using the camera and keys of the said user's default MED, and further illustrating the setting up of a default digital wallet account, which is generated from the UPIN provided by the said user, and yet further illustrating a bar code and/or any other means of communicating financial data, is generated for each financial instrument (except for e-Checks) and the default digital wallet account, to facilitate an e-commerce transaction, after which the financial instruments and data thereof, and the data of the default digital wallet account are saved and stored in the appropriate subcomponents of the digital wallet.

FIG. 19 is a flow diagram of a manner of operation of an aspect of the present invention illustrating the process of an application allowing a user, who submitted a request to another user and non-user of this invention, for a financial instrument and data thereof to be electronically up-loaded to his digital wallet, to have the financial instrument and data thereof be received by the DWCS and stored in a storage component to be temporarily held awaiting for the said user to authorize, save and stored the said financial instrument or delete it, and further illustrating the 5th security level protocol, wherein upon the receipt of the financial instrument in the storage component, an alert text message is sent to the said user's default MED, requiring him to authorize the said instrument and up-load it in his digital wallet or delete it.

FIG. 20 is a flow diagram of a manner of operation of an aspect of the present invention illustrating the process of an application allowing a user to retrieve a financial instrument and data thereof and display them on the screen of the said user's MED, and further illustrating the process of an application allowing the said user to retrieve the transaction statement and balance of a selected financial instrument account, by connecting to the central bank account interface, and display the said data on the said user's default MED screen.

FIG. 21 is a flow diagram of a manner of operation of an aspect of the present invention illustrating the process of an application allowing a user to connect with another user's MED and either talk, send text messages, or live chat.

FIG. 22 is a flow diagram of a manner of operation of an aspect of the present invention illustrating the process of an application allowing a user, after a transaction has been consummated, to import a receipt/confirmation of the transaction, by using the camera of the said user's MED, and further illustrating the electronic import of a receipt/confirmation of a consummated transaction from another user and non-user of this invention, wherein the said receipt/confirmation is saved and stored in the appropriate subcomponent of the said user's digital wallet.

FIG. 23 is a flow diagram of a manner of operation of an aspect of the present invention illustrating the process of an application allowing a user to export a receipt/confirmation of a consummated transaction stored in the said user's digital wallet to another user and non-user of this invention.

FIG. 24 is a flow diagram of a manner of operation of an aspect of the present invention illustrating the process of an application allowing a user to retrieve a receipt/confirmation of a consummated transaction stored in the said user's digital wallet and display it on the screen of the user's default MED.

FIG. 25 is a flow diagram of a manner of operation of an aspect of the present invention illustrating the process of an application allowing a user to create a receipt/confirmation of a consummated transaction by using the keys of the said user's default MED.

FIG. 26 is a flow diagram of a manner of operation of an aspect of the present invention illustrating the process of an application allowing a user to have funds transferred from another user and non-user of this invention, into his default digital wallet account, and further illustrating the 7th security level protocol, wherein an alert text message is sent to the said user's default MED, warning him that a deposit of funds is in the process of being executed, and requiring the said user to verify and authorize the said deposit, before the deposit is finalized or to cancel it and alert the DWCS customer service.

FIG. 27 is a flow diagram of a manner of operation of an aspect of the present invention illustrating the process of an application allowing a user to transfer funds to another user and non-user of this invention, to purchase goods and services, and to pay bills, by transferring the funds from a selected financial instrument account stored in the said user's digital wallet, and further illustrating the 7th security level protocol, wherein an alert text message is sent to the said user's default MED, warning him that a transfer from his stored financial instrument account is in the process of being executed, and requiring him to verify and authorize the said transfer, before the transfer is executed or cancel it and alert the DWCS customer service.

FIG. 28 is a flow diagram of a manner of operation of an aspect of the present invention illustrating the process of an application allowing a user to periodically and/or at one time, transfer funds from a selected financial instrument account stored in the said user's digital wallet, into a one-way-sub-account assigned to a particular bill to be paid, wherein at the end of the month, the funds in all one-way-sub-accounts, which are available to pay each particular bill in full, are automatically transferred to the payee (another user and non-user of this invention) of each bill, and further illustrating the 7th security level protocol, wherein an alert text message is sent to the said user's default MED, warning him that fund transfers are in the process of being executed, and requiring him to verify and authorize the said transfers, before the transfers are executed or cancel them and alert the DWCS customer service.

FIG. 29 is a flow diagram of a manner of operation of an aspect of the present invention illustrating the process of an application allowing a user to import discount coupons from another user and non-user of this invention, save and store them in the said user's digital wallet awaiting to be consummated.

FIG. 30 is flow diagram of a manner of operation of an aspect of the present invention illustrating the process of an application allowing a user to export and consummate a selected discount coupon stored in the said user's digital wallet, by either electronically transferring the said discount coupon and data thereof to another user and non-user of this invention, and/or by displaying it on the screen of the said user's default MED to consummate it at the cash register at a vender/provider's site.

FIG. 31 is a flow diagram of a manner of operation of an aspect of the present invention illustrating the process of an application allowing a user to retrieve the discount coupons stored in the said user's digital wallet and display them on the screen of the said user's default MED.

FIG. 32 is a flow diagram of a manner of operation of an aspect of the present invention illustrating the process of an application allowing a user to submit a vote, free of charge, for the purpose of a contest of sorts, to another user and non-user of this invention.

FIG. 33 is a flow diagram of a manner of operation of an aspect of the present invention illustrating the process of an an application allowing a user to submit a vote by the purchase of a selected item, for the purpose of a contest of sorts, by transferring the required funds to another user and non-user of this invention, and further illustrating the 7th security level protocol, wherein an alert text message is sent to the said user's default MED, warning him that a transfer of funds is in the process of being executed, and requiring him to verify and authorize the said transfer, before the transfer is executed or cancel it and alert the DWCS customer service.

FIG. 34 is a flow diagram of a manner of operation of an aspect of the present invention illustrating the process of an application allowing a company user (including a financial and government entity) to transfer funds from a selected financial instrument account stored in the said company user's digital wallet to its employees, who are users and non-users of this invention, for the purpose of pay rolls, and further illustrating the 7th security level protocol, wherein an alert text message is sent to the said company user's default MED, warning it that transfers of funds are in the process of being executed, and requiring the said company user to verify and authorize the said transfers, before its execution, or cancel them and alert the DWCS customer service and/or other pertinent authority.

FIG. 35 is a flow diagram of a manner of operation of an aspect of the present invention illustrating the process of an application allowing a financial and government entity user to transfer funds to another user of this-invention, and further illustrating the 8th security level protocol, wherein the identity of the recipient of the funds is verified by sending an alert text message to the said recipient, who is required to either verify, confirm, and correctly respond to an inquiry, or cancel the transaction, whereinafter the said financial and government entity user confirms the identity of the said recipient, the funds are transferred to the said recipient default digital wallet account, and yet further illustrating the 7th security level protocol, wherein an alert text message is sent to the financial and government entity user's default MED, warning it that a transfer of funds is in the process of being executed, and requiring it to verify and authorize the said transfer, before the transfer is executed or cancel the transfer and alert the DWCS customer service and/or other pertinent authority.

FIG. 36 is a flow diagram of a manner of operation of an aspect of the present invention illustrating the process of an application allowing a user to record the data of bill(s) to be paid and data of payment(s) made toward the payment of the bill(s) for the purpose of tracking the status of the bill(s) that are yet to be paid, wherein all said recorded data are saved and stored in the appropriate subcomponent(s) of the said user's digital wallet, and further illustrating the said application allowing the said user to retrieve the said recorded data of bill(s) and display it on the screen of the said user's default MED.

FIG. 37 is a flow diagram of a manner of operation of an aspect of the present invention illustrating the process of an application allowing a user to deposit a check (e-check and paper check) at financial entity users into the said user's default digital wallet account, and further illustrating the 7th security level protocol, wherein an alert text message is sent to the said user's default MED, warning him that a deposit is in the process of being executed, and requiring him to verify and authorize the said deposit of funds, before the deposit is executed or cancel it and alert the DWCS customer service.

FIG. 38 is a flow diagram of a manner of operation of an aspect of the present invention illustrating the process of an application allowing a user to write a check (e-check and paper check) from his default digital wallet account to another user and non-user of this invention, and further illustrating the 7th security level protocol, wherein an alert text message is sent to the said user's default MED, warning him that a fund transfer is in the process of being executed, and requiring him to verify and authorize the said transfer, before the transfer is executed or cancel it and alert the DWCS customer service.

FIG. 39 is a flow diagram of a manner of operation of an aspect of the present invention illustrating the process of an application allowing a user, who has become alerted of an unauthorized person having stolen his log-in information and has accessed or intends to access the user is digital wallet, and/or has lost his default MED, to access the DWCS' “Emergency Digital Wallet Access, Freeze, and Change of User Name, Password, PIN and/or SIP” Application, for the purpose of allowing the said user to access his digital wallet using another MED and freeze his digital wallet even when his digital wallet is being used by the unauthorized person, and further illustrating the 2nd security level protocol, which requires the said user to identify himself using SIP, before allowing the said user to execute the emergency application.

FIG. 40 is a flow diagram of a manner of operation of an aspect of the present invention illustrating the process of an application allowing a user to log-out after having consummated a session with his digital wallet and chooses to get out of his digital wallet.

FIG. 41 is a flow diagram of a manner of operation of an aspect of the present invention illustrating the process of an application allowing the DWCS to charge and collect service fees for each selected transaction consummated through a user's digital wallet, and further illustrating the DWCS charging no service fee for any fund transfer related to the voting application.

FIG. 42 is a flow diagram of a manner of operation of an aspect of the present invention illustrating the process of an application allowing the DWCS to add/activate and/or delete/deactivate application(s) and/or subcomponent(s) for the purpose of adapting the users' digital wallet to society changes, wherein the said modification(s) is saved and stored in the appropriate component(s)/subcomponent(s).

FIG. 43 is a flow diagram of a manner of operation of an aspect of the present invention illustrating the process of the 10th security level protocol, wherein the DWCS monitors and alerts a user of all fund transaction in and out of the network of this invention using selected financial and personal identification data stored in the said user's digital wallet.

### DETAILED DESCRIPTION OF THE INVENTION

While the invention is susceptible to various modifications and alternative forms, the specific embodiment(s) shown and/or described herein is by way of example. It should thus be appreciated that there is no intent to limit the invention to the particular form disclosed, as the intention is to cover all modifications, equivalents, and alternatives falling within the spirit and scope of the invention as defined by the appended claims.

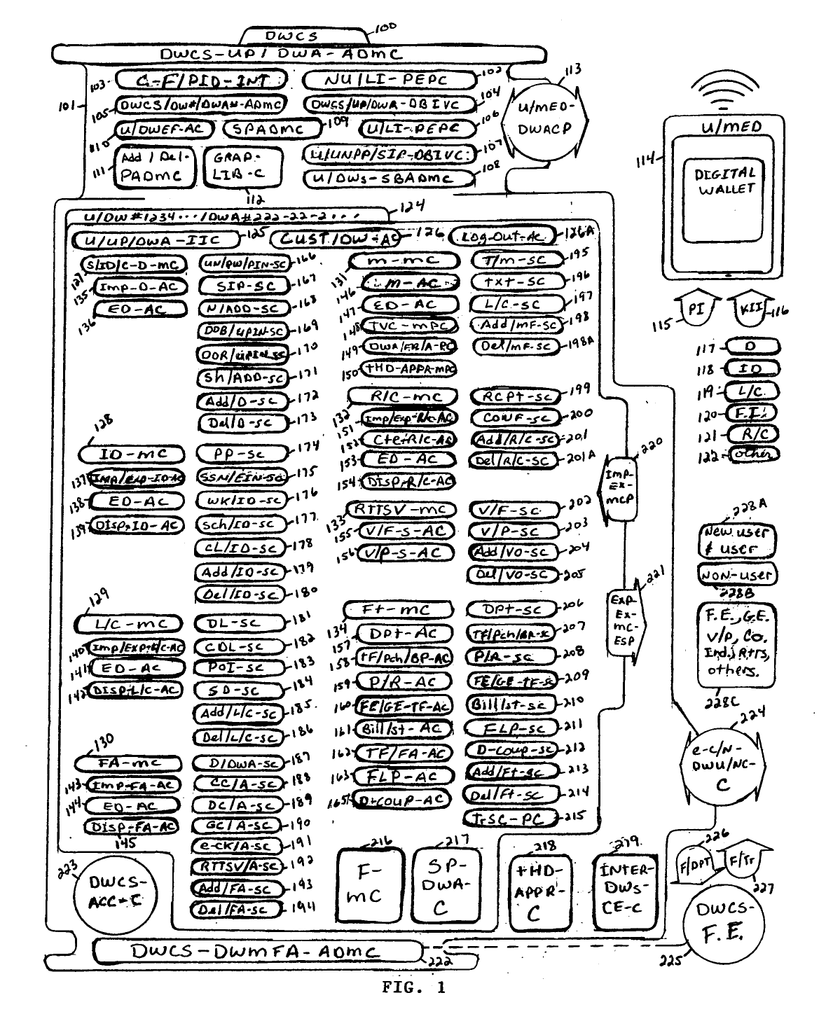

A structure of a digital wallet is depicted in FIG. 1 and reference is hereafter made thereto. More particularly, FIG. 1 depicts a simplified, exemplary block diagram of a “User/Digital Wallet” (U/DW) 124, operating in conjunction with a “Digital Wallet Company Server-User Profile/Digital Wallet Account-Administrator Component” (DWCS-UP/DWA-ADMC) 101, within a “Digital Wallet Company Server” (DWCS) 100, of the type that forms a backbone for the various aspects (i.e. enhancements/applications) according to the principles of the present invention.

As indicated above, the U/DW 124, which operates in conjunction with the DWCS-UP/DWA-ADMC 101 is a software and/or program instruction implementation of various concepts and/or functionalities.

The DWCS-UP/DWA-ADMC 101 includes a “New User/Log-In-Program Exchange & processing Component” (NU/LI-PEPC) 102; a “Central-Financial/Personal Identification-Interface” (C-F/PID-INT) 103; a “DWCS-User Profile/Digital Wallet Account-Data Base Interface Verification Component” (DWCS-UP/DWA-DBIVC) 104; a “DWCS/Digital Wallet Number/Digital Wallet Account Number-Administrator Component” (DWCS/DW#/DWA#-ADMC) 105; a “User/Log-In-Program Exchange & Processing Component” (U/LI-PEPC) 106; a “User/User name-Password-Personal Identification Number/Secondary Identification Parameters Data Base Interface Verification Component” (U/UNPP/SIP-DBIVC) 107; a “User/Digital Wallets-Switch Board Administrator Component” (U/DWs-SBADMC) 108; A “Security Protocol Administrator Component” (SPADMC) 109; a “User/Digital Wallet Emergency Freeze-Application Component” (U/DWEF-AC) 110; an “Add/Delete-Program Administrator Component” (Add/Del-PADMC) 111; a “Graphic-Library-Component” (GRAPH-LIB-C) 112; a “User/Mobile Electronic Device-Digital Wallet Access Control Portal” (U/MED-DWACP) 113, which allows a “New User & User” 228A, who may be a″Financial Entity, Government Entity, Vendor/Provider, Company, Individual, Reality TV Talent Show, Others” (F.E., G.E., V/P, Ind., RTTS, Others) 228C, to use his “User/Mobile Electronic Device (or Non-Mobile Electronic Device)” (U/MED) 114 to access the DWCS 100 and his U/DW 124; an “e-commerce/Non-Digital wallet User/Network Communication-Component” (e-C/N-DWU/NC-C) 224, which allows a “Non-User” 228B, who may be a F.E., G.E., V/P, Co., Ind., RTTS, Others 228C, to consummate an e-commerce transaction through a U/DW 124; a “Temporary Hold Data-Approval-Component” (THD-APPR-C) 218: and “Inter-Digital Wallets-Communication Exchange-Component” (INTER-DWs-CE-C) 219; a “DWCS-Account-Component”(DWCS-ACC-C) 223; a “DWCS-Digital Wallet Master Fund Account-Administrator Component” (DWCS-DWMFA-ADMC) 222, which operates in conjunction with its “DWCS-Financial Entity” (DWCS-F.E.) 225.

The U/DW 124 includes a “User/User Profile/Digital Wallet Account-Instruction Implementation Component” (U/UP/DWA-IIC) 125; a “Customize/Digital Wallet-Application Component” (CUST/DW-AC) 126; a “Log-Out-Application Component” (LOG-OUT-AC) 126A; a “Security/Identification/Contact-Data-Manager Component” (S/ID/C-D-MC) 127; a “User Name/Password/Personal Identification Number-Subcomponent” (UN/PW/PIN-SC) 166; a “Secondary Identification Parameters-Subcomponent” (SIP-SC) 167; a “Name/Address-Subcomponent” (N/ADD-SC) 168; a “Date of Birth/Unique Personal Identification Number Subcomponent” (DOB/UPIN-SC) 169; a “Date of Registration/Unique Personal Identification Number-Subcomponent” (DOR/UPIN-SC) 170; a “Shopping/Address-subcomponent” (Sh/ADD-SC) 171; an “Add/Data-Subcomponent” (Add/D-SC) 172; a “Delete/Data-Subcomponent” (Del/DSC) 173; an “Import-Data-Application Component” (IMP-D-AC) 135; an “Edit-Application Component” (ED-AC) 136; an “Identification-Manager Component” (ID-MC) 128; a “Passpoort-Subcomponent” (PP-SC) 174; a “Social Security Number/Employer Identification Number-Subcomponent” (SSN/EIN-SC) 175; a “Work/Identification-Subcomponent” (WK/ID-SC) 176; a “School/Identification-Subcomponent” (Sch/ID-SC) 177; a “Clud/Identification-Subcomponent” (Cl/ID-SC) 178; an “Add/Identification-Subcomponent” (Add/ID-SC) 179; a “Delete/Identification-Subcomponent” (Del/ID-SC) 180; an “Import/Export-Identification-Application Component” (IMP/EXP-ID-AC) 137; an “Edit-Application Component” (ED-AC) 138; a “Display-Identification-Application Component” (DISP-ID-AC) 139; a “License/Certification-Manager Component” (L/C-MC) 129; a “Driver's License-subcomponent” (DL-SC) 181; a “Commercial Driver's License-Subcomponent” (CDL-SC) 182; a “Proof of Insurance-Subcomponent” (POI-SC) 183; a “Schoold Diploma-Subcomponent” (SD-SC) 184; an “Add/License/Certification-Subcomponent” (Add/L/C-SC) 185; a “Delete/License/Certification-Subcomponent” (Del/L/C-SC) 186; an “Import/Export-License/Certification-Application component” (IMP/EXP-L/C-AC) 140; an “Edit-Application Component” (ED-AC) 141; a “Display-License/Certification-Application Component (DISP-L/C-AC) 142; a “Fund Account-Manager Component” (FA-MC) 130; a “Default/Digital Wallet Account-Subcomponent” (D/DWA-SC) 187; A “Credit Card/Account-Subcomponent” (CC/A-SC) 188; A “Debit Card/Account-Subcomponent” (DC/A-SC) 189; A “Gift Card/Account-Subcomponent” (GC/A-SC) 190; An “Electronic-Check/Account-Subcomponent” (e-CK/A-SC) 191; a “Reality TV Talent Show Vote/Account-Subcomponent” (RTTSV/A-SC) 192; an “Add/Fund Account-Subcomponent” (Add/FA-SC) 193; a “Delete/Fund Account-Subcomponent” (Del/FA-SC) 194; an “Import-Fund Account-Application Component” (IMP-FA-AC) 143; an “Edit-Application Component” (ED-AC) 144; a “Display-Fund Account-Application Component” (DISP-FA-AC) 145; a “Message-Manager Component” (M-MC) 131; a “Talk/Messaging-Subcomponent” (T/M-SC) 195; a “Texting-Subcomponent” (TXT-SC) 196; a “Live/Chatting-Subcomponent” (L/C-SC) 197; an “Add/Message Function-Subcomponent” (Add/MF-SC) 198; a “Delete/Message Function-Subcomponent” (Del/MF-SC) 198A; a Messaging-Application Component” (M-AC) 146; an “Edit-Application Component” (ED-AC) 147; a “Transaction Verification and Confirmation-Message protocol Component” (TVC-MPC) 148; A “Digital Wallet Account/Fraud/Alert-Protocol Component” (DWA/FR/A-PC) 149; a “Temporary Hold Data-Approval-Message Protocol Component” (THD-APPR-MPC) 150; a “Receipt/Confirmation-Manager Component” (R/C-MC) 132; a “Receipt-Subcomponent” (RCPT-SC) 199; a “Confirmation-Subcomponent” (CONF-SC) 200; an “Add/Receipt/Confirmation-Subcomponent” (Add/R/C-SC) 201; a “Delete/Receipt/Confirmation-Subcomponent” (Del/R/C-SC) 201A; an “Import/Export-Receipt/Confirmation-Application Component” (IMP/EXP-R/C-AC) 151; a “Create-Receipt/Confirmation-Application Component” (CTE-R/C-AC) 152; an “Edit-Application Component” (ED-AC) 153; a “Display-Receipt/confirmation-Application Component” (DISP-R/C-AC) 154; A “Reality TV Talent Show Vote-Manager Component” (RTTSV-MC) 133; A “Vote/Free of Charge-Subcomponent” (V/F-SC) 202; a “Vote/By Purchase-Subcomponent (V/P-SC) 203; an “Add/Vote-Subcomponent” (Add/Vo-SC) 204; a “Delete/Vote-Subcomponent” (Del/Vo-SC) 205; a “Vote/Free of Charge-Application Component” (V/F-AC) 155; a “Vote/By Purchase-Application Component” (V/P-AC) 156; a “Fund Transaction-Manager Component” (FT-MC) 134; a “Deposit-Subcomponent” (DPT-SC) 206; (a “Transfer/Purchase/Bill Pay-Subcomponent” (TF/Pch/BP-SC) 207; a “Pay Roll-Subcomponent” (P/R-SC) 208; a “Financial Entity/Government Entity-Transfer-Subcomponent” (FE/GE-TF-SC) 209; a “Bill. Status-Subcomponent” (Bill/ST-SC) 210; a “Flex Pay-Subcomponent” (FLP-SC) 211; a “Discount-Coupons-Subcomponent” (D-Coup-SC) 212; an “Add/Fund Transfer-Subcomponent” (Add/FT-SC) 213; a “Delete/Fund Transfer-Subcomponent” (Del/FT-SC) 214; a “Transaction service charge-Payment Component” (TrSC-PC) 215; a “Deposit-Application Component” (DPT-AC) 157; a “Transfer/Purchase/Bill Pay-Application Component” (TF/Pch/BP-AC) 158; a “Pay Roll-Application Component” (P/R-AC) 159; a “Financial Entity/Government Entity-Transfer-Application Component” (FE/GE-TF-AC) 160; a “Bill Status-Application Component” (Bill/ST-AC) 161; A “Transfer/Fund Accounts-Application Component” (TF/FA-AC) 162; a “Flex Pay-Application Component” (FLP-AC) 163; a “Discount Coupons-Application. Component” (D-Coup-AC) 165; a “Fund-Manager Component” (F-MC) 216; a “Security Protocol-Digital Wallet Account-Component” (SP-DWA-C) 217; an “Import-Exchange-Manager Component Portal” (IMP-EX-MCP) 220; an “Export-Exchange-Manager Component-Encryption Software Portal” (EXP-EX-MC-ESP) 221.

FIG. 1 further depicts the capability of a U/MED 114 to import into a U/DW 124, by taking a “Picture” (PI) 115 and/or “Keying-In Information” (KII) 116, “Data” (D) 117, “Identification Instruments and Data Thereof” (ID) 118, “License/Certification Instruments and Data Thereof” (L/C) 119, “Financial Instruments and Data Thereof” (F.I.) 120, “Receipt/Confirmation of Transactions and Data Thereof” (R/C) 121, and “Other” 122.

FIG. 1 yet further depicts the DWCS-F.E.'s ability to transact “Fund Deposit” (F/DPT) 226 into, and/or “Fund Transfer” (F/TR) 227 from, the D/DWA-SC of a user of this invention.

A first advantage of this invention is achieved through a digital wallet having the operative capability to receive from various sources, create, edit, manage, and allow the retrieval, displaying, and sharing of a wider variety and greater quantity of enhancements, as compared to previously implemented digital wallet, and as compared to a traditional wallet, whereby permitting a user of this invention to protect the content of his traditional wallet from being stolen and/or lost, by keeping his traditional wallet and its content in a secured location.

A second advantage of this invention resides in a digital wallet operating a wide range of functionalities in conjunction with the various enhancements stored in a digital wallet, wherein each functionality may operate independently from each other, and/or in conjunction with each other.

A third advantage of this invention is further achieved through a digital wallet operating to allow a user of this invention to organize multiple sorts of data, identification instruments, license/certification instruments, receipt/confirmation of transactions, and to organize financial instruments, its accounts and manage the funds thereof.

A fourth advantage of this invention further resides in a digital wallet operating to centralize all aspects of banking at the fingertips of a user of this invention, without the need to go to the bank or use the ATM machine to easily manage funds.

A fifth advantage of this invention is yet achieved through a digital wallet operating to allow a user of this invention to keep track of his spendings.

A sixth advantage of this invention yet resides in a digital wallet operating to allow a user of this invention to submit a vote for the purpose of a contest of sorts.

A seventh advantage of this invention is yet further achieved through a digital wallet operating to provide a user of this invention an opportunity to have a bank account to transact funds, after the said user have been turned down by all banks, due to the said user's ill-banking practice.

An eighth advantage of this invention yet further resides in a digital wallet operating in conjunction with the DWCS-UP/DWA-ADMC 101, which provides various security protocols, typically during financial and non-financial transactions, implemented to protect a user of this invention from being a victim of aggravated identity theft, fraud, and of the damages thereof.

A ninth advantage of this invention is yet furthermore achieved through a digital wallet operating in a manner to tag all transactions consummated within the digital wallet of a user of this invention with a Digital Wallet Number, wherein a user of this invention is prevented from using the personal identification of another individual through his U/DW 124 for fraudulent purpose, where each such transaction is paper-trailed by the Digital Wallet Number, and therefore making it easy to track any fraudulent transaction and perpetrator thereof.

A tenth advantage of this invention yet furthermore resides in a network of users of this invention, wherein the implemented security protocols operate to allow a user of this invention to block any financial and non-financial transaction, while in process, and also red-flag any fraudulent transaction and perpetrator thereof on the spot.

It should be understood that the above description of a digital wallet 124 operating in conjunction with the DWCS-UP/DWA-ADMC 101 is exemplary of an implementation and/or general structure of a digital wallet. Therefore, it should be appreciated that other implementation and/or structure, now existing and later developed, of a digital wallet may be used to achieve the following functionalities (enhancements/applications) of this invention.

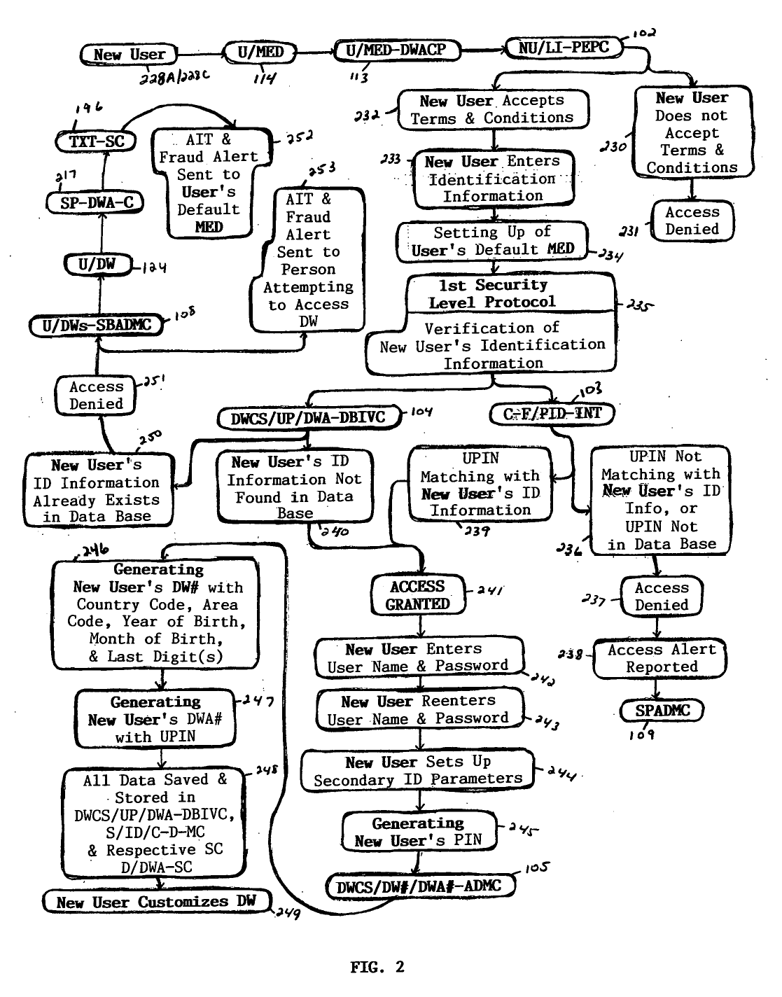

Referring now to FIG. 2, there is a flow diagram of a manner of operation of an aspect of the present invention illustrating the first time log-in process of a new user of this invention; the setting up of the New User's default mobile electronic device (or non-mobile electronic device); the generating of a “Digital Wallet Number” and “Default Digital Wallet Account”, and further illustrating the 1st security level protocol, which compares the new user's personal identification information entered by the said new user with the DWCS-UP/DWA-ADMC 101 data bases.

In particular, a “New User” 228A/228C uses a U/MED 114 to navigate a network, preferably an electronic network such as the internet, to connect with the DWCS 100 through the U/MED-DWACP 113 to upload from the NU/LI-PEPC 102 the new user log-in program exchange processing software, typically the home page of the DWCS 100, which allows the DWCS-UP/DWA-ADMC 101 to interact with the new user's U/MED 114 for the entry of essential data for the purpose of setting up the new user's U/DW 124.

First, the “New User” 228A/228C must . . . accept the terms and conditions of the DWCS 100. If the “New User does not accept the terms and conditions” 230, the “new User is denied Access” 231. If the “New User accepts the terms and conditions” 232, the “New User is required to enter his personal identification information” 233, which includes, but is not limited to, first name, middle name, last name, company/entity name, address, date of birth, date of registration, unique personal identification number (such as social security number, employer identification number), e-mail address, country code, and is further required to provide a phone number for the “setting up of his default MED” 234.

Second, once entered, all information is transmitted to the DWCS-UP/DWA-ADMC 101 to run the “1st security level protocol for the verification of the new user's identification” 235, which consists of (a) verifying the unique personal identification number by comparing it to the data base of the C-F/PID-INT 103, which is a centralize interface in which all financial and personal identification information of an individual is maintained and where all financial and government entities go to verify the identity of an individual and company/entity, wherein if the “UPIN does not match with the new user's personal identification information, or the UPIN does not exist in the data base” 236, the “New User is denied access” 237 and an “unauthorized access alert is reported” 238 to the SPADMC 109; (b) verifying the personal identification information by comparing it to the data base of the DWCS/UP/DWA-DBIVC 104, which maintains the personal identification information of all users of this invention, wherein if the “personal identification information already exists in the said data base” 250, meaning that someone else already has set up a digital wallet using the new user's personal identification information and no other digital wallet can be setup using the same said information, the “New User is denied access” 251, and an “AIT & Fraud alert text message is sent to the User's default MED” 252 by the DWCS-UP/DWA-ADMC 101 (1) connecting to the U/DWs-SBADMC 108, which is an electronic relay system software allowing a user of this invention to connect to his U/DW 124 and also allowing the DWCS-UP/DWA-ADMC 101 and other users of this invention to connect to a specific U/DW 124; (2) connecting to the SP-DWA-C 217, which is a security protocol software operating in a U/DW 124 to process alert text messages, when attempt to access a user's digital wallet by an unauthorized individual occurs; (3) connecting to the TXT-SC 196, which is a software subcomponent, which operates to transmit text messages to the user's default MED 114, and simultaneously an “AIT & Fraud alert text message is sent to the person attempting to set up a digital wallet” 253.

Only when the “UPIN matches with the New User's personal identification information” 239 and the “New User's personal identification information is not found in the DWCS/UP/DWA-DBIVC” 240 that a “New User is granted access” 241 to set up a digital wallet.

Third, the “New User is required to enter a User Name and Password” 242, the “New User is required to reenter the same User Name and Password” 243, and then, the “New User is required to set up Secondary Identification Parameters” 244, which may include, but is not limited to, answers to 3 specific personal questions, fingerprints, face recognition.

Once the user name, password and secondary identification parameters are entered, the DWCS-UP/DWA-ADMC 101, generates the “New User's Personal Identification Number (PIN)” 245.

Fifth, the DWCS/DW#/DWA#-ADMC 105, “generates the New User's Digital Wallet Number using the Country Code, Area Code, Year of Birth, Month of Birth, and Last Digit(s)” 246, and also “generates the New User's Default Digital Wallet Account Number using his Unique Personal Identification Number” 247.

Sixth, “all the information entered by the New User and generated by the DWCS-UP/DWA-ADMC 101 and DWCS/DW#/DWA#-ADMC 105 is first grouped and maintained in the DWCS/UP/DWA-DBIVC 104, and then individually maintained in the S/ID/C-D-MC, which manages all log-in and personal identification information and other information specific to a user of this invention, wherein the User Name, Password and PIN are stored in the UN/PW/PIN-SC 166, the Secondary Identification Parameters are stored in the SIP-SC 167, the Name and Address are stored in the N/ADD-SC 168, the Date of Birth and UPIN are stored in the DOB/UPIN-SC 169, the Date of Registration and UPIN are stored in the DOR/UPIN-SC 170, the Shipping Address is stored in the Sh/ADD-SC 171, and the Default Digital Wallet Account number is stored in the D/DWA-SC 187” 248. Thereafter, the “New User is ready to customize his digital wallet” 249.

A first advantage of this aspect of the present invention is achieved by the generating of a Digital Wallet Number and a Default Digital Wallet Account Number, which makes a digital wallet 124 unique to a single user, for the purpose of preventing anyone else to use the said user's personal identification information to set up a duplicate digital wallet 124 to fraudulently transact funds.

A second advantage of this aspect of the present invention resides in the 1st security level protocol, wherein, when a New User attempts to set up a U/DW 124, but is denied access because his personal identification information has already been used to set up a U/DW 124, an alert text message is sent both to the person, who is attempting to set up a digital wallet, and the user of the digital wallet that has already been set up, for the purpose of alerting either one of them that someone else has committed aggravated identity theft and has or is about to also commit fraud.

A third advantage of this aspect of the present invention is further achieved through the log-in process of a New User requiring him to set up a Default MED as the only MED which will receive all alert text messages, for the purpose to secure the content of the User's U/DW 124.

A fourth advantage of this aspect of the present invention further resides in the generating of Digital Wallet Number, which is used to connect a user with another user of this invention and transact among each other, for the purpose of hiding the low-level sensitive data that are required for the consummation of an electronic transaction.

A fifth advantage of this aspect of the present invention is yet achieved through the generating of a Digital Wallet Account Number, which uses a user's unique personal identification number as the account number, which is a fund account managed by the DWCS 100 and used as the sole depository account for fund transfers from a user to another user of this invention, for the purpose of protecting the said users against aggravated identity theft, fraud, and the damages thereof.

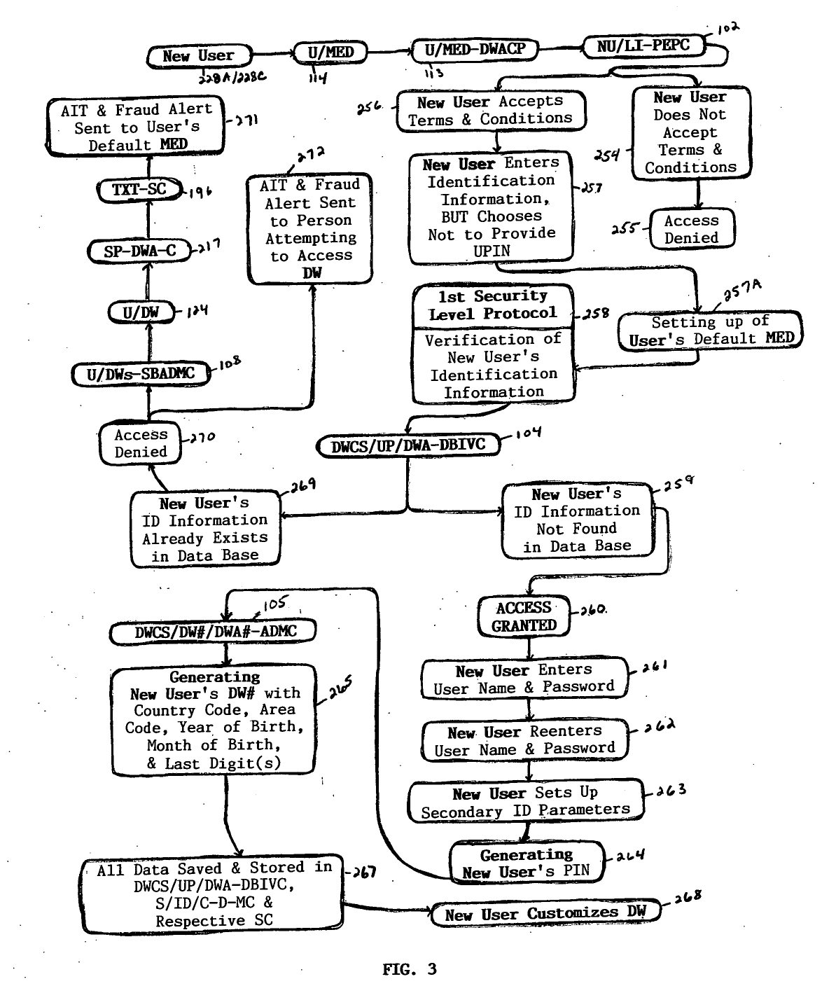

Referring to FIG. 3, there is a flow diagram of a manner of operation of an aspect of the present invention illustrating the first time log-in process of a new user, who chooses not to provide a UPIN, the generating of a Digital Wallet number, the setting up of a Default MED, and further illustrating the 1st security level protocol, which compares the new user's personal identification information entered by the user with the DWCS 100 data base.

In particular, a “New User” 228A/228C uses a U/MED 114 to navigate a network, preferably an electronic network such as the internet, to connect with the DWCS 100 through the U/MED-DWACP 113 to upload from the NU/LI-PEPC 102 the new user log-in program exchange processing software, typically the home page of the DWCS 100, which allows the DWCS-UP/DWA-ADMC 101 to interact with the new user's U/MED 114 for the entry of essential data for the purpose of setting up the new user's U/DW 124.

First the “New User” 228A/228C must accepts the terms and conditions of the DWCS 100. If the “New User does not accept the terms and conditions” 254, the “New User is denied access” 255. If the “New User accepts the terms and conditions” 256, the “New User is required to enter his personal identification information but chooses not to provide his UPIN” 257, which includes, but is not limited to, first name, middle name, last name, company/entity name, address, date of birth, date of registration, e-mail address, country code, and is further required to provide a phone number for the “setting up of his default MED” 257A.

Second, once entered, all information is transmitted to the DWCS-UP/DWA-ADMC 101 to run the “1st security level protocol for the verification of the New User's identification” 258, which consists of verifying the personal identification information by comparing it to the DWCS/UP/DWA-DBIVC 104, which maintains the personal identification information of all users of this invention, wherein if the “personal identification information already exists in the said data base” 269, meaning that someone else already has set up a digital wallet using the new user's personal identification information and no other digital wallet can be set up using the same said information, the “New User is denied access” 270, and an “AIT & Fraud alert text message is sent to the User's default MED” 271 by the DWCS-UP/DWA-ADMC 101 (1) connecting to the U/DWs-SBADMC 108, which is an electronic relay system software allowing a user of this invention to connect to his U/DW 124 and also allowing the DWCS-UP/DWA-ADMC 101 and other users of this invention to connect to a specific U/DW 124; (2) connecting to the SP-DWA-C; 217, which is a security protocol software operating in a U/DW 124 to process alert text messages, when attempt to access a user's digital wallet by an unauthorized individual occurs; (3) connecting to the TXT-SC 196, which is a software subcomponent, which operates to transmit text messages to the user's default MED 114, and simultaneously an “AIT & Fraud alert text message is sent to the person attempting to set up a digital wallet” 272.

Only when the “New User's personal identification information is not found in the DWCS/UP/DWA-DBIVC” 259 that a “New User is granted access” 260 to set up a digital wallet.

In this aspect of the present invention, because a New User has chosen not to provide a UPIN, which is necessary to generate the Default Digital Wallet Account Number, such a New User is provided with a digital wallet, but without the said default digital wallet account number and corresponding subcomponent, which deprives the digital wallet of the advantages thereof, as mentioned earlier. This modification is however an advantage for those individuals who do not possess a UPIN in this country, such as an individual from another country who has been admitted in this country under a student visa and an individual who resides in another country and has a “secondary residence” in this country, and who does not have such UPIN. This aspect thus allows such individuals to set up a digital wallet, which has all the other benefits are available to them.

Third, the “New User is required to enter a User Name and Password” 261, the “New User is required to reenter the same User Name and Password” 262, and then, the “New User is required to set up Secondary Identification Parameters” 263, which may include, but is not limited to, answers to 3 personal questions, fingerprints, face recognition.

Once the user name, password and secondary identification parameters are entered, the DWCS-UP/DWA-ADMC 101, generates the “New User's personal Identification Number (PIN) 264 for log-in purpose.

Fifth, the DWCS/DW#/DWA#-ADMC 105, “generates the New User's Digital Wallet Number using the Country Code, Area Code, Year of Birth, Month of Birth, and Last Digit(s)” 265.

Sixth, “all the information entered by the new user and generated by the DWCS-UP/DWA-ADMC 101 and DWCS/DW#/DWA#-ADMC 105 is first grouped and maintained in the DWCS/UP/DWA-DBIVC 104 and then individually maintained in the S/ID/C-D-MC 127, which manages all log-in and personal identification information and other information specific to a user of this invention, wherein the User Name, Password, and PIN are stored in the UN/PW/PIN-SC 166, the Secondary Identification Parameters are stored in the SIP-SC 167, the Name and Address are stored in the N/ADD-SC 168, the Date of Birth and UPIN are stored in the DOB/UPIN-SC 169, the Date of Registration and UPIN are stored in the DOR/UPIN-SC 170, the Shipping Address is stored in the Sh/ADD-SC 171” 267. Thereafter, the “New User is ready to customize his digital wallet” 268.

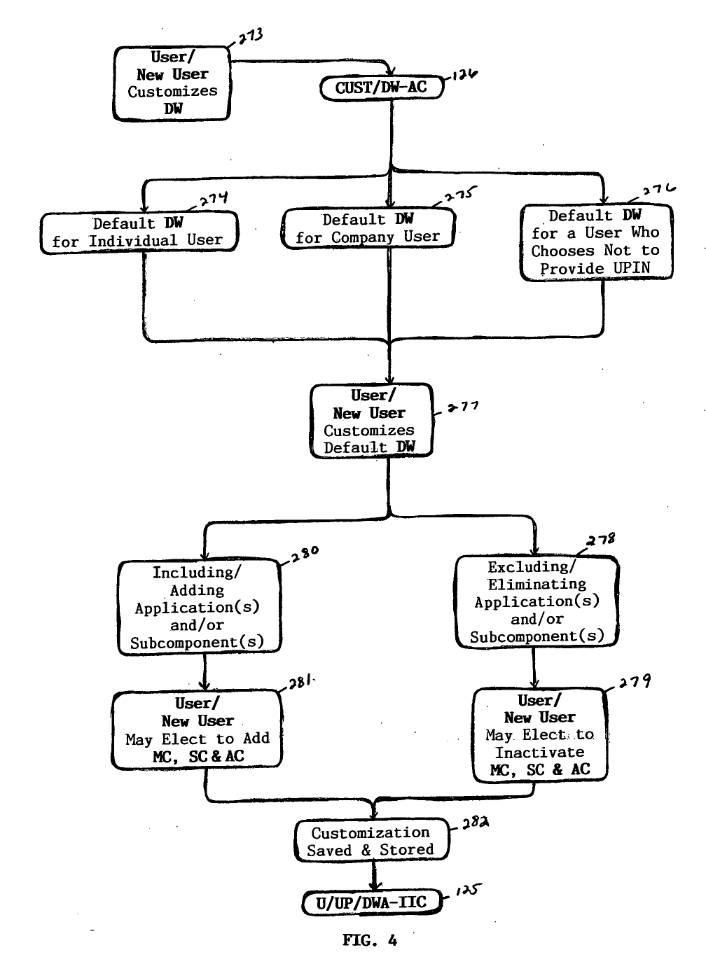

Referring to FIG. 4, there is a flow diagram of a manner of operation of an aspect of the present invention illustrating the process of an application allowing a new user and user to customize his digital wallet.

In particular, a “User and New User may customize his digital wallet” 273, by selecting the CUST/DW-AC 126 function of a U/DW 124, which is an application operating the customization of a user/new user's U/DW 124 at any time a user/new user wishes to adapt his U/DW 124 to fit his needs.

Upon the setting up of a U/DW 124, the DWCS 100 provides a user/new user with an option of 3 different default digital wallet 124: a “Default Digital Wallet for an Individual User 274; a “Default Wallet for a Company/Entity User” 275; and a “Default Digital Wallet for an Individual user choosing not to provide a Unique Personal Identification Number” 276, wherein each default digital wallet contains specific functionalities which best fit each different type of user.

Upon selecting the default digital wallet that best fits his needs, a “User/New User Customizes the Default Wallet” 277.

It should be understood that the herein description of a digital wallet is exemplary of an implementation and/or general structure of a digital wallet. Therefore, it should be appreciated that the enhancements and applications herein described are an exemplary of a default digital wallet, and that other enhancements and applications may complement a digital wallet. Thus such is an advantage of this aspect of the present invention to provide a wide range of complementary enhancements and applications to a digital wallet, as part of the customization of a digital wallet, which includes, but is not limited to, digital business card holder, address book, calendar, scheduling book, calculator, and watch with different zone times, subcomponents with import/export, edit, and display applications, and/or any other functionalities that a traditional wallet typically provides. Thus, a user/new user customizes a default digital wallet by “including/adding specific application(s) and/or subcomponent(s) that are not included in the default digital wallet” 280, wherein a “User/New User may elect to add specific Manager component(s), Subcomponent(s), and/or Application Component(s)” 281, and/or by “Excluding/eliminating Application(s) and/or Subcomponent(s)” 278, wherein a “User/New User may elect to inactivate specific Manager Component(s), Subcomponent(s), and/or Application Component(s)” 279, to best fit his needs, whereafter “the customization modifications are saved and stored” 282 in the U/UP/DWA-IIC 125 of the user/new user's U/DW 124.

A first advantage of this aspect of the present invention resides in the ability of a digital wallet to be customized to fit the needs of a specific user, and thus provides versatility to a digital wallet.

A second advantage of this aspect of the present invention is achieved through the ability of a digital wallet to maintain and manage various types of enhancements, and also a plurality of enhancements of the same type, i.e. a plurality of credit cards, debit cards, identification instruments, license/certification instruments, as well as a plurality of digital wallet accounts, which are operated by the DWCS-F.E. 225, which use the UPIN and a suffix added to each additional digital wallet account. Thus a company/entity user may customize a digital wallet to hold as many digital wallet accounts to manage each different department budget, and further may set up a plurality of log-in information for the purpose to identify the different employees who have access to the company/entity digital wallet.

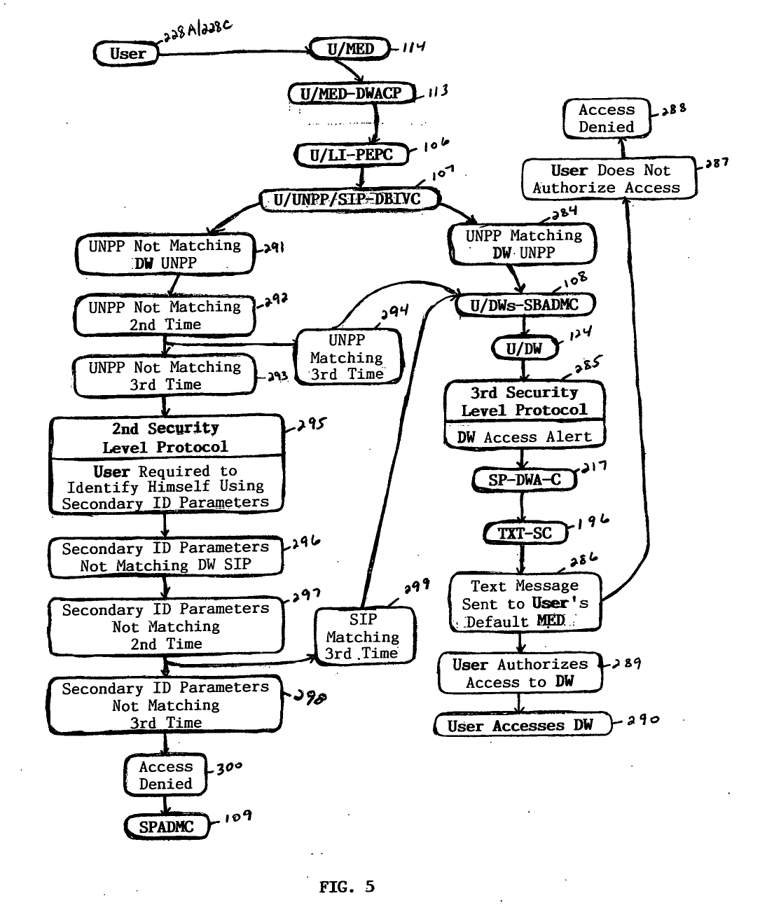

Referring to FIG. 5, there is a flow diagram of a manner of operation of an aspect of the present invention illustrating the process of a user attempting to log-in, but has forgotten his user name, password, PIN, and further illustrating the 2nd security level protocol, which requires a user to identify himself using secondary identification parameters, and yet further illustrating the 3rd security level protocol, which alerts the said user of his digital wallet being accessed, and requiring the said user to authorize such access, before the said user could access his wallet.

In particular, a “User” 228A/228C uses a U/MED 114 to navigate a network, preferably an electronic network such as internet, to connect with the DWCS 100 through the U/MED-DWACP 113 to upload from the U/LI-PEPC 106 the User Log-in Program Exchange Processing software, typically the log-in page of the DWCS 100, which allows the DWCS-UP/DWA-ADMC 101 to interact with a user's U/MED 114 for the entry of the log-in information, such as the User Name, Password, and PIN for the purpose of a user to access his U/DW 124.

First, the user's log-in information is processed through the U/UNPP/SIP-DBIVC 107, which is a software program component that operates to retrieve the User Name, Password, PIN, and Secondary Identification Parameters from the UN/PW/PIN-SC 166 and SIP-SC 167 of the user's U/DW 124 and maintains a data base thereof for the purpose of the log-in process and access to a specific U/DW 124, and further operates to “give 3 chances to a user to enter his correct User Name, Password and PIN” 291, 292, 293, where after the 3rd chance, if the user enters incorrect log-in information, the U/UNPP/SIP-DBIVC 107 runs the “2nd security level protocol, which requires the user to identify himself using his secondary identification parameters” 295, wherein the U/UNPP/SIP-DBIVC 107 operates to “give 3 chances to a user to enter his correct secondary identification parameters” 296, 297, 298, and if the user still fails to enter the correct information on the 3rd time, the “User is denied access” 300 and the SPADMC 109 is alerted.

Second, if however the “User Name, Password, and PIN match with the digital wallet log-in information on the 1st attempt” 284, or “on the 3rd attempt” 294, or “if after the 3rd attempt the secondary identification parameters match” 299, through the U/DWs-SBADMC 108, a user accesses his U/DW 124, and upon accessing his U/DW 124, the U/DWs-SBADMC 108 runs the “3rd security level protocol, which alerts the user that his U/DW 124 is in the process of being accessed” 285, wherein the alert is transmitted through the SP-DWA-C 217 and through the TXT-SC 196, which transmits an “alert text message to the user's default MED” 286, for the “user to authorize the access to his U/DW 124” 289 allowing “him to access his U/DW 124” 290, or for the “user not to authorize the access” 287, which “denies access to his U/DW 124” 288.

A first advantage of this aspect of the present invention is achieved through the 2nd security level protocol, which by requiring the user to identify himself using his secondary identification parameters, when he has forgotten his User Name, Password, and/or PIN, it makes it harder for anyone else to access a user's digital wallet, even when another individual has obtained a user's log-in information, and used it to access a U/DW 124.

A Second advantage of this aspect of the present invention resides in the 3rd security level protocol, which alerts a user of this invention that his digital wallet is in the process of being accessed, before its access is allowed, and further requiring the said user to authorize such access. Thus a user becomes aware of any attempt by someone else to use his digital wallet and further has the control over the access of his digital wallet through his MED.

A third advantage of this aspect of the present invention is further achieved through the 3rd security level protocol, which sends a Digital. Wallet Access Alert to a user's default MED, wherein only through the default MED a user can receive such alert and authorize or deny the access to his digital wallet, whereby preventing anyone else to access a user's digital wallet without the user being alerted, even when someone else has obtained a user's log-in information, and used it to log-in.

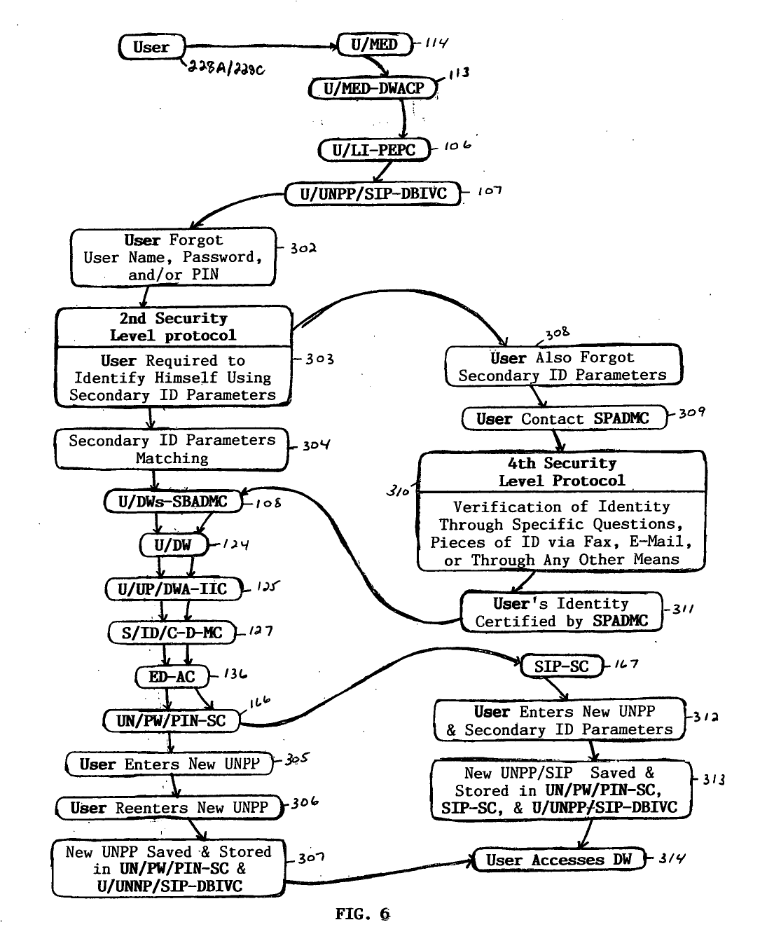

Referring to FIG. 6, there is a flow diagram of a manner of operation of an aspect of the present invention illustrating the process of a user attempting to log-in, who not only has forgotten his User Name, password, and/or PIN, but also has forgotten his Secondary Identification Parameters, and further illustrating the 2nd security level protocol, as shown in FIG. 5, and yet further illustrating the 4th security level protocol, which requires the said user to contact the DWCS customer service to certify his identity, before granting him access to his digital wallet and allowing him to change his User Name, Password, PIN, and/or Secondary Identification Parameters.

In particular, a “User” 228A/228C uses his U/MED 114 to navigate a network, preferably an electronic network such as the internet, to connect with the DWCS 100 through the U/MED-DWACP 113 to upload from the U/LI-PEPC 106 the User Log-in Program Exchange Processing software, typically the log-in page of DWCS 100, which allows the DWCS-UP/DWA-ADMC 101 to interact with a user's U/MED 114 for the entry of log-in information such as the User Name, password, and PIN for the purpose of a user to access his U/DW 124.

First, the user's information is processed through the U/UNPP/SIP-DBIVC 107, and upon entering his log-in information, a “User forgets his User Name, Password, and/or PIN” 302, and by entering the incorrect log-in information, the U/UNPP/SIP-DBIVC 107 runs the “2nd security level protocol, which requires the user to identify himself using his secondary identification parameters” 303. If the “secondary identification parameters match” 304, through the U/DWs-SBADMC 108, the user accesses his U/DW 124 to change his log-in information, through the U/UP/DWA-IIC 125, which is an Instruction Implementation software component of a U/DW 124, operating to process any of the applications of a user's U/DW 124, through the S/ID/C-D-MC 127, wherein the user selects the ED-AC 136, which is an application component that operates to allow a user to edit the data maintained in the UN/PW/PIN-SC 166. Thus, the “User enters new User Name, Password and/or PIN” 305, the “User reenters the new log-in information” 306, whereafter the “New log-in information is saved and stored in the UN/PW/PIN-SC 166 and U/UNNP/SIP-DBIVC 107” 307, and the “User accesses his digital wallet 124” 314.

Second, however, if in addition to having forgotten his' User Name, Password, and/or PIN, when the U/UNPP/SIP-DBIVC 107 runs the “2nd security level protocol and requires the user to identify himself using his secondary identification parameters” 303, the “User also has forgotten his secondary identification parameters” 308, by entering the incorrect information, the “user is required to contact the SPADMC 109” 309, wherein the SPADMC 109 operates all security protocol at the administrative level, which includes, but is not limited to, record all unsuccessful attempt to connect to the DWCS-UP/DWA-ADMC 101 to access a U/DW 124 through the log-in program of the U/UNPP/SIP-DBIVC 107, and also operates to connect a user to a live DWCS customer service agent, who runs the “4th security level protocol, which requires the said agent to verify the identity of such a user through specific questions, pieces of identification via fax, e-mail, or through any other means that allows said agent to verify and certify a user's identification” 310. Thus, if the “User's identity is verified and certified by the DWCS customer service agent of the SPADMC” 311, through the U/DWs-SBADMC 108, the user is granted access to his U/DW 124 to change his log-in information, which is operated through the U/UP/DWA-IIC 125 and S/ID/C-D-MC 127, wherein the user selects the ED-AC 136 to edit the User Name, Password, and/or PIN maintained in the UN/PW/PIN-SC 166, and edit the secondary identification parameters maintained in the SIP-SC 167. Thus, the “User enters new User Name, Password, PIN and Secondary Identification parameters” 312, whereafter the “New Log-in Information is saved and stored in the UN/PW/PIN-SC, SIP-SC and U/UNPP/SIP-DBIVC” 313, and the “User Accesses his Digital Wallet” 314.

An advantage of this aspect of the present invention resides in the 4th security level protocol, wherein eventhough a user has forgotten his user name, password, PIN and/or secondary identification parameters, such a user may contact a DWCS customer service agent to verify and certify his identify to allow him to gain access to his digital wallet and change his log-in information, for the purpose to prevent any otherwise unauthorized person to access a user's digital wallet and further provide such a user with another method to access his digital wallet.

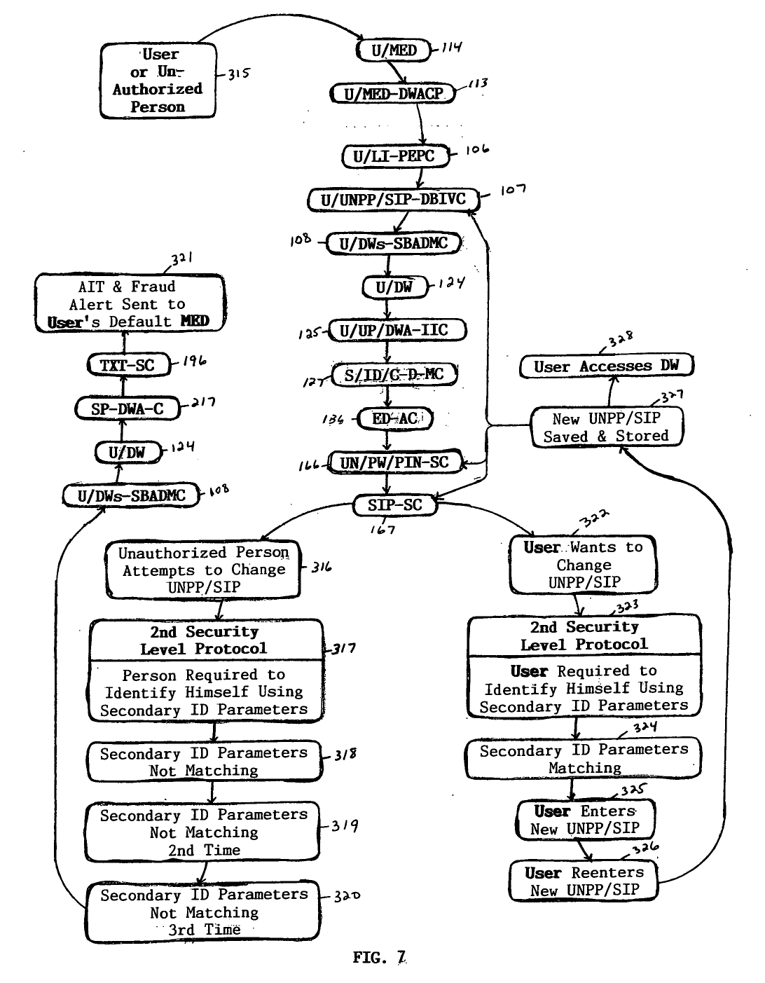

Referring to FIG. 7, there is a flow diagram of a manner of operation of an aspect of the present invention illustrating the process of a user (or unauthorized person) having logged-in a digital wallet, and attempting to change the user name, password, PIN, and/or secondary identification parameters, and further illustrating the 2nd security level protocol, which requires the user to identify himself using his secondary identification parameters, before allowing him to execute the changes.

In particular, a “User or Unauthorized person” 315 “[uses a U/MED 114 to navigate a network, preferably an electronic network such as the internet, to connect to the DWCS 100 through the U/MED-DWACP 113 to upload from the U/LI-PEPC 106 the User Log-in Program Exchange Processing software, typically the log-in page of the DWCS 100, which allows the DWCS-UP/DWA-ADMC 101 to interact with a user's U/MED 114 for the entry of the log-in information, such as the user name, password, and PIN, for the purpose to access his U/DW 124 through the U/UNPP/SIP-DBIVC 107, the U/DWs-SBADMC 108, and through the U/UP/DWA-IIC 125 to select an aspect of the present invention]” hereafter “LOG-IN”.

First, the “User or Unauthorized Person” 315 elects to change his user name, password, PIN and/or secondary identification parameters, by selecting the ED-AC 136 of the S/ID/C-D-MC 127 and further selects the UN/PW/PIN-SC 166 and/or SIP-SC 167.

Second, by an “Unauthorized Person, who attempts to change the log-in information” 316, . . . selecting the said application, the ED-AC 136 runs the “2nd security level protocol, which requires the unauthorized person to identify himself using a user's secondary identification parameters” 317, which allows “3 chances to enter the correct information, where if the information is incorrect” 318, 319, 320, through the U/DWs-SBADMC 108, the U/DW 124, the SP-DWA-C 217 and the TXT-SC 196, an “Aggravated Identity Theft and Fraud alert text message is sent to the user of the U/DW 124 being accessed through the said user's default MED” 321.

Third, by the “User, who elects to change his log-in information” 322, selecting the ED-AC 136, the ED-AC 136 runs the “2nd security level protocol, which requires the user to identify himself using his secondary identification parameters” 323, wherein the “matching of the secondary identification parameters” 324 allows the “User to enter new log-in information” 325, to “reenter the same new log-in information” 326, whereafter, the “New log-in information is saved and stored” 327 in the U/UNPP/SIP-DBIVC 107, the UN/PW/PIN-SC 166, and the SIP-SC 167, and then, the “User accesses his digital wallet” 328, to continue a session.

A first advantage of this aspect of the present invention is achieved through the grid security level protocol, requiring an unauthorized person, who has obtained the log-in information of a user and is in possession of the said user's default MED, such as a friend, a child of the user, the divorced spouse of the user, to identify himself using the secondary identification parameters of the user, before allowing the unauthorized person to execute the changes, thus preventing Such an unauthorized person to maliciously prevent the said user to further access his digital wallet and/or from fraudulently use the said user's digital wallet and its content.

A second advantage of this aspect of the present invention resides in a digital wallet being capable of operating and processing different means of secondary identification parameters, such as, among other means, fingerprints, voice and face recognition, individually and/or in combination, which makes it even harder for an unauthorized person to operate the digital wallet of a user.

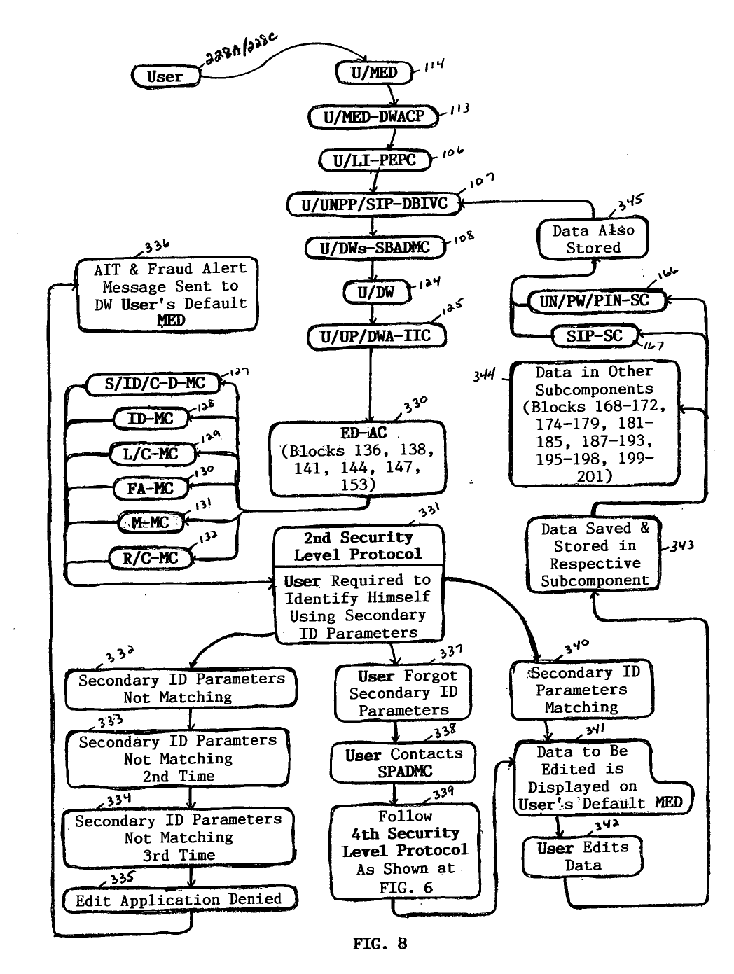

Referring to FIG. 8, there is a flow diagram of a manner of operation of an aspect of the present invention illustrating the process of an application allowing a user to edit a selected data stored in the said user's digital wallet, and further illustrating the 2nd security level protocol, which requires a user to identify himself using his secondary identification parameters, before allowing him to execute the editing of any data, and yet further illustrating the 4th security level protocol, which requires the said user to contact the DWCS customer service to verify and certify the said user's identity, when the said user has forgotten his secondary identification parameters.

In particular, a “User” 228A/228C LOG-IN and elects to edit the data maintained in a selected manager component, by selecting the corresponding ED-AC 136, 138, 141, 144, 147, 153 of the S/ID/C-D-MC 127, ID-MC 128, L/C-MC 129, FA-MC 139, M-MC 131, and R/C-MC 132, wherein the edit application runs the “2nd security level protocol, which requires a user to identify himself using his secondary identification parameters” 331, and which allows 3 chances to a user to enter the correct secondary identification parameters.

First, if the user “enters incorrect secondary identification 3 consecutive times” 332, 333, 334, the “edit application is denied” 335 and an “Aggravated Identity Theft and Fraud alert text message is sent to the user's default MED” 336.

Second, if the “user forgot his secondary identification parameters” 337, the user is required to “contact a SPADMC customer service agent” 338, who is required to “follow the 4th security protocol as shown at FIG. 6, as stated above at [0127]” 339, wherein if the said agent verifies and certifies the user's identity, the user is granted access to his U/DW 124 to execute the editing of selected data, “which are displayed on the said user's default MED” 341, allowing him to edit the selected data” 342.

Third, when the user's “secondary identification parameters match” 340, the “data to be edited is displayed on the user's default MED” 341, allowing him to edit the data” 342, whereafter the “edited data is saved and stored in their respective subcomponents” 343, where “data related to user name, password and PIN is maintained in UN/PW/PIN-SC 166, to secondary identification parameters is maintained in SIP-SC 167, and “data related to personal information, identification instruments, license/certification instruments, fund accounts, messaging, and receipts/confirmation of transactions, are respectively maintained in subcomponents numbered 168-172, 174-179, 181-185, 187-193, 195-198 and 199-201” 344. Furthermore, the “data maintained in UN/PW/PIN-SC 166 and SIP-SC 167 are saved and stored” 345 in the U/UNPP/SIP-DBIVC 107.

A first advantage of this aspect of the present invention is achieved through the 2nd security level protocol, which allows the editing of any data stored in a digital wallet only after the user has correctly provided his secondary identification parameters.

A second advantage of this aspect of the present invention resides in the data stored in a digital wallet being displayed only on a user's default MED, wherein, even in the event that an unauthorized person has obtained a user's log-in information and has accessed the user's digital wallet, such person is prevented from editing any data thereof by the data only being displayed on the user's default MED, and no other.

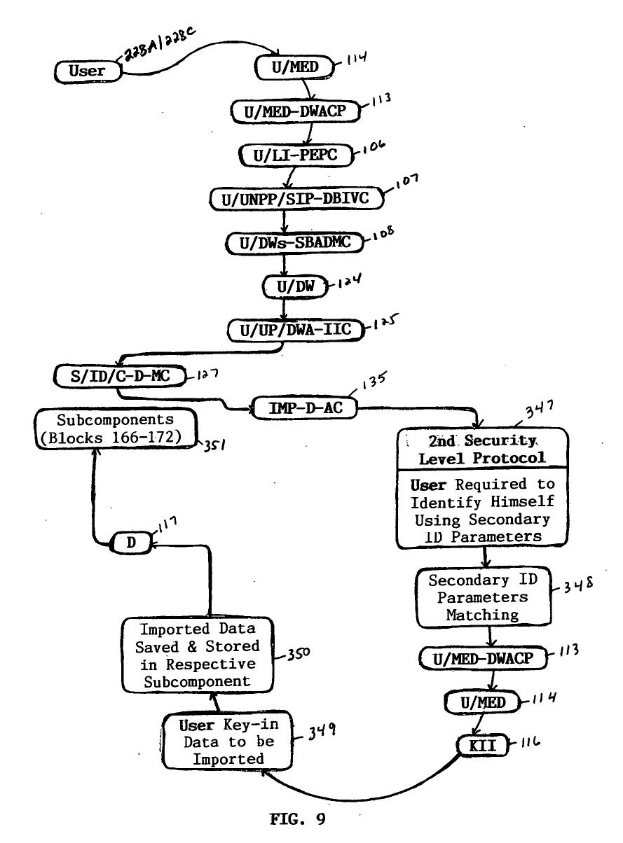

Referring to FIG. 9, there is a flow diagram of a manner of operation of an aspect of the present invention illustrating the process of an application allowing a user to import, save and store personal data in his digital wallet, and further illustrating the 2nd security level protocol, which requires a user to identify himself using his secondary identification parameters, before allowing him to execute any import of such data.

In particular, a “User” 228A/228C LOG-IN, and selects the IMP-D-AC 135 of the S/ID/C-D-MC 127, which is an application operating to allow a user to import personal and other related data into a U/DW 124.

By selecting the IMP-D-AC 135, this application runs the “2nd security level protocol, which requires a user to identify himself using his secondary identification parameters” 347, wherein the “matching of the secondary identification parameters” 348 and through the U/MED-DWACP 113, the U/MED 114, and the KII 116, the “user uses the keys of his MED to key-in the data to be imported” 349, whereafter the “imported data is saved and stored in the respective subcomponents” 350. Thus the “Data” 117 is stored and maintained in “subcomponents 166-172” 351 of the U/DW 124.

In addition of the 3rd security level protocol, as shown at FIG. 5, which alerts a user of his digital wallet being in the process of being accessed, an advantage of this aspect of the present invention resides in the 2nd security level protocol, which allows a user to import personal and other related data into his digital wallet only if he enters the correct secondary identification parameters, and thus making harder for anyone else to import fraudulent data into a user of this invention.

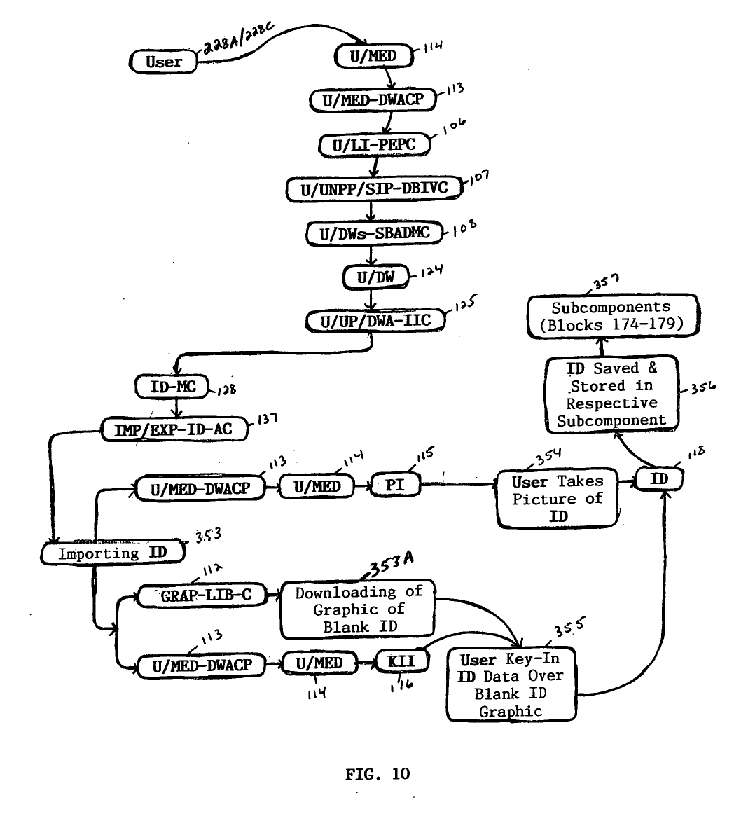

Referring to FIG. 10, there is a flow diagram of a manner of operation of an aspect of the present invention illustrating the process of an application allowing a user to import, save and store identification instruments and data thereof using the camera and keys of his MED.

In particular, a “User” 228A/228C LOG-IN, and selects the IMP/EXP-ID-AC 137 of the ID-MC 128, which operates an application allowing a user to import and export identification instruments and data thereof, and wherein the ID-MC 128 manages all identification instruments as well as any other related enhancements, and further “selects the import aspect of the application” 353.

First, through the U/MED-DWACP 113, the U/MED 114, and using the “camera of a user's MED” 115, a “User may elect to take a picture of the identification instrument” 354.

Second, from the GRAP-LIB-C 112, which is an electronic library of digital wallet enhancement related graphics provided by the DWCS 100 (i.e. graphics of identification instruments, license/certification instruments, financial instruments and other transaction related instruments), wherein the “User downloads a selected graphic of a blank identification instrument” 353A, which is displayed on his U/MED 114, and through the U/MED-DWACP 113, the U/MED 114 and the “keys of the user's MED” 116, a “User may also elect to key-in the data of the identification instrument over the blank graphic” 355.

Third, the “identification instrument” 118 is “saved and stored in their respective subcomponents” 356, which are “subcomponents 174-179” 357 of the U/DW 124.

An advantage of this aspect of the present invention resides in the functionality of a digital wallet that allows a user to import, save and store personal and other related data from his MED.

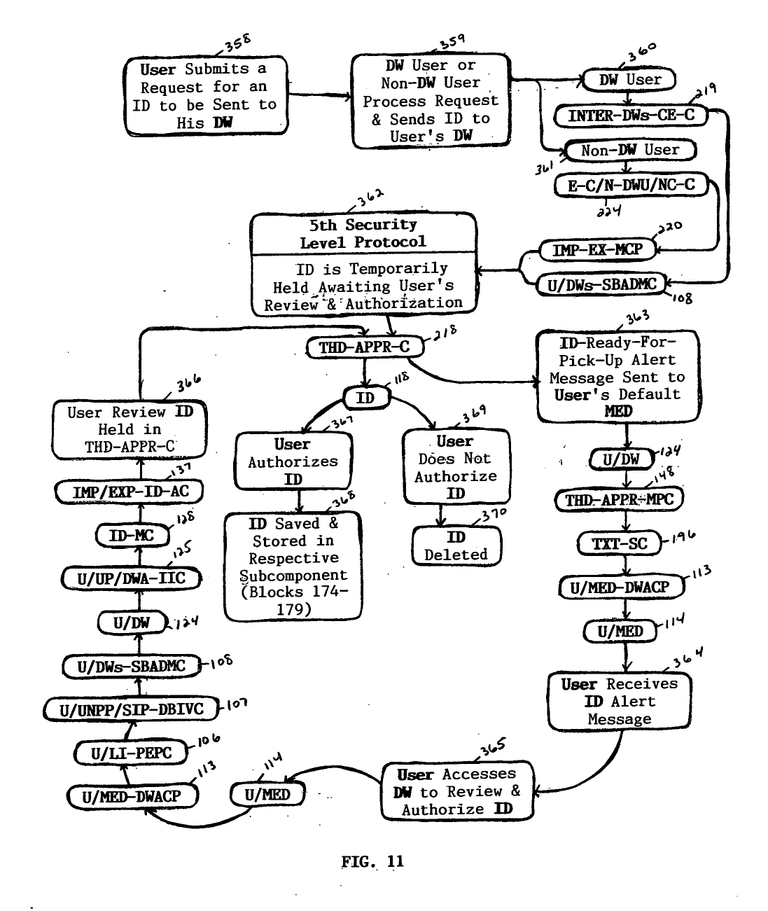

Referring to FIG. 11, there is a flow diagram of a manner of operation of an aspect of the present invention illustrating the process of an application allowing a user, who submitted a request for an identification instrument to be electronically up-loaded to his digital wallet, to have the said instrument be received by the DWCS 100 and stored in a storage component to be temporarily held awaiting for the user to authorize, save and store the said instrument or delete it, and further illustrating the 5th security level protocol, wherein upon the receipt of the said instrument in the storage component, an alert text message is sent to the said user's default MED, requiring him to authorize the said instrument and up-load it in his digital wallet or delete it.

In particular, a “User submits a request for an identification instrument to be electronically sent to his digital wallet” 358 to “another digital wallet user or to a non-digital wallet user of this invention, who processes the said User's request and sends the said instrument to his digital wallet” 359.

First, the identification instrument sent by the “other digital wallet user” 360 is transmitted through the INTER-DWs-CE-C 219, which is a software component that operates the communication exchange between users of this invention and processing all transactions from a user to another, and through the U/DWs-SBADMC 108.

Second, the identification instrument sent by a “non-digital wallet user” 361 is transmitted through the E-C/N-DWU/NC-C 224, which is a software component that operates the communication exchange between a user and a non-user of this invention and processes all electronic transaction therewith, and through the IMP-EX-MCP 220, which is a software component portal that operates all import of transaction data from non-digital wallet users into a digital wallet of a user of this invention.

Third, both the IMP-EX-MCP 220 and the U/DWs-SBADMC 108 run the “5th security level protocol, which transmits an incoming identification instrument into a temporary holding storage component and requires a user to review and authorize the said instrument” 362. Thus, the identification instrument is temporarily stored in the THD-APPR-C 218, which is a software component that operates the temporary holding of an incoming identification instrument, license/certification instrument, financial instrument and any other related instruments, until a user authorizes its downloading into his digital wallet or deletes it.

Fourth, upon the receiving of the said instrument in the THD-APPR-C 218, an “ID-Ready-For-Pick-Up alert text message is sent to the user's default MED” 363. Thus, the alert text message is transmitted through the U/DW 124, the THD-APPR-MPC 148, which is a software component that operates and manage the alert messages that are processed through the THD-APPR-C 218, through the TXT-SC 196, the U/MED-DWACP 113 and the U/MED 114, and “received by the user” 364.

Fifth, upon receiving the alert text message, a “user accesses his digital wallet” 365. Thus, the user LOG-IN (U/MED 114, U/MED-DWACP 113, U/LI-PEPC 106, U/UNPP/SIP-DBIVC 107, U/DWs-SBADMC 108, U/DW 124, U/UP/DWA-IIC 125) and selects the IMP/EXP-ID-AC 137 of the ID-MC 128, wherein the “user accesses the THD-APPR-C 218 to review the identification instrument held therein” 366. Thus, upon the review of the “identification instrument” 118 held in the THD-APPR-C 218, either the “user authorizes it” 367 and “saves and stores it in the respective subcomponents 174-170” 368, or the “user does not authorize it” 369 and “deletes the said instrument” 370.

A first advantage of this aspect of the present invention resides in the 5th security level protocol, wherein before being downloaded into a digital wallet, an incoming identification instrument is temporarily held in a storage component awaiting a user to review and authorize it or delete it, after being alerted that the said instrument is ready to be picked-up and downloaded into his digital wallet, thus preventing a fraudulent downloading of an unauthorized identification instrument into a user's digital wallet.

A second advantage of this aspect of the present invention is achieved through an alert text message being sent to a user's default MED, alerting him that an incoming identification instrument is being held awaiting his review and authorization, wherein only through the user's default MED can a user be alerted of such and authorize or delete the said instrument, thus preventing any other person downloading a fraudulent identification instrument into a user's digital wallet, without the user knowing of it.

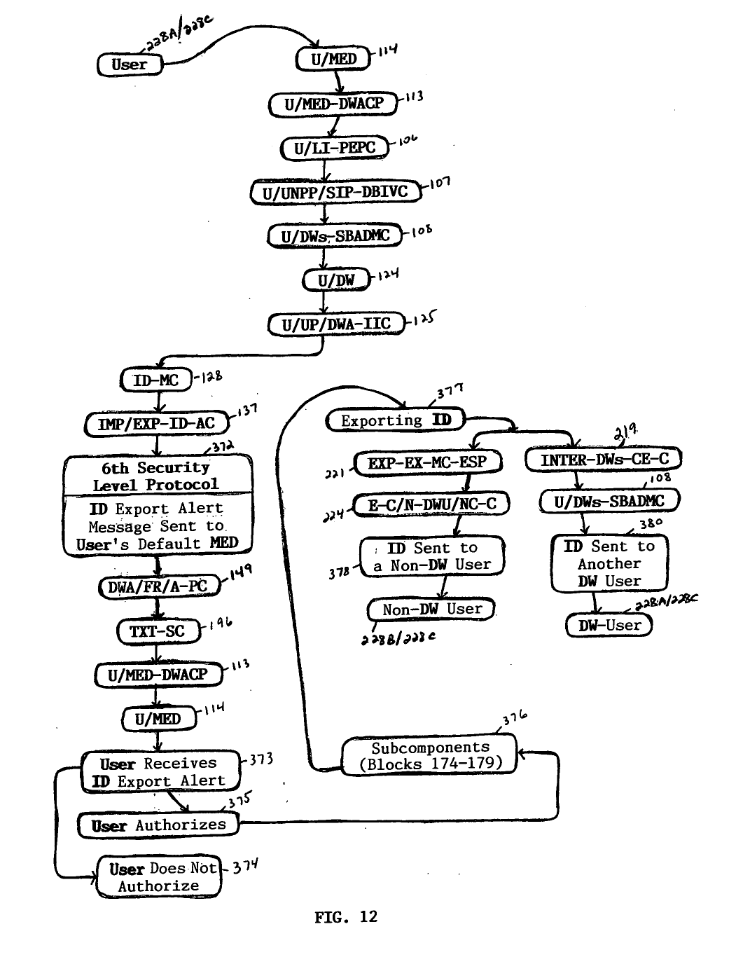

referring to FIG. 12, there is a flow diagram of a manner of operation of an aspect of the present invention illustrating the process of an application allowing a user to export an identification instrument, and further illustrating the 6th security level protocol, wherein an alert text message is sent to the user's default MED, warning him that the export of an identification instrument, stored in his digital wallet, is in the process of being executed, and requiring the said user to authorize the said export, before allowing its execution, or to block the said export.

In particular, a “User” 228A/228C LOG-IN, and selects the IMP/EXP-ID-AC 137 of the ID-MC 128, to export a selected identification instrument.

First, upon selecting the IMP/EXP-ID-AC 137, this application runs the “6th security level protocol, which alerts a user that an identification instrument stored in his digital wallet is in the process of being exported, by sending an alert text message to the user's default MED” 372, which is transmitted through the DWA/FR/A-PC 149, which is a software protocol component that operates the communication of all alerts related to possible fraudulent transactions, through the TXT-SC 196, the U/DWs-SBADMC 108, and the U/MED 114, wherein the “user receives the export alert” 373.

Second, upon receiving . . . the export alert, either the “user does not authorize the export” 374, or the “user authorizes the export” 375 and further selects the identification instrument that he wishes to export from “subcomponents 174-179” 376.

Third, the “exporting of the selected identification instrument” 377 is then either processed through the EXP-EX-MC-ESP 221, which is a software manager component portal with encryption capability that operates all exports of data from a user's digital wallet to be transmitted to a non-digital wallet user, through the E-C/N-DWU/NC-C 224, wherein the “identification instrument is sent to a non-digital wallet user” 378 and is received by that “non-digital wallet user” 228B/228C, or through the INTER-DWs-CE-C 219, the U/DWs-SBADMC 108, wherein the “identification instrument is sent to another digital wallet user” 380 and is received by that “digital wallet user” 228A/228C.

A first advantage of this aspect of the present invention resides in a digital wallet operating an application allowing a user of this invention to export an identification instrument stored in his digital wallet to either another user of this invention or a non-digital wallet user.

A second advantage of this aspect of the present invention is achieved through the 6th security level protocol, which alerts a user of a digital wallet of an export of an identification instrument being in the process of being executed and requiring the said user to authorize the export, before its execution, providing a user with control over his digital wallet.

A third advantage of this aspect of the present invention further resides in a digital wallet operating to send an alert text message to a user's default MED, reporting the export of an identification instrument being in process, and requiring the user to authorize the said export through his default MED and only through his default MED, before the execution of the said export, thus preventing anyone else to intrude a user's digital wallet and attempt to export any identification instrument stored therein.

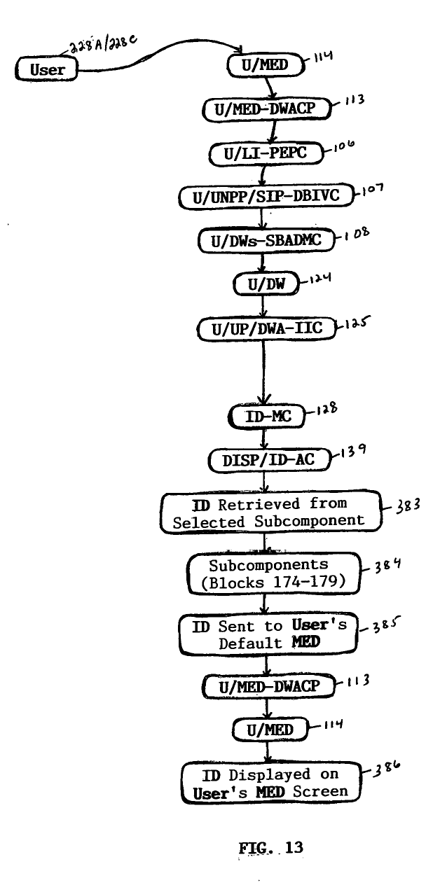

Referring to FIG. 13, there is a flow diagram of a manner of operation of an aspect of the present invention illustrating the process of an application allowing a user to retrieve an identification instruments and display it on the screen of the said user's default MED.

In particular, a “User” 228A/228C LOG-IN, and selects the DISP-ID-AC 139, which is a software component operating the displaying of an identification instrument, stored in a digital wallet, on a user's default MED, of the ID-MC 128, wherein the “identification instrument is retrieved from a selected subcomponent” 383, which is from “subcomponents 174-179” 384, and the “identification instrument is transmitted to the user's default MED” 385, by transmitting it through the U/MED-DWACP 113 and the U/MED 114, for the “identification instrument to be displayed on the screen of the user's default MED” 386.

An advantage of this aspect of the present invention is achieved through a digital wallet operating an application that allows a user to retrieve and transmit an identification instrument, stored in his digital wallet, on the user's default MED to be displayed on its screen.

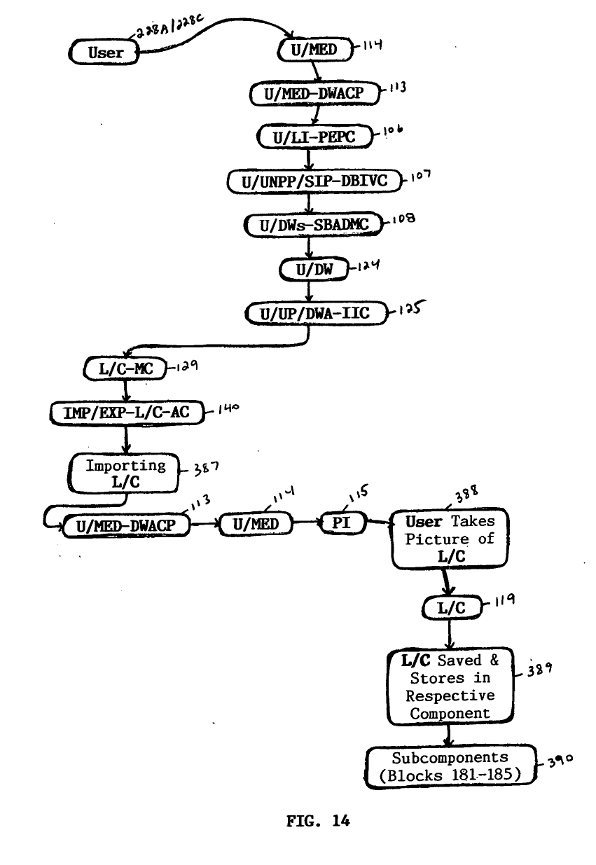

Referring to FIG. 14, there is a flow diagram of a manner of operation of the present invention illustrating the process of an application allowing a user to import license/certification instruments using the camera of the said user's MED.

In particular, a “User” 228A/228C LOG-IN, and selects the IMP/EXP-L/C-AC 140, which is a software component that operates an application allowing a user to import and export license/certification instruments into a digital wallet, of the L/C-MC 129, which is a software component that operates and manages all license/certification instruments as well as any other related enhancements, and further selects the “import functionality” 387.

Thus, through the U/MED-DWACP 113, the U/MED 114 and using the “camera of a user's MED” 115, a “user may elect to take a picture of the license/certification instrument” 388, wherein the “license/certification instrument” 119 is “saved and stored in its respective subcomponent” 389, which is subcomponents 181-185″ 390 of a digital wallet.

An advantage of this aspect of the present invention is achieved through a digital wallet operating an application that allows a user to import a license/certification instrument by using the camera of his MED.

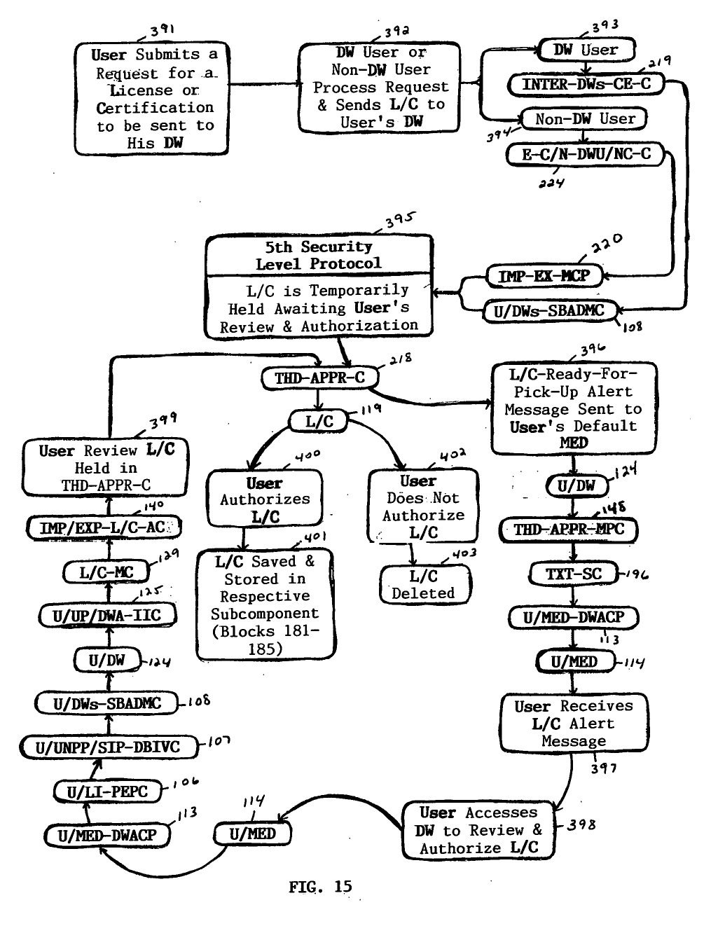

Referring to FIG. 15, there is a flow diagram of a manner of operation of an aspect of the present invention illustrating the process of an application allowing a user, who submitted a request for a license/certification instrument to be electronically up-loaded in his digital wallet, to have the license/certification instrument be received by the DWCS 100 and stored in a storage component to be temporarily held awaiting for the user to authorize, save and store the said license/certification instrument or delete it, and further illustrating the 5th security level protocol, wherein upon the receipt of the license/certification instrument in the storage component, an alert text message is sent to the said user's default MED, requiring him to authorize the said instrument and up-load it in his digital wallet or delete it.

In particular; a “User submits a request for a license/certification instrument to be electronically sent to his digital wallet” 391 to “another digital wallet user or to a non-digital wallet user of this invention, who processes the said User's request and sends the said instrument to his digital wallet” 392.

First, the license/certification instrument sent by the “other digital wallet user” 393 is transmitted through the INTER-DWs-CE-C 219 and through the U/DWs-SBADMC 108.

Second, the license/certification instrument sent by a “non-digital wallet user” 394 is transmitted through the E-C/N-DWU/NC-C 224 and through the IMP-EX-MCP 220.

Third, both the IMP-EX-MCP 220 and the U/DWs-SBADMC 108 run the “5th security level protocol, which transmits an incoming license/certification instrument into a temporary holding storage component and requires a user to review and authorize the said instrument” 395. Thus, the license/certification instrument is temporarily stored in the THD-APPR-C 218.

Fourth, upon the receiving of the said instrument in the THD-APPR-C 218, an “ID-Ready-For-Pick-Up alert text message is sent to the user's default MED” 396. Thus, the alert text message is transmitted through the U/DW 124, the THD-APPR-MPC 148, the TXT-SC 196, the U/MED-DWACP 113 and the U/MED 114, and “received by the user” 397.

Fifth, upon receiving the alert text message, a “User accesses his digital wallet” 398. Thus, the user LOG-IN and selects the IMP/EXP-L/C-AC 140, which is a software component that operates an application allowing a user to import and export license/certification instruments and data thereof, of the L/C-MC 129, which is a software component that operates and manages all license/certification instruments as well as any other related enhancements, wherein the “user accesses the THD-APPR-C 218 to review the license/certification instrument held therein” 399.

Thus, upon the review of the “License/certification instrument” 119 held in the THD-APPR-C 218, either the “user authorizes it” 400 and “saves and stores it in the respective subcomponent 181-185” 401, or the “user does not authorize it” 402 and “deletes the said instrument” 403.

A first advantage of this aspect of the present invention resides in a digital wallet operating an application that allows a user to import, save and store license/certification instruments and data thereof a user and non-user of this invention.

A second advantage of this aspect of the present invention is achieved through the 5th security level protocol, wherein before being downloaded into a digital wallet, an incoming license/certification instrument is temporarily held in a storage component awaiting a user to review and authorize it or delete it, after being alerted that the said instrument is ready to be picked-up and downloaded into his digital wallet, thus preventing a fraudulent downloading of an unauthorized license/certification instrument into a user's digital wallet.

A third advantage of this aspect of the present invention further resides in the alert text message being sent to a user's default MED, alerting him that an incoming license/certification instrument is being held awaiting his review and authorization, wherein only through the user's default MED can a user be alerted of such and authorize or delete the said instrument, thus preventing any other person downloading a fraudulent license/certification instrument into a user's digital wallet, without the user knowing of it.

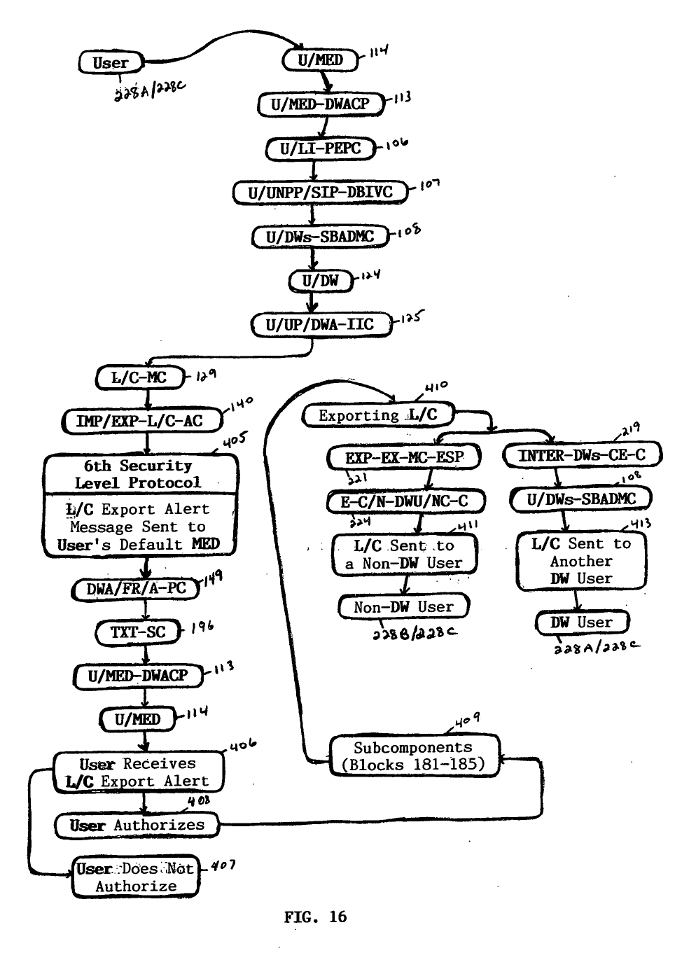

Referring to FIG. 16, there is a flow diagram of a manner of operation of an aspect of the present invention illustrating the process of an application allowing a user to export a license/certification instrument, and further illustrating the 6th security level protocol, wherein an alert text message is sent to the user's default MED, warning him that the export of a license/certification instrument, stored in his digital wallet, is in the process of being exported, and requiring the said user to authorize the said export, before allowing its execution, or to block the said export.

In particular, a “User” 228A/228C LOG-IN and selects the IMP-EXP-L/C-AC 140 of the L/C-MC 129, to export a selected license/certification instrument.

First, upon selecting the IMP/EXP-L/C-AC 140, this application runs the “6th security level protocol, which alerts a user that a license/certification instrument stored in his digital wallet is in the process of being exported, by sending an alert text message to the user's default MED” 405, which is transmitted through the DWA/FR/A-PC 149, through the TXT-SC 196, the U/DWs-SBADMC 108, and the U/MED 114, wherein the “user receives the export alert” 406.

Second, upon receiving the export alert, either the “user does not authorize the export” 407, or the “user authorizes the export” 408 and further selects the license/certification instrument that he wishes to export from “subcomponents 181-185” 409.

Third, the “exporting of the selected license/certification instrument” 410 is then either processed through the EXP-EX-MC-ESP 221, through the E-C/N-DWU/NC-C 224, wherein the “license/certification instrument is sent to a non-digital wallet user” 411 and is received by that “non-digital wallet user” 228A/228C, or through the INTER-DWs-CE-C 219, the U/DWs-SBADMC 108, wherein the “license/certification instrument is sent to another digital wallet user” 413 and is received by that “digital wallet user” 228A/228C.

A first advantage of this aspect of the present invention resides in a digital wallet operating an application allowing a user of this invention to export a license/certification instrument stored in his digital wallet to either another user of this invention or a non-digital wallet user.

A second advantage of this aspect of the present invention is achieved through the 6th security level protocol, which alerts a user of a digital wallet of an export of a license/certification instrument being in the process of being exported and requiring the said user to authorize the export, before its execution, providing a user with control over his digital wallet.

A third advantage of this aspect of the present invention further resides in a digital wallet operating to send an alert text message to a user's default MED, reporting the export of a license/certification instrument being in process, and requiring the user to authorize the said export through his default MED and only through his default MED, before the execution of the said export, thus preventing anyone else to intrude a user's digital wallet and attempt to export any license/certification instrument stored therein.

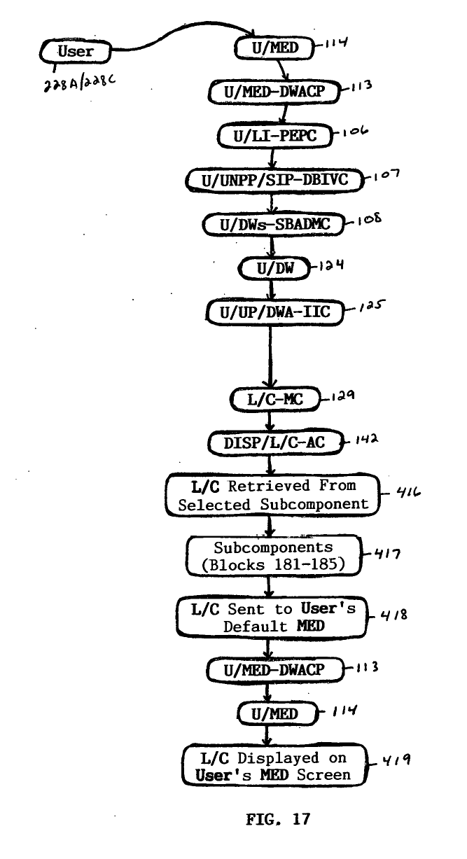

Referring to FIG. 17, there is a flow diagram of a manner of operation of an aspect of the present invention illustrating the process of an application allowing a user to retrieve a license/certification instrument and display it on the screen of the said user's default MED.

In particular, a “User” 228A/228C LOG-IN, and selects the DISP-L/C-AC 142 of the L/C-MC 129, which is a software component operating the displaying of a license/certification instrument, stored in a digital wallet, on a user's default MED, wherein the “license/certification instrument is retrieved from a selected subcomponent” 416, which is maintained in subcomponent 181-185″ 417, and the “license/certification instrument is transmitted to the user's default MED 418, through the U/MED-DWACP 113 and the U/MED 114, for the “license/certification instrument to be displayed on the screen of the user's default MED” 419.

An advantage of this aspect of the present invention resides in a digital wallet operating an application allowing a user to retrieve and transmit a license/certification instrument stored in his digital wallet to his default MED to be displayed on the screen.

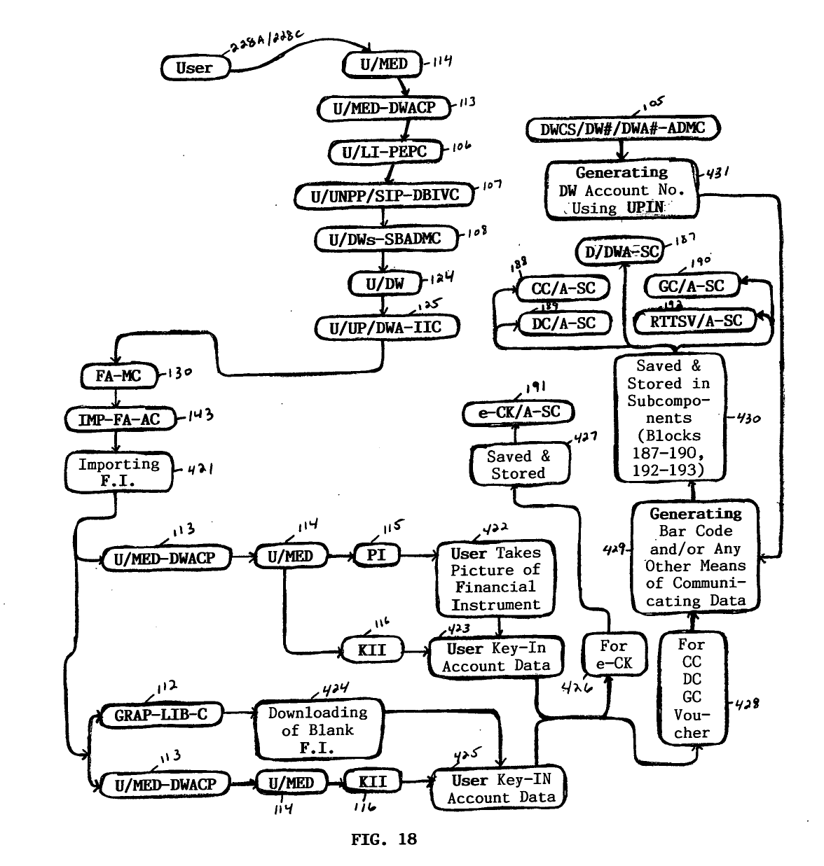

Referring to FIG. 18, there is a flow diagram of a manner of operation of an aspect of the present invention illustrating the process of an application allowing a user to import financial instruments and data thereof using the camera and keys of the said user's default MED, and further illustrating the setting up of a default digital wallet account #, which is generated using the UPIN provided by the user, and yet further illustrating a bar code and/or any other means of communicating financial data, being generated for each financial instrument (except for e-check) and the default digital wallet account, to facilitate an e-commerce transaction, after which the financial instrument and data thereof, and the data of the default digital wallet account are saved and stored in the appropriate subcomponents of the digital wallet.

In particular, a “User” 228A/228C LOG-IN, and selects the IMP-FA-AC 143, which is a software component that operates an application allowing a user to import financial instruments, of the FA-MC 130, which is a software component that operates and manages all financial instruments as well as any other related enhancements, and further “selects the import aspect of the application” 421.

First, through the U/MED-DWACP 113, the U/MED 114, and using the “camera of a user's MED” 115, a “user may elect to take a picture of a financial instrument” 422, and then using the “keys of his MED” 116, the “user key-in the account data thereof” 423.

Second, from the GRAP-LIB-C 112, wherein a “user downloads a selected graphic of a blank financial instrument” 424, which is displayed on his MED 114, and through the U/MED-DWACP 113, the U/MED 114 and the “keys of the user's MED” 116, a “User may elect to key-in the data of the financial instrument over the blank graphic” 425.

Third, the “electronic check” 426 is then “saved and stored” 427 in the e-CK/A-SC 191, which is a software subcomponent that operates to maintain digital checks and data thereof.

Fourth, “for credit cards, debit cards, gift cards, and vouchers” 428, a bar code is generated (or any other means of communicating financial data is generated and/or applied) for each individual financial instrument” 429, whereafter each financial instrument is “saved and stored in their appropriate subcomponent 188-190 and 192-193” 430. Thus, the CC/A-SC 188 is a software subcomponent operating to maintain a digital credit card and its data, the DC/A-SC 189 is a software subcomponent operating to maintain a digital debit card and its data, the GC/A-SC 190 is a software subcomponent operating to maintain a digital gift card and its data, and the RTTSV/A-SC 192 is a software subcomponent operating to maintain a-voucher and data thereof for a Reality TV Talent Show.

Fifth, for the default digital wallet account #, the DWCS/DW#/DWA#-ADMC 105 operates to “generate the said account # using the UPIN provided by a user” 431, wherein a “bar code is generated (or any other means of communicating financial data is generated and/or applied)” 429, whereafter the said financial instrument account is “saved and stored in the appropriate subcomponent 187” 430. Thus, the D/DWA-SC 187 is a software subcomponent operating to maintain the digital financial instrument of the default digital wallet account and its data.

A first advantage of this aspect of the present invention resides in a digital wallet operating an application that allows a user to import financial instruments and data thereof by using the camera and keys of his MED.

A second advantage of this aspect of the present invention is achieved through a digital wallet generating a default digital wallet account number using the UPIN provided by a user of this invention, which, in conjunction with the different security protocols operating in a digital wallet, is used as the sole depository fund account of the digital wallet, for the purpose to provide a greater control over the incoming funds, thus preventing fraudulent or unentitled funds to be deposited in a user's digital wallet by another person.

A third advantage of this aspect of the present invention further resides in a digital wallet generating a bar code (and/or any other means of communicating financial data) for each individual financial instrument containing the necessary account information, including for the default digital wallet account and its account number, but excluding the digital checks, for the purpose to facilitate the consummation of an e-commerce transaction, wherein the exchange of data necessary to consummate such transaction may be achieved by scanning, taping, swipping, and/or any other means, now existing and later developed.

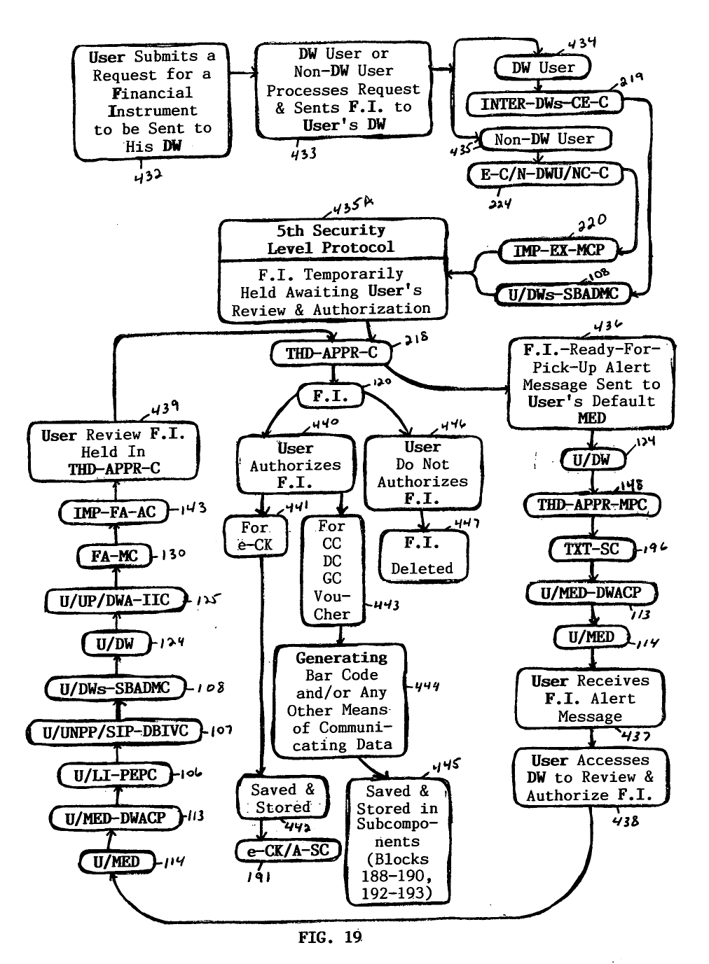

Referring to FIG. 19, there is a flow diagram of a manner of operation of an aspect of the present invention illustrating the process of an application allowing a user, who submitted a request to another user and non-user of this invention, for a financial instrument and data thereof to be electronically uploaded to his digital wallet, to have the financial instrument and data thereof be received by the DWCS 101 and stored in a storage component to be temporarily held awaiting for the said user to authorize, save and store the said instrument or delete it, and further illustrating the 5th security level protocol, wherein upon the receipt of the financial instrument in the storage component, an alert text message is sent to the said user's default MED, requiring him to authorize the said instrument and up-load it in his digital wallet or delete it.

In particular, a “user submits a request for a financial instrument to be electronically sent to his digital wallet” 432 to “another digital wallet user or to a non-digital wallet user of this invention” 433.

First, the financial instrument sent by the “other digital wallet user” 434 is transmitted through the INTER-DWs-CE-C 219, and through the U/DWs-SBADMC 108.

Second, the financial instrument sent by the “non-digital wallet user” 435 is transmitted through the E-C/N-DWU/NC-C 224, and through the IMP-EX-MCP 220.

Third, both the IMP-EX-MCP 220 and the U/DWs-SBADMC 108 run the “5th security level protocol, which transmits an incoming financial instrument into a temporary holding storage component and requires a user to review and authorize the said instrument” 435A. Thus, the financial instrument is temporarily stored in the THD-APPR-C 218.

Fourth, upon the receiving of the said instrument in the THD-APPR-C 218, an “ID-Ready-For-Pick-Up alert text message is sent to the user's default MED” 436. Thus, the alert text message is transmitted through the U/DW 124, the THD-APPR-MPC 148, the TXT-SC 196, the U/MED-DWACP 113 and the U/MED 114, and “received by the user” 437.

Fifth, upon receiving the alert text message, a “user accesses his digital wallet” 438. Thus, the user LOG-IN, and selects the IMP-FA-AC 143 of the FA-MC 130, wherein the “user accesses the THD-APPR-C 218 to review the financial instrument held therein” 439. Thus, upon the review of the “financial instrument” 120 held in the THD-APPR-C 218, either the “user does not authorize it” 446 and “deletes the said instrument” 447, or the “user authorizes it” 440, wherein “for an electronic check” 441, it is “saved and stored” 442 in the e-CK/A-SC 191, and “for credit cards, debit cards, gift cards, and vouchers” 443, a bar code is generated (or any other means of communicating financial data is generated and/or applied) for each individual financial instrument” 444, whereafter each financial instrument is “saved and stored in their appropriate subcomponent 188-190 and 192-193” 445. Thus, the CC/A-SC 188 maintains a credit card and data thereof, the DC/A-SC 189 maintains a debit card and data thereof, the GC/A-SC 190 maintains a gift card and data thereof, and the RTTSV/A-SC maintains a voucher and data thereof.

A first advantage of this aspect of the present invention resides in a digital wallet operating an application that allows a user to import, save and store financial instruments and data thereof from a user and non-user of this invention.

A second advantage of this aspect of the present invention is achieved through a digital wallet generating a bar code (and/or any other means of communicating financial data) for each individual financial instrument containing the necessary account information, but excluding the digital checks, for the purpose to facilitate the consummation of an e-commerce transaction, wherein the exchange of data necessary to consummate such transaction may be achieved by scanning, taping, swipping, and/or any other means, now existing and later developed.

A third advantage of this aspect of the present invention further resides in a digital wallet operating the 5th security level protocol, wherein before downloading into the digital wallet, an incoming financial instrument is temporarily held in a storage component awaiting a user to review and authorize it or delete it, after being alerted that the said instrument is ready to be picked up and downloaded into his digital wallet, thus preventing a fraudulent downloading of an unauthorized financial instrument into a user's digital wallet.

A fourth advantage of this aspect of the present invention is further achieved through a digital wallet operating an application that sends an alert text message to a user's default MED, to alert him that an incoming financial instrument is being held awaiting his review and authorization, wherein only through the user's default MED can a user be alerted of such and can he authorize or delete the said instrument, thus preventing any other person downloading a fraudulent financial instrument into a user's digital wallet, without the user knowing of it.

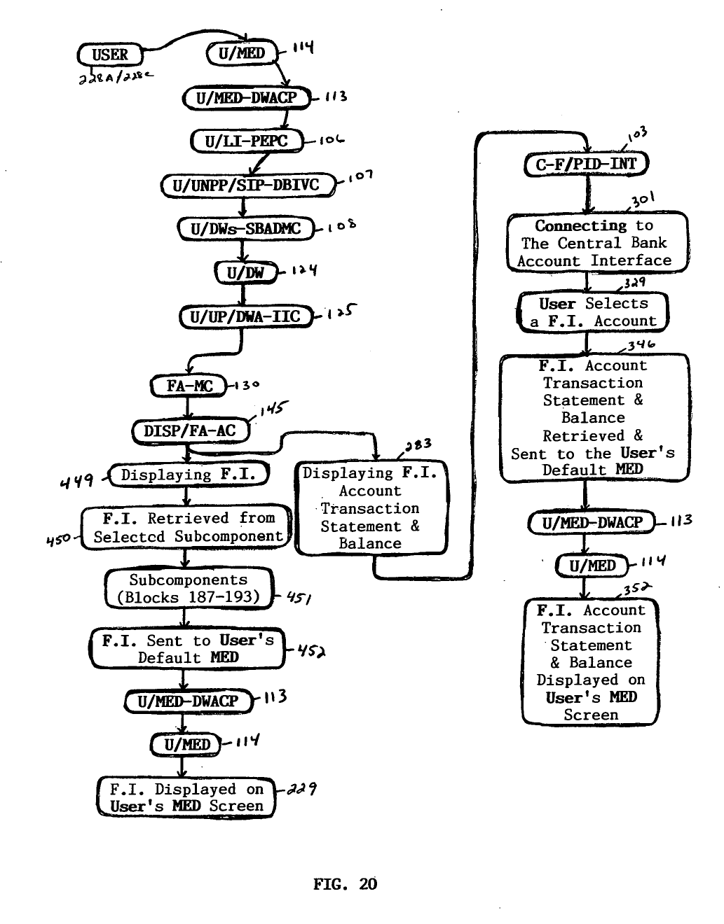

Referring to FIG. 20, there is a flow diagram of a manner of operation of an aspect of the present invention illustrating the process of an application allowing a user to retrieve a financial instrument and data thereof and display them on the screen of the user's default MED, and further illustrating the process of an application allowing the said user to retrieve the transaction statement and balance of a selected financial instrument account, by connecting to the central bank account interface, and display the said data on the said user's default MED screen.

In particular, a “User” 228A/288C LOG-IN, and selects the DISP-FA-AC 145 of the FA-MC 130, which is a software component that operates the displaying of a financial instrument, stored in a digital wallet, on a user's default MED.

First, a user “may elect to display a selected financial instrument” 449, wherein the “financial instrument is retrieved from a selected subcomponent” 450, which is from “subcomponents 187-193” 451, and the “financial instrument is sent to the user's default MED” 452, by transmitting it through the U/MED-DWACP 113 and the U/MED 114, for the “financial instrument to be displayed on the screen of the user's MED” 229.

Second, a user “may elect to display the financial instrument transaction statement and balance thereof” 283. Thus; through the C-F/PID-INT 103, which is a central software system interface that maintains accurate data of financial bank accounts and personal identification information of all individuals and entities, typically the central data system interface to which all banks and other financial and government entities connect to verify the identity and profile of persons and entities and process new bank accounts, loans, government applications and the like, and also to which ATMs all over the world connect in order to process all domestic and international financial transaction and providing a customer with an accurate statement of a selected account and the balance thereof. Thus, upon “connecting to the said central bank account interface” 301, a “user selects a financial instrument account” 329. Thus, upon the selection of a financial instrument, the “financial instrument account transaction statement and balance are retrieved and sent to the user's default MED” 346, which is transmitted through the U/MED-DWACP 113 and the U/MED 114, wherein the “financial instrument account transaction statement and balance are displayed on the screen of the user's default MED” 352.

A first advantage of this aspect of the present invention resides in a digital wallet operating an application that allows a user to display a selected financial instrument and data thereof.

A second advantage of this aspect of the present invention is achieved through a digital wallet operating an application that allows a user to retrieve and display the transaction statement and balance of a selected financial instrument account through the central bank account interface (C-F/PID-INT 103).

A third advantage of this aspect of the present invention further resides in a digital wallet operating an application, which displays a financial instrument and data thereof, stored in a digital wallet, and the transaction statement and balance of a financial instrument account, only on the screen of a user's default MED, thus preventing anyone else who gained access to a user's digital wallet to attempt to display the said data on any other MED and thus preventing aggravated identity theft and fraud.

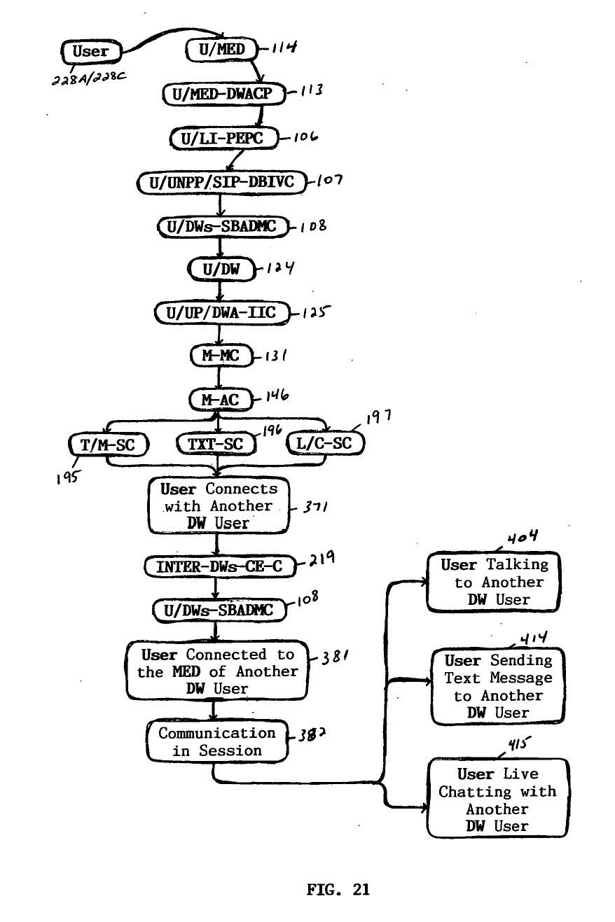

Referring to FIG. 21, there is a flow diagram of a manner of operation of an aspect of the present invention illustrating the process of an application allowing a user to connect with another user's MED to either talk, sent text messages, or chat live.

In particular, a “User” 228A/228C LOG-IN, and selects the M-AC 146, which is a software component operating an application that allows a user to connect with another user's MED to talk, send text messages and live chat, between each other, of the M-MC 131, which is a software component operating and managing all communication aspects of a digital wallet, wherein through the T/M-SC 195, which is a software subcomponent operating the talking functionality, the TXT-SC 196, which is a software subcomponent operating the text messaging functionality, and the L/C-SC 197, which is a software subcomponent operating the live chatting functionality, the “user connects with another digital wallet user” 371 through the INTER-DWs-CE-C 219 and the U/DWs-SBADMC 108, wherein the “user is connected to the other digital wallet user's MED” 381 for both users to have a “communication session” 382, whereby either the “user may elect to talk to another digital wallet user” 404, the “user may elect to send a text message to another digital wallet user” 414, or the “user may elect to live chat with another digital wallet user” 415.

An advantage of this aspect of the present invention resides in a digital wallet operating an application that allows a user to talk to, send text messages to, and live chat with, another user of this invention.

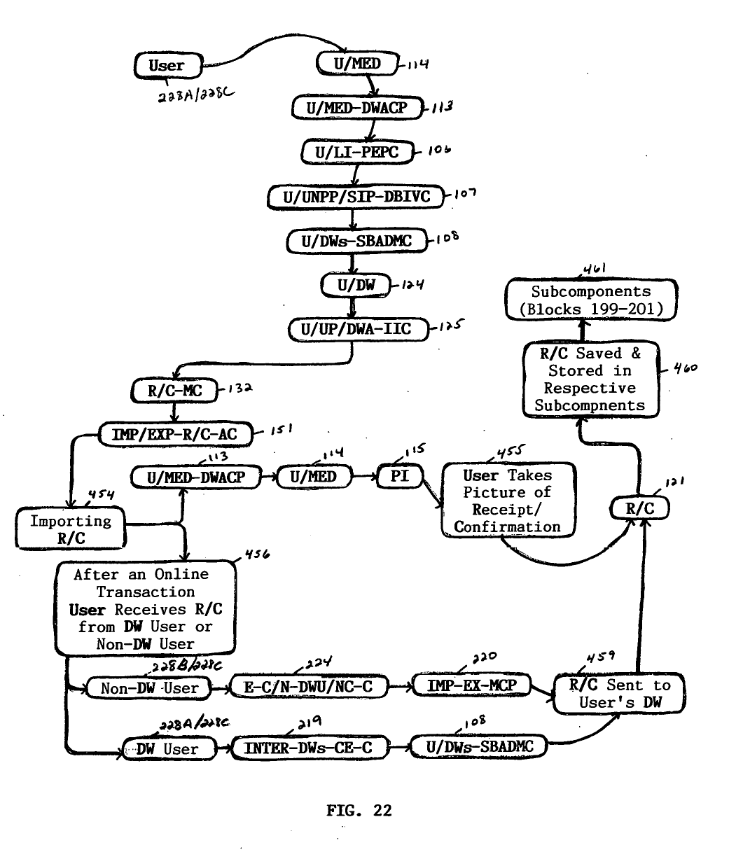

Referring to FIG. 22, there is a flow diagram of a manner of operation of an aspect of the present invention illustrating the process of an application allowing a user, after a transaction has been consummated, to import a receipt/confirmation thereof, by using the camera of the user's MED, and further illustrating the electronic import of a receipt/confirmation of a consummated transaction from another user and non-user of this invention, wherein the said receipt/confirmation is saved and stored in the appropriate subcomponent of the user's digital wallet.

In particular, a “User” 228A/228C LOG-IN, and selects the IMP/EXP-R/C-AC 151, which is a software component operating an application that allows a user to import and export receipts/confirmations of consummated transaction into and from a digital wallet, of the R/C-MC 132, which is a software component operating and managing all receipts/confirmations of consummated transactions and any related enhancement thereof, wherein a user elects to further select the “import functionality” 454.

First, through the U/MED-DWACP 113, the U/MED 114, and the “camera of the user's MED” 115, a “user may elect to take a picture of a receipt/confirmation of a consummated transaction” 455.

Second, “after an online transaction consummated through the user's MED, a user may elect to download a receipt/confirmation of a consummated transaction from a digital wallet user or a non-digital wallet user” 456, wherein the receipt/confirmation of a consummated transaction from a “non-digital wallet user” 228B/228C is transmitted through the E-C/N-DWU-NC-C 224 and the IMP-EX-MCP 220, for the said “receipt/confirmation to be sent to the user's digital wallet” 459, whereas the receipt/confirmation from a “digital wallet user” 228A/228C is transmitted through the INTER-DWs-CE-C 219 and the U/DWs-SBADMC 108, for the said “receipt/confirmation to be sent to the user's digital wallet” 459.

Third, the “receipt/confirmation of a consummated transaction” 121 is then “saved and stored in its respective subcomponents” 460, which are “subcomponents 199-201” 461.

An advantage of this aspect of the present invention resides in a digital wallet operating an application that allows a user to import, save and stored receipts/confirmations of consummated transactions, either from the camera of his MED, or electronically from a user and non-user of this invention.

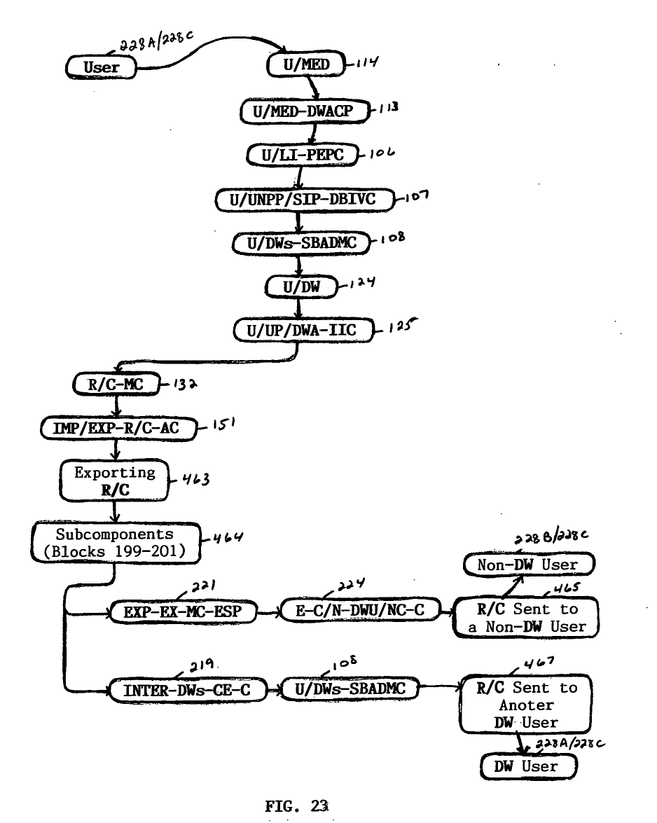

Referring to FIG. 23, there is a flow diagram of a manner of operation of an aspect of the present invention illustrating the process of an application allowing a user to export a receipt/confirmation of a consummated transaction, stored in the user's digital wallet, to another user and non-user of this invention.

In particular, a “User” 228A/228C LOG-IN, and selects the IMP/EXP-R/C-AC 151 of the R/C-MC 132 and further selects the “export functionality” 463, wherein a selected receipt/confirmation of a consummated transaction, stored in the user's digital wallet, is retrieved from “subcomponents 199-201” 464.

First, the selected receipt/confirmation is transmitted through the EXP-EX-MC-ESP 221 and the E-C/N-DWU/NC-C 224 “to be sent to a non-digital wallet user” 465 and received by a “non-digital wallet user” 228B/228C.

Second, the selected receipt/confirmation is transmitted through the INTER-DWs-CE-C 219 and the U/DWs-SBADMC 108, “to be sent to another digital wallet user” 467, and received by the “other digital wallet user” 228A/228C.

An advantage of this aspect of the present invention resides in a digital wallet operating an application that allows a user to export a selected receipt/confirmation of a consummated transaction, stored in his digital wallet, by transmitting it to a user and non-user of this invention.

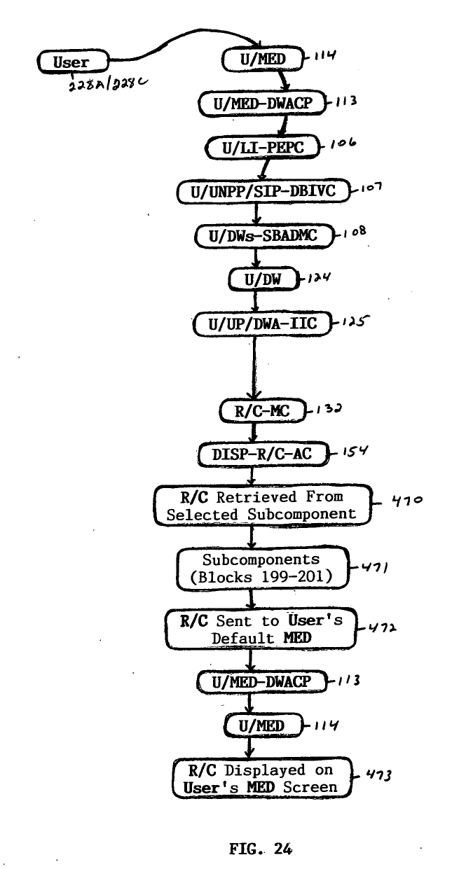

Referring to FIG. 24, there is a flow diagram of a manner of operation of an aspect of the present invention illustrating the process of an application allowing a user to retrieve a receipt/confirmation of a consummated transaction, stored in his digital wallet and display it on the user's default MED screen.

In particular, a “User” 228A/228C LOG-IN, and selects the DISP-R/C-AC 154, which is a software component operating an application that allows a user to display a selected receipt/confirmation of a consummated transaction, stored in his digital wallet, on his default MED, of the R/C-MC 132, wherein the said “receipt/confirmation is retrieved from a selected subcomponent” 470, which is from “subcomponent 199-201” 471, and the “receipt/confirmation is transmitted to the user's default MED” 472, by transmitting it through the U/MED-DWACP 113 and the U/MED 114, for the “receipt/confirmation to be displayed on the screen of the user's default MED” 473.

An advantage of this aspect of the present invention resides in a digital wallet operating an application that allows a user to retrieve and transmit a receipt/confirmation of a consummated transaction, stored in his digital wallet, to be displayed on the screen of the user's default MED.

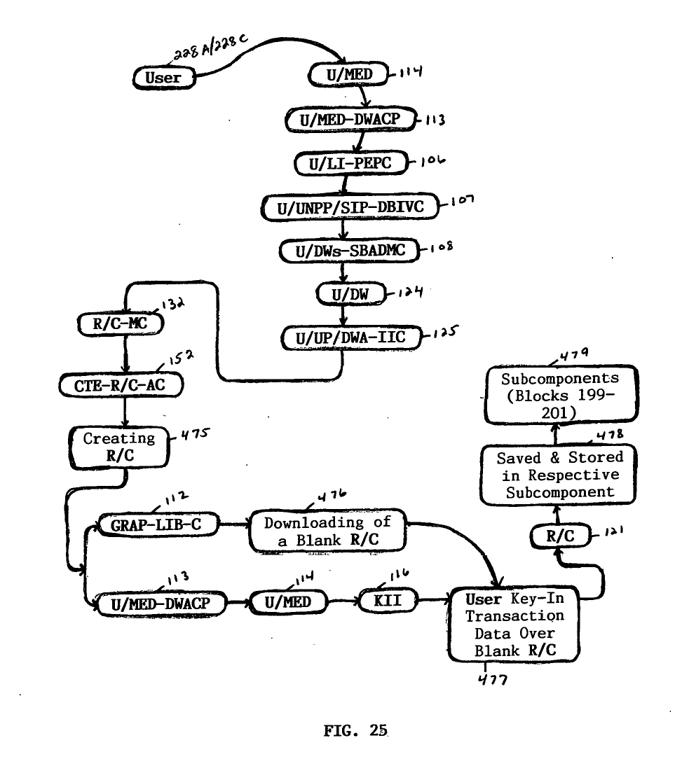

Referring to FIG. 25, there is a flow diagram of a manlier of operation of an aspect of the present invention illustrating the process of an application allowing a user to create a receipt/confirmation of a consummated transaction by using the keys of the said user's default MED.

In particular, a “User” 228A/228C LOG-IN, and selects the CTE-R/C-AC 152 of the R/C-MC 132, which is a software component operating an application that allows a user to create a receipt/confirmation of a consummated transaction, wherein a user further selects the “Create functionality” 475.

First, from the GRAP-LIB-C 112, a user “downloads a blank graphic of a receipt/confirmation” 476, and through the U/MED-DWACP 113, the U/MED 114 and the “keys of the user's MED” 116, the “user elects to key-in the transaction data over the blank graphic of a receipt/confirmation” 477.

Second, the created “receipt/confirmation” 112 is “saved and stored in its appropriate subcomponent” 478, which is “subcomponent 199-201” 479.

An advantage of this aspect of the present invention resides in a digital wallet operating an application that allows a user to create, save and stored a receipt/confirmation of a consummated transaction, by using the keys of his MED.

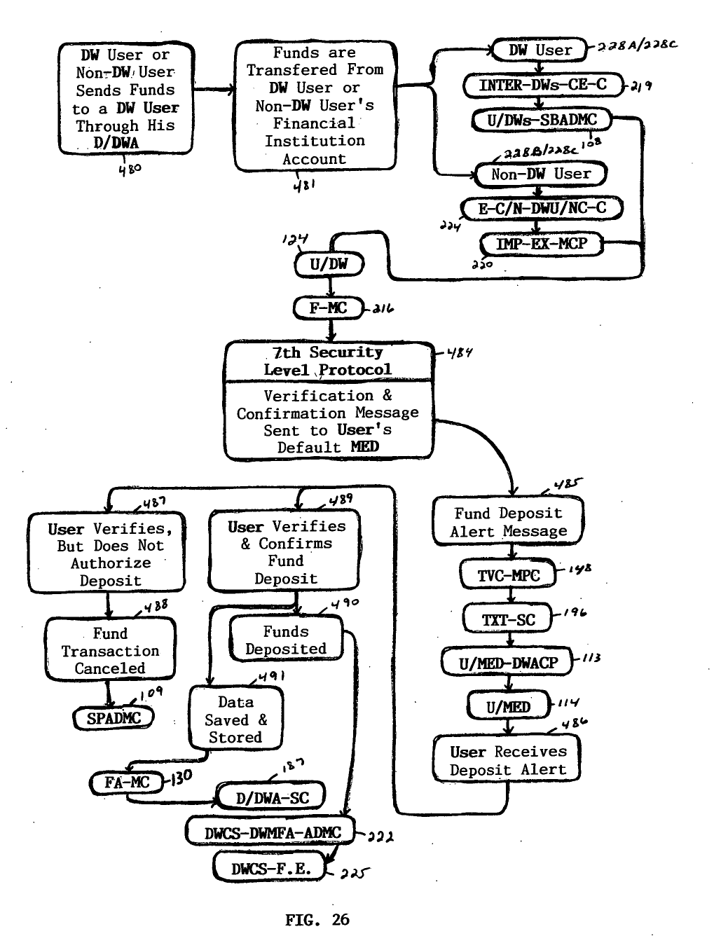

Referring to FIG. 26, there is a flow diagram of a manner of operation of an aspect of the present invention illustrating the process of an application allowing a user to have funds transferred from another user and non-user of this invention, into his default digital wallet account, and further illustrating the 7th security level protocol, wherein an alert text message is sent to the user's default MED, warning him that a deposit of funds is in the process of being executed, and requiring him to verify and confirm the said deposit, before the deposit is finalized or to cancel it and alert the DWCS customer service.

In particular, “another digital wallet user or a non-digital wallet user sends funds to a digital wallet user through his default digital wallet account” 480, wherein the “funds are transferred from the other digital wallet user or non-digital wallet user's financial institution account” 481.

First, the funds sent by “another digital wallet user” 228A/228C is transferred through the INTER-DWs-CE-C 219 and the U/DWs-SBADMC 108.

Second, the funds sent by a “non-digital wallet user” 228B/228C is transferred through the E-C/N-DWU/NC-C 224 and the IMP-EX-MCP 220.

Third, both the U/DWs-SBADMC 108 and IMP-EX-MCP 220 further transfer the funds to a U/DW 124, wherein the data of the fund transaction is transmitted through the F-MC 216, which is a software component operating and managing all fund transactions consummated through a digital wallet, and further runs the “7th security level protocol, which sends a verification and confirmation text message to a user's default MED” 484, wherein the “fund deposit alert message” 485 is transmitted through the TVC-MPC 148, which is a software component operating a security protocol, which alerts a user of a deposit of funds being in process and requiring the user's verification and confirmation before allowing the said deposit transaction to proceed, through the TXT-SC 196, the U/MED-DWACP 113, the U/MED 114, and “received by the user” 486.

Fourth, either the “user verifies the deposit transaction, but does not authorize it” 487, wherein the “fund transactional is canceled” 488 and the user contact the SPADMC 109 (the DWCS customer service), or the “user verifies and confirms the fund deposit” 489, wherein the “funds is deposited” 490 in the DWCS-DWMFA-ADMC 222, which is a software component operating and administering all funds transactions passed through the default digital wallet account of each individual digital wallet hosted by the DWCS 100, and managing the funds thereof, and wherein the said funds are further deposited in the DWCS-F.E. 225, which is the financial institution that holds the DWCS 100 funds under the DWCS 100 master fund account number, which is also generated using the UPIN of the DWCS 100, and the “data of the deposit transaction is saved and stored” 491 in the D/DWA-SC 187 of the FA-MC 130.

A first advantage of this aspect of the present invention resides in a digital wallet operating to receive funds from another user and non-user of this invention, and be deposited and managed through the default digital wallet account of a user's digital wallet.

A second advantage of this aspect of the present invention is achieved through a digital wallet operating a security protocol, which alerts a user of this invention that funds are in the process of being deposited in his default digital wallet account, and requiring the user to verify and confirm his entitlement of the funds, before executing the deposit, thus preventing anyone else to fraudulently use a user's digital wallet to deposit stolen funds, and thus providing a user with more control over his digital wallet and its content.

A third advantage of this aspect of the present invention further resides in a digital wallet operating a security protocol, which sends a deposit alert text message to a user's default MED, thus preventing anyone else from authorizing a fraudulent deposit of funds in the user's digital wallet through any other MED.

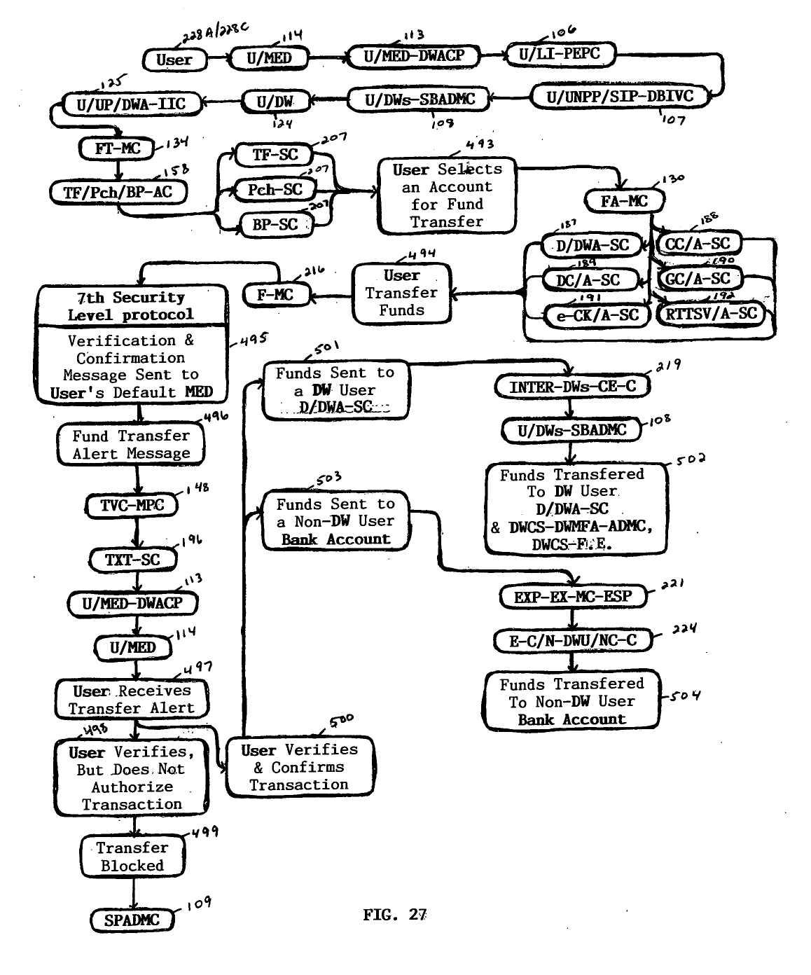

Referring to FIG. 27, there is a flow diagram of a manner of operation of an aspect of the present invention illustrating the process of an application allowing a user to transfer funds to another user and non-user of this invention, to purchase goods and services, and to pay bills, by transferring the funds from a selected financial instrument account, stored in the said digital wallet, and further illustrating the 7th security level protocol, wherein an alert text message is sent to the said user's default MED, warning him that a transfer from his stored financial instrument account is in the process of being executed, and requiring him to verify and authorize the said transfer, before the transfer is executed or cancel it and alert the DWCS customer service.

In particular, a “User” 228A/228C LOG-IN, and selects the TF/Pch/BP-AC 158, which is a software component operating an application that allows a user to transfer funds, purchase goods and services, and pay bills, of the FT-MC 134 which is a software component . . . operating and managing all funds transfers transacted through a digital wallet, wherein a user further selects to transfer funds either through the TF-SC 207, which is a software subcomponent operating to maintain all fund transfer data, the Pch-SC 207, which is a software subcomponent operating to maintain all purchase of goods and services data, or through the BP-SC 207, which is a software subcomponent operating to maintain all bill payment data.

First, the “user selects an account from which the funds is taken for the transfer” 493, wherein through the FA-MC 130, and either the D/DWA-SC 187, the CC/A-SC 188, the DC/A-SC 189, the GC/A-SC 190, the e-CK/A-SC 191, or the RTTSV/A-SC 192, the “user transfers the funds” 494.

Second, the fund transaction is then processed through the F-MC 216, which runs the “7th security level protocol, which sends a verification and confirmation text message to the user's default MED” 495, wherein the “fund transaction alert message” 496 is transmitted through the TVC-MPC 148, the TXT-SC 196, the U/MED-DWACP 113, and the U/MED 114, “to be received by the user” 497, who either “verifies, but does not authorize the transfer” 498, whereby the “transaction is blocked” 499 and the user alerts the SPADMC 109, or the “user verifies and confirms the transfer” 500, whereby the fund transfer is executed.

Third, the “funds sent to a digital wallet user's default digital wallet account (D/DWA-SC 187)” 501 is transferred through the INTER-DWs-CE-C 219 and the U/DWs-SBADMC 108, whereafter the “funds and data thereof are transferred to the digital wallet user's D/DWA-SC 187 and also to the DWCS-DWMFA-ADMC 222 and DWCS-F.E. 225” 502 to be processed and maintained.

Fourth, the “funds sent to a non-digital wallet user's bank account” 503 is transferred through the EXP-EX-MC-ESP 221 and the E-C/N-DWU/NC-C 224, whereafter the “funds and data thereof are transferred to the non-digital wallet user's bank account” 504, to be processed and maintained.

A first advantage of this aspect of the present invention resides in a digital wallet operating an application that allows a user to transact fund transfers from any fund account stored in his digital wallet, to simply transfer money to, to purchase goods and services from, and to pay bills to, another user and non-user of this invention.

A second advantage of this aspect of the present invention is achieved through a digital wallet operating a security protocol, which alerts a user of this invention that funds are in the process of being transferred from a fund account stored in his digital wallet, and requiring him to verify and confirm the said transfer of funds, before executing the transfer, thus preventing anyone else to fraudulently access a user's digital wallet and transfer funds from any of his fund accounts stored in his digital wallet, and thus providing a user with more control over his digital wallet and its content.

A third advantage of this aspect of the present invention further resides in a digital wallet operating a security protocol, which sends a fund transfer alert text message to a user's default MED, thus preventing anyone else from authorizing a fraudulent transfer of funds from a user's digital wallet through any other MED.

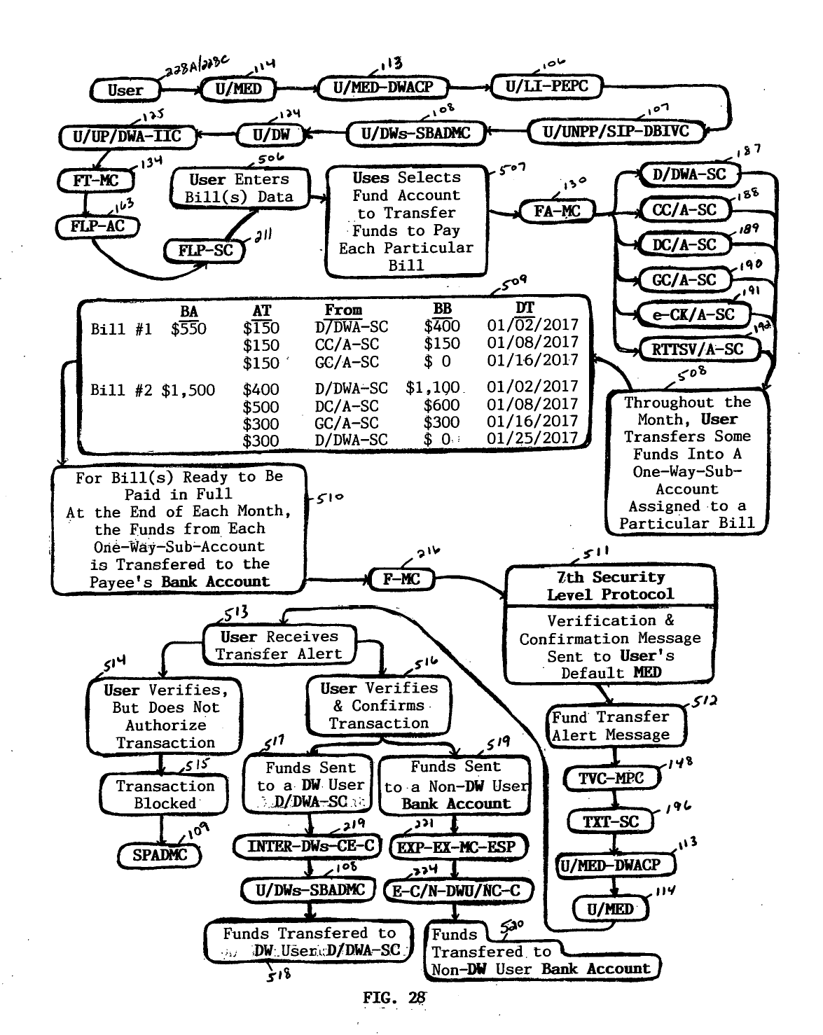

Referring to FIG. 28, there is a flow diagram of a manner of operation of an aspect of the present invention illustrating the process of an application allowing a user to periodically and/or at one time, transfer funds from a selected financial instrument account, stored in his digital wallet, into a one-way sub-account assigned to a particular bill to be paid, wherein at the end of the month, the funds in all one-way-sub-accounts, which are available to pay each bill in full, are automatically transferred to the payee (another user and non-user of this invention) of each bill, and further illustrating the 7th security level protocol, wherein an alert text message is sent to the said user's default MED, warning him that funds transfers are in the process of being executed, and requiring him to verify and authorize the said transfers, before the transfers are executed or cancel them and alert the DWCS customer service.

In particular, a “User” 228A/228C LOG-IN, and selects the FLP-AC 163 of the FT-MC 134, which is a software component operating an application that allows a user to manage his bills to be paid through a “Flex Pay Planner”, wherein the user periodically through the month and/or at one time, deposits funds in a one-way-sub-account assigned to a specific bill to be paid, until the funds are available to pay the bill in full, and further selects the FLP-SC 211, which is a software subcomponent operating to process and maintain the data of the flex pay planner transactions and data thereof.

First, a “user enters the data of a bill to be paid” 506, whereafter the “user selects the financial instrument account from which funds are transferred to pay a specific bill to be paid” 507, wherein through the FA-MC 130 and either through the D/DWA-SC 187, the CC/A-SC 188, the DC/A-SC 189, the GC/A-SC 190, the e-CK/A-SC 191, or the RTTSV/A-SC 192, and “throughout the month, a user transfers some funds into a one-way-sub-account assigned to a particular bill to be paid” 508, where a “One-Way-Sub-Account” is a fund account generated from the default digital wallet account that a suffix is added to differentiate each account, and which is a type of fund account for pay-out only, and not for a user to use the funds therein for other purpose.

Second, “a list of a plurality of bills to be paid indicating the data of each bill, the bill amount (BA), the amount transferred (AT), the origin of the funds (From), the bill balance (BB), and the date of the fund transfer (DT), is generated” 509, which is displayable on the screen of the user's default MED.

Third, “for the bill(s) ready to be paid in full, at the end of the month, the funds available in each one-way-sub-account to pay its respective bill in full, is automatically transferred to the payee's bank account” 510.

Fourth, however, before the execution of the transfers, the transaction data is processed through the F-MC 216, which runs the “7th security level protocol, which sends a verification and confirmation text message to the user's default MED” 511, wherein the “fund transfer text alert message” 512 is transmitted through the TVC-MPC 148, the TXT-SC 196, the U/MED-DWACP 113 and the U/MED 114, “to be received by the user” 513.

Fifth, either the “user verifies, but does not authorize the transactions” 514, whereby the “transactions are blocked” 515, and the user alerts the SPADMC 109, or the “user verifies and confirms the transactions” 516, and either the “funds are sent to a digital wallet user's D/DWA-SC 187” 517 through the INTER-DWs-Ce-C 219 and the U/DWs-SBADMC 108, for the “funds to be transferred to the user's D/DWA-SC 187” 518, or the “funds are sent to a non-digital wallet user's bank account” 519 through the EXP-EX-MC-ESP 221 and the E-C/N-DWU/NC-C 224, for the “funds to be transferred to the non-digital wallet user's bank account” 520.

A first advantage of this aspect of the present invention resides in a digital wallet operating an application that allows a user to manage his bills to be paid through a pay-out-only-flex-pay planner, when a user knows of himself to be undisciplined at paying his bills on time and to have the bad habit of spending his paycheck money on unnecessary things before paying his mortgage, utility bills, etc.

A second advantage of this aspect of the present invention is achieved through a digital wallet operating a security protocol, which alerts a user of this invention that funds are in the process of being transferred from his flex-pay planner one-way-sub-accounts, and requiring him to verify and confirm the said transfers of funds, before executing the transfers, thus preventing anyone else to fraudulently access a user's digital wallet and transfer money from his one-way-sub-accounts and cause a user to fail to pay his bills on time.

A third advantage of this aspect of the present invention further resides in a digital wallet operating a security protocol, which sends a fund transfer alert text message to a user's default MED, thus preventing anyone else from fraudulently authorizing the transfer of funds through the flex-pay planner through any other MED.

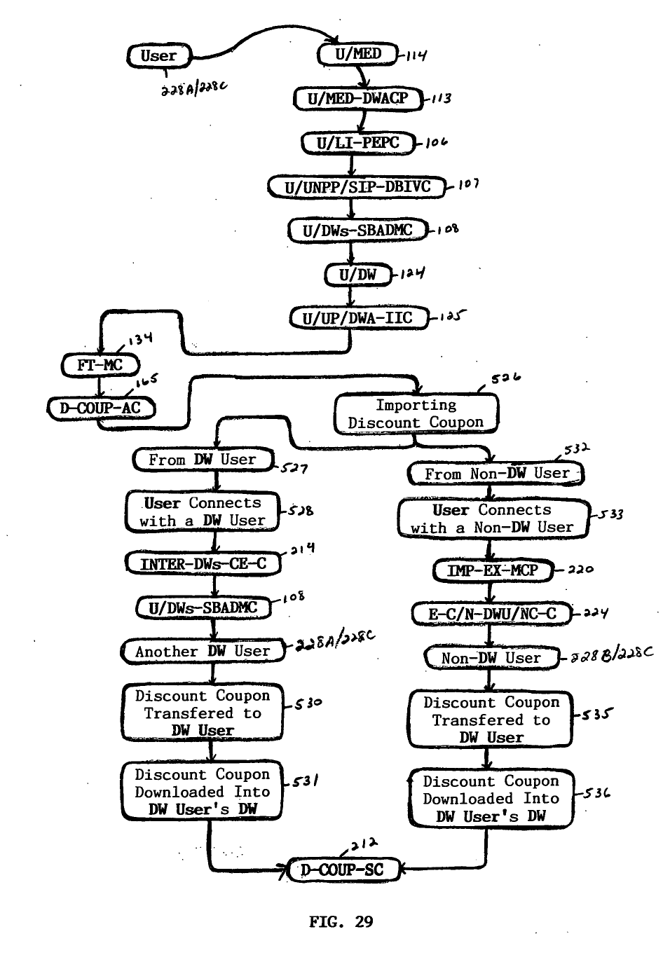

Referring to FIG. 29, there is a flow diagram of a manner of operation of an aspect of the present invention illustrating the process of an application allowing a user to import discount coupons from another user and non-user of this invention, save and store them in the said user's digital wallet awaiting to be consummated.

In particular, a “User” 228A/228C LOG-IN, and selects the D-COUP-AC 165 of the FT-MC 134, which is a software component operating an application that allows a user to import and export discount coupons from a user and non-user of this invention, wherein the user further selects the “import functionality” 526.

First, a discount coupon “from a digital wallet user” 527 is transmitted to a user by the “user connecting with a digital wallet user” 528 and through the INTER-DWs-CE-C 219 and the U/DWs-SBADMC 108, the “other digital wallet user” 228A/228C “transfers the discount coupon to the said user” 530, which is then download into the said user's digital wallet” 531 to be saved and stored in the D-COUP-SC 212, which is a software subcomponent operating to maintain digital discount coupon and data thereof.

Second, a discount coupon “from a non-digital wallet user” 532 is transmitted to a user by the “user connecting with the non-digital wallet user” 533 through the IMP-EX-MCP 220 and the E-C/N-DWU/NC-C 224 for the “non-digital wallet user” 228A/228C “to transfer the discount coupon to the said user” 535, which is then “downloaded into the said user's digital wallet” 536 to be saved and stored in the D-COUP-SC 212.

An advantage of this aspect of the present invention resides in a digital wallet operating an application that allows a user of this invention to import, save and store discount coupons from a user and non-user of this invention and maintain them in his digital wallet until its consummation.

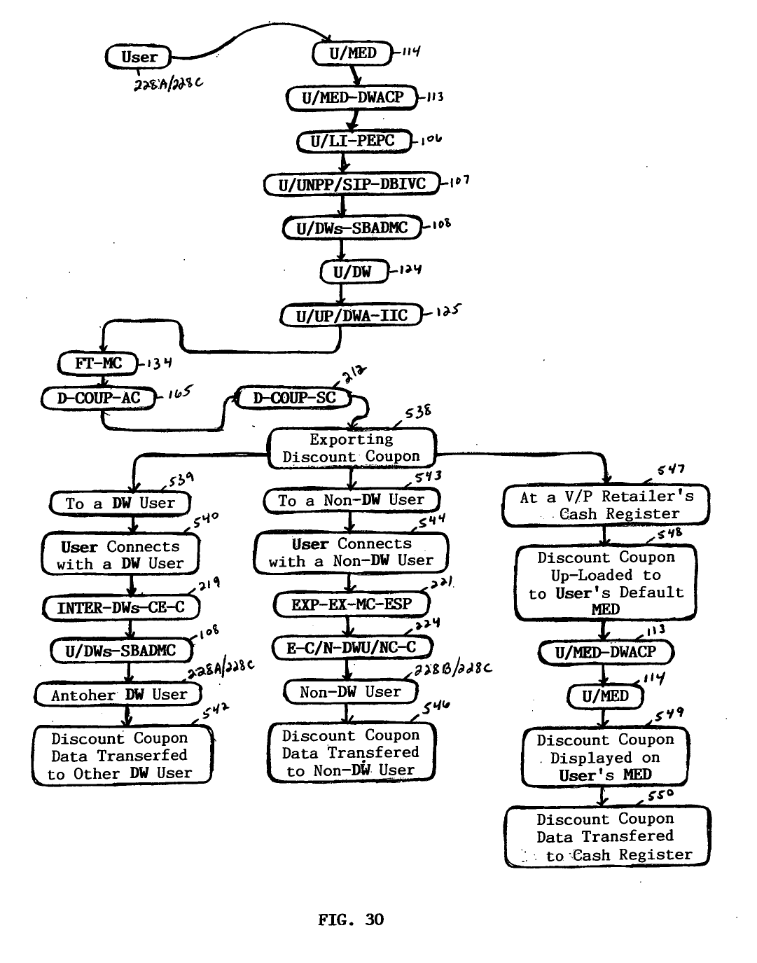

Referring to FIG. 30, there is a flow diagram of a manner of operation of an aspect of the present invention illustrating the process of an application allowing a user to export and consummate a selected discount coupon, stored in his digital wallet, by either electronically transferring the said discount coupon and data thereof to another user and non-user of this invention, and/or by displaying it on the screen of the said user's default MED to consummate it at the cash register at a vender/provider's site.

In particular, a “User” 228A/228C LOG-IN, and selects the D-COUP-AC 165 of the FT-MC 134 and through the D-COUP-SC 212, the user further selects the “export functionality” 538.

First, a user may elect to consummate a selected discount coupon by purchasing an item “from a digital wallet user” 539, by the “user connecting with another digital wallet user” 540 through the INTER-DWs-CE-C 219 and the U/DWs-SBADMC 108, for the “other digital wallet user” 228A/228C to receive the discount coupon, wherein the “discount coupon and data thereof are transferred to the other digital wallet user” 542 and consummated.

Second, a user may elect to consummate a selected discount coupon by purchasing an item “from a non-digital wallet user” 543 by the “user connecting with a non-digital wallet user” 544 through the EXP-EX-MC-ESP 221 and the E-C/N-DWU/NC-C 224, for the “non-digital wallet” 228A/228C to receive the discount coupon, wherein the “discount coupon and data thereof are transferred to the non-digital wallet user” 546 and consummated.

Third, a user may elect to consummate a selected discount coupon by purchasing an item “at a vender/provider retailer's cash register” 547, by the “discount coupon being up-loaded to the user's default MED” 548 through the U/MED-DWACP 113 and U/MED 114, for the “discount coupon and data thereof to be displayed on the screen of the user's MED” 549 and for the “discount coupon and data thereof to be transferred at the cash register” 550 of a vender/provider retailer's site by scanning the bar code thereof.

A first advantage of this aspect of the present invention resides in a digital wallet operating an application that allows a user to consummate a discount coupon stored in his digital wallet, by purchasing an item either electronically or at the vender/provider retailer's site, which is either a user or non-user of this invention.

A second advantage of this aspect of this present invention is achieved through a digital wallet operating to up-load a selected discount coupon from the user's digital wallet only on the user's default MED, thus preventing anyone else to access a user's digital wallet and up-load a selected discount coupon on any other MED.

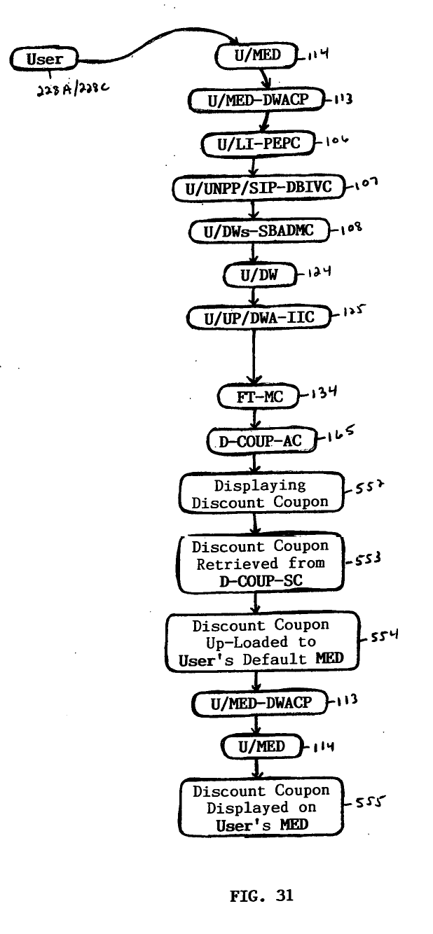

Referring to FIG. 31, there is a flow diagram of a manner of operation of an aspect of the present invention illustrating the process of an application allowing a user to retrieve a selected discount coupon, stored in the user's digital wallet, and display it on the screen of the user's default MED.

In particular, a “User” 228A/228C LOG-IN, and selects the D-COUP-AC 165, which is a software component that also operates to retrieve a selected discount coupon, stored in a user's digital wallet, for the purpose of displaying it on the screen of a user's default MED, of the FT-MC 134, wherein a “selected discount coupon is displayed” 552 by the “discount coupon being retrieve from the D-COUP-SC” 553 to be “up-loaded to the user's default MED” 554 through the U/MED-DWACP 113 and the U/MED 114, for the “selected discount coupon to be displayed on the screen of the user's Default MED” 555.

An advantage of this aspect of the present invention is achieved through a digital wallet operating an application that allows a user to retrieve and transmit a selected discount coupon, stored in his digital wallet, to his default MED to be displayed on its screen.

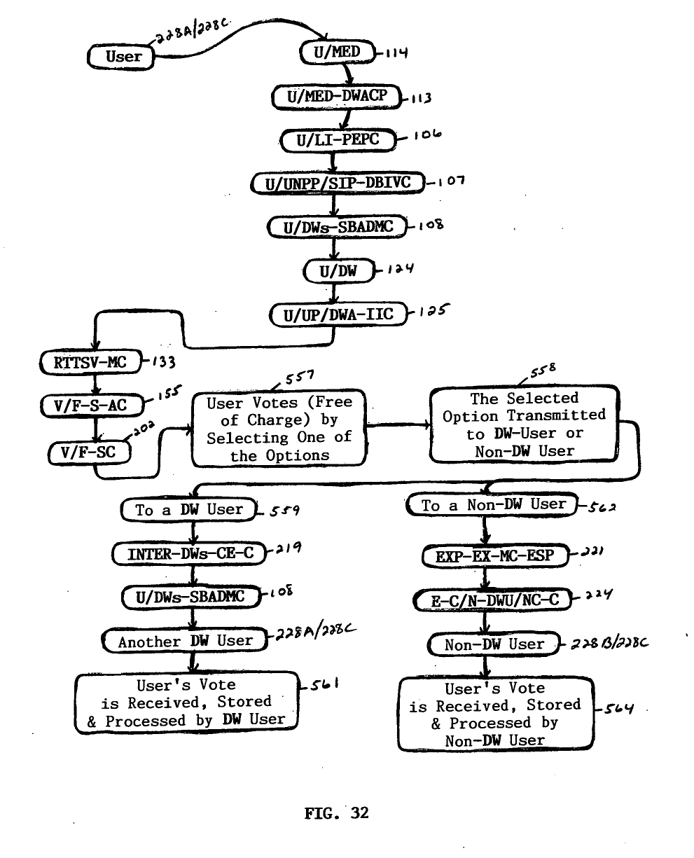

Referring to FIG. 32, there is a flow diagram of a manner of operation of an aspect of the present invention illustrating the process of an application allowing a user to submit a vote, free of charge, for the purpose of a contest of sorts, to another user and non-user of this invention.

In particular, a “User” 228A/228C LOG-IN, and selects the V/F-S-AC 155, which is a software component operating an application that allows a user to submit a vote, free of charge, for the purpose of a contest of sorts, of the RTTSV-MC 133, which is a software component operating and managing the submission of all votes, either free of charge or by the purchase of an item, and the user further selects the V/F-SC 202, which is a software subcomponent operating to process and maintain options downloaded, for the purpose of voting in a contest of sorts, through the website of a user or non-user of this invention, who typically is a Reality TV Talent Show.

First, the “user votes (free of charge) by selecting one of the options” 557 maintained in the V/F-SC 202, wherein the selected option is transmitted to another digital wallet user or non-digital wallet user” 558.

Second, a vote submitted “to a digital wallet user” 559 is transmitted through the INTER-DWs-CE-C 219 and the U/DWs-SBADMC 108, wherein the “other digital wallet user” 228A/228C “receives, stores & processes the user's vote” 561, or a vote submitted “to a non-digital wallet user” 562 is transmitted through the EXP-EX-MC-ESP 221 and the E-C/N-DWU/NC-C 224, wherein the “non-digital wallet user” 228A/228C “receives, stores and processes the user's vote” 564.

An advantage of this aspect of the present invention is achieved through a digital wallet operating an application that allows a user to vote, free of charge, for the purpose of a contest of sorts, typically in a Reality TV Talent Show, whereby the vote is submitted and transmitted to another user or non-user of this invention.

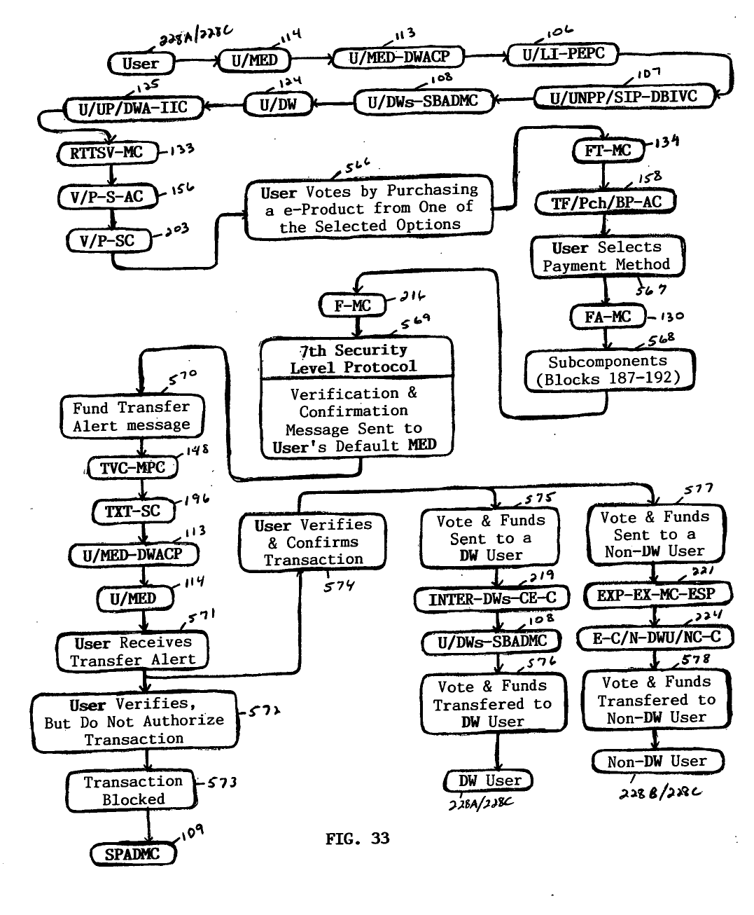

Referring to FIG. 33, there is a flow diagram of a manner of operation of an aspect of the present invention illustrating the process of an application allowing a user to submit a vote by the purchase of a selected item, for the purpose of a contest of sorts, by transferring the required funds to another user or non-user of this invention, and illustrating the 7th security level protocol, wherein an alert text message is sent to the said user's default MED, warning him that a transfer of funds is in the process of being executed, and requiring him to verify and authorize the said transfer, before the transfer is executed or cancel it and alert the DWCS customer service.

In particular, a “User” 228A/228C LOG-IN, and selects the V/P-S-AC 156 of the RTTSV-MC 133, which is a software component operating an application that allows a user to submit a vote by the purchase of an item, for the purpose of a contest of sorts, and the user further selects the V/P-SC 203, which is a software subcomponent operating to process and maintain options downloaded, for the purpose of voting in a contest of sorts, through the website of a user or non-user of this invention, who typically is a Reality TV Talent Show.

First, the “user votes by purchasing an e-product from one of the selected options” 566 maintained in the V/P-SC 203, wherein through the FT-MC 134 and the TF/Pch/BP-AC 158, the “user selects the payment method” 567, for a purchase, and through the FA-MC 130 and the “subcomponents 187-192” 568, which are the financial instrument accounts stored in the user's digital wallet, the user selects the fund account from which the funds is to be transferred to consummate the said purchase.

Second, the data of the purchase transaction is then transmitted through the F-MC 216, which runs the “7th security level protocol, which sends a verification and confirmation text message” 569, wherein the “fund transaction alert message” 570 is transmitted through the TVC-MPC 148, the TXT-SC 196, the U/MED-DWACP 113, the U/MED 114, and “received by the user” 571.

Third, either the “user verifies, but does not authorize the purchase transaction” 572, “blocks the transaction” 573, and alerts the SPADMC 109, or the “user verifies and confirms the said transaction” 574, wherein the “vote and funds are sent to a digital wallet user” 575 through the INTER-DWs-CE-C 219 and the U/DWs-SBADMC 108, whereby the “vote and funds are transferred to the digital wallet user” 576 and received by the “digital wallet user” 228A/228C, or the “vote and funds are sent to a non-digital wallet user” 577 through the EXP-EX-MC-ESP 221 and the E-C/N-DWU/NC-C 224, whereby the “vote and funds are transferred to the non-digital wallet user” 578 and received by the “non-digital wallet user” 228A/228C.

A first advantage of this aspect of the present invention resides in a digital wallet operating an application that allows a user to submit a vote to a user or non-user of this invention, for the purpose of a contest of sorts, by the purchase of an item, from the funds held in the financial instrument account stored in his digital wallet.

A second advantage of this aspect of the present invention is achieved through a digital wallet operating a security protocol, which alerts a user of this invention that funds are in the process of being transferred, from a financial instrument account stored in his digital wallet, and requiring the user to verify and authorize the said transaction, before the transaction is executed or cancel it and alert the DWCS customer service.

A third advantage of this aspect of the present invention further resides in a digital wallet operating a security protocol, which alerts a user of a transfer of funds being in progress, through his default MED, thus preventing anyone else, who has access to a user's digital wallet to authorize the execution of such transfer of funds through any other MED.

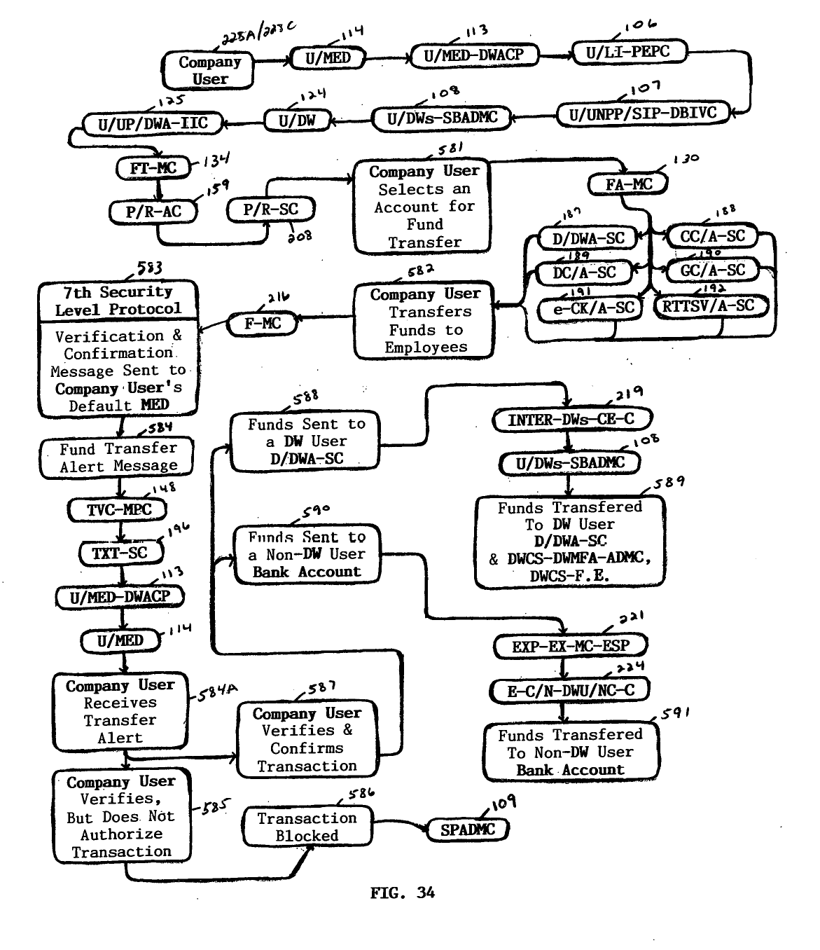

Referring to FIG. 34, there is a flow diagram of a manner of operation of an aspect of the present invention illustrating the process of an application allowing a company user (including a financial and government entity) to transfer funds from a selected financial instrument account, stored in its digital wallet, to its employees, who are users and non-users of this invention, for the purpose of pay rolls, and further illustrating the 7th security level protocol, wherein an alert text message is sent to the said company user's default MED, warning it that transfers of funds are in the process of being executed, and requiring the said company user to verify and authorize the said transfers, before the transfers are executed or cancel them and alert the DWCS customer service and/or other pertinent authority.

In particular, a “company user” 228A/228C LOG-IN, and selects the P/R-AC 159 of the FT-MC 134, which is a software component operating an application that allows a user to process and manage pay rolls for, and electronic transfer of the funds to, its employees, and the company user further selects the P/R-SC 208, which is a software subcomponent operating to process and maintain the data of the said user's pay rolls and employee information.

First, the “company user selects an account from which the funds for its employee pay rolls are transferred” 581, wherein through the FA-MC 130 and either the D/DWA-SC 187, the CC/A-SC 188, the DC/A-SC 189, the GC/A-SC 190, the e-CK/A-SC 191 or the RTTSV/A-SC 192, the “company user transfer the funds to its employees” 582.

Second, the data of the transactions are then processed through the F-MC 216, which runs the “7th security level protocol, which sends a verification and confirmation text message to the company user's default MED” 583, wherein the “fund transfer alert message” 584 is transmitted through the TVC-MPC 148, the TXT-SC 196, the U/MED-DWACP 113, the U/MED 114, and “received by the company user” 584A.

Third, upon receiving the fund transfer alert message, either the “company user verifies, but does not authorize the transfers” 585, “blocks the transaction” 586 and alert the SPADMC 109, or the “company user verifies and confirms the said transfers” 587, whereafter the “funds sent to an employee, who is a digital wallet user and elects to have the funds sent to his default digital wallet account (D/DWA-SC 187)” 588 are transferred through the INTER-DWs-CE-C 219 and the U/DWs-SBADMC 108, wherein the “funds are transferred to the D/DWA-SC, the DWCS-DWMFA-ADMC and DWCS-F.E.” 589, whereas the “funds transferred to an employee, who is a non-digital wallet user and elects to have the funds transferred to his regular bank account” 590 are transferred through the EXP-EX-MC-ESP 221 and the E-C/N-DWU/NC-C 224, wherein the “funds are transferred to the non-digital wallet user's bank account” 591.

A first advantage of this aspect of the present invention resides in a digital wallet operating an application that allows a company user (including financial and government entities) to process and manage pay rolls for its employees and the electronic transfer of funds thereof, from a financial instrument account stored in its digital wallet, where the company user's employees may be a user and non-user of this invention.

A second advantage of this aspect of the present invention is achieved through a digital wallet operating a security protocol, which alerts a company user that funds are in the process of being transferred from a financial instrument account stored in his digital wallet, and requiring the company user to verify and authorize the said transactions, before its execution or cancel them and alert the DWCS customer service.

A third advantage of this aspect of the present invention further resides in a digital wallet operating a security protocol, which alerts a company user of a transfer of funds being in progress, through his default MED, thus preventing anyone else, who has accessed the company user digital wallet to authorize such transfer of funds through any other MED.

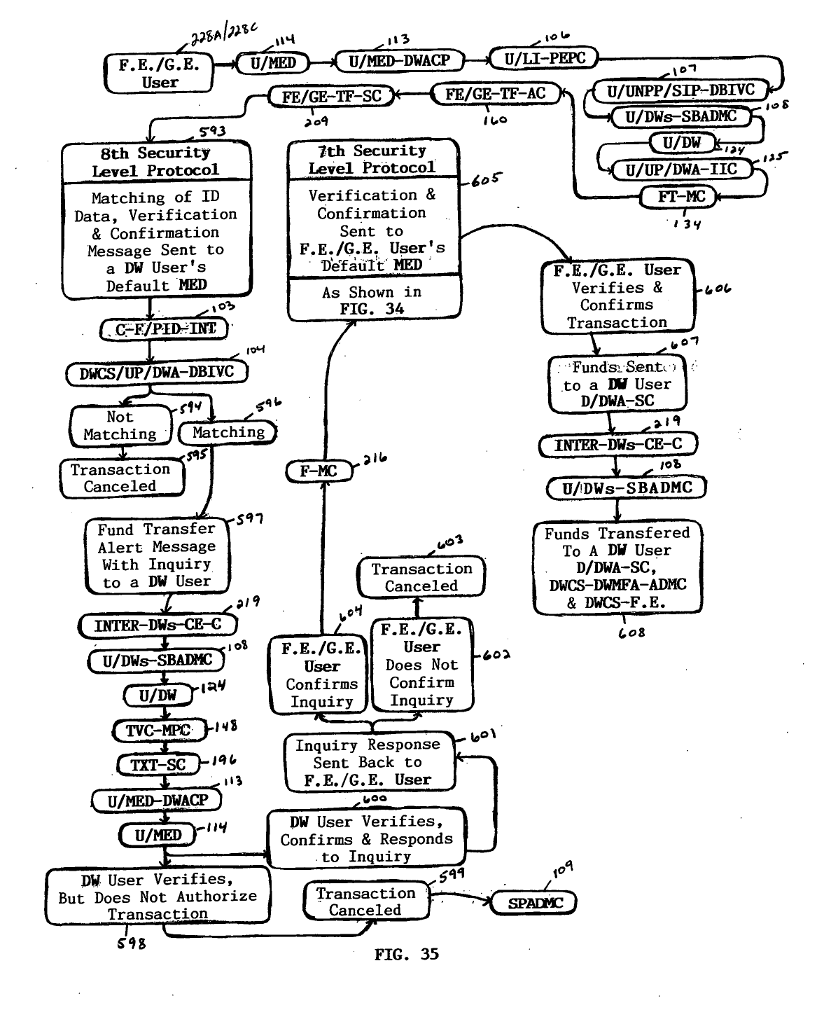

Referring to FIG. 35, there is a flow diagram of a manner of operation of an aspect of the present invention illustrating the process of an application allowing financial and government entity users to transfer funds to another user of this invention, and further illustrating the 8th security level protocol, wherein the identity of the recipient of the funds is verified by sending an alert text message to the said recipient, who is required to either verify, confirm, and correctly respond to an inquiry, or cancel the transaction, whereinafter a said financial or government entity user confirms the identity of the said recipient, the funds are transferred to the said recipient default digital wallet account, and yet further illustrating the 7th security level protocol, wherein an alert text message is sent to the financial and government entity user's default MED, warning it that a transfer of funds is in the process of being executed, and requiring it to verify and authorize the said transfer, before the transfer is executed or cancel the transaction and alert the DWCS customer service and/or other pertinent authority.

In particular, a “financial entity/government entity user” 228A/228C LOG-IN, and selects the FE/GE-TF-AC 160 of the FT-MC 134, which is a software component operating an application that allows a financial entity user and/or a government entity user to transfer funds to another user of this invention, and the said entity user selects the FE/GE-TF-SC 209, which is a software subcomponent operating to process and maintain the data of transfer of funds to a digital wallet user recipient of funds, and further runs the “8th security level protocol, which verifies the identity of a user recipient, by sending a verification and confirmation of identity text message to the user recipient's default MED” 593, wherein through the C-F/PID-INT 103, the said entity user verifies the matching of identity data of the user recipient, and through the DWCS/UP/DWA-DBIVC 104, the said entity user further verifies the matching of identity data of the user recipient with the data base of the DWCS 100.

First, upon verifying the matching of the identity of the user recipient, either the identity data “does not match” 594, whereby the “transaction is canceled” 595, or “it matches” 596, and a “fund transfer alert text message with inquiry is sent to the digital wallet user recipient” 597 through the INTER-DWs-CE-C 219, the U/DWs-SBADMC 108, the U/DW 124, the TVC-MPC 148, the TXT-SC 196, the U/MED-DWACP 113 and the U/MED 114.

Second, upon receiving the fund transfer alert text message, either the “user recipient verifies, but does not authorize the transfer of funds” 598, and the “transaction is canceled” 599 and the user recipient alerts the SPADMC 109, or the “user recipient verifies, confirms the transaction and responds to the inquiry” 600. Thus, the “inquiry response from the user recipient is sent back to the said entity user” 601 and either the “entity user does not confirm the inquiry response” 602 and “cancels the transaction” 603, or the “said entity user confirms the inquiry response” 604 and the fund transfer is processed through the F-MC 216, which runs the “7th security level protocol, as shown in FIG. 33 [0307]”605, wherein “said entity user verifies and confirms the transaction” 606, and the “funds are sent to the digital wallet user recipient's default digital wallet account” 607 through the INTER-DWs-CE-C 216 and the U/DWs-SBADMC 108. Thus the “funds are transferred to the digital wallet user recipient's D/DWA-SC, the DWCS-DWMFA-ADMC and DWCS-F.E.” 608.

A first advantage of this aspect of the present invention resides in a digital wallet operating an application that allows a financial entity and/or government entity user of this invention to transfer funds to a digital wallet user recipient.

A second advantage of this aspect of the present invention is achieved through a digital wallet operating a security protocol, which allows a financial entity user and/or government entity user to verify the identity of a digital wallet user who is the recipient of funds to be transferred, through a central financial and identification data base interface and the DWCS user data base, before transferring the funds.

A third advantage of this aspect of the present invention further resides in a digital wallet operating to send an alert text message of a fund transfer with inquiry to a digital wallet user's default MED, thus permitting a financial entity user and/or government entity user to certify that the person to whom the funds are about to be transferred to is the actual digital wallet user, who is entitled to the said funds, thus preventing that the funds are fraudulently diverted to the wrong person.

A fourth advantage of this aspect of the present invention is further achieved through a digital wallet operating a security protocol, which alerts a financial entity user and/or government entity user that funds are in the process of being transferred from a financial instrument account stored in its digital wallet, and requiring the said entity user to verify and authorize the said transaction, before its execution or cancel it and alert the DWCS customer service and/or any other pertinent authority.

a fifth advantage of this aspect of the present invention yet further resides in a digital wallet operating a security protocol, which alerts a financial entity user and/or government entity user of a transfer of funds being in the process of being executed, through its default MED, thus preventing anyone else, who has access to its digital wallet to authorize such transfer of funds through any other MED.

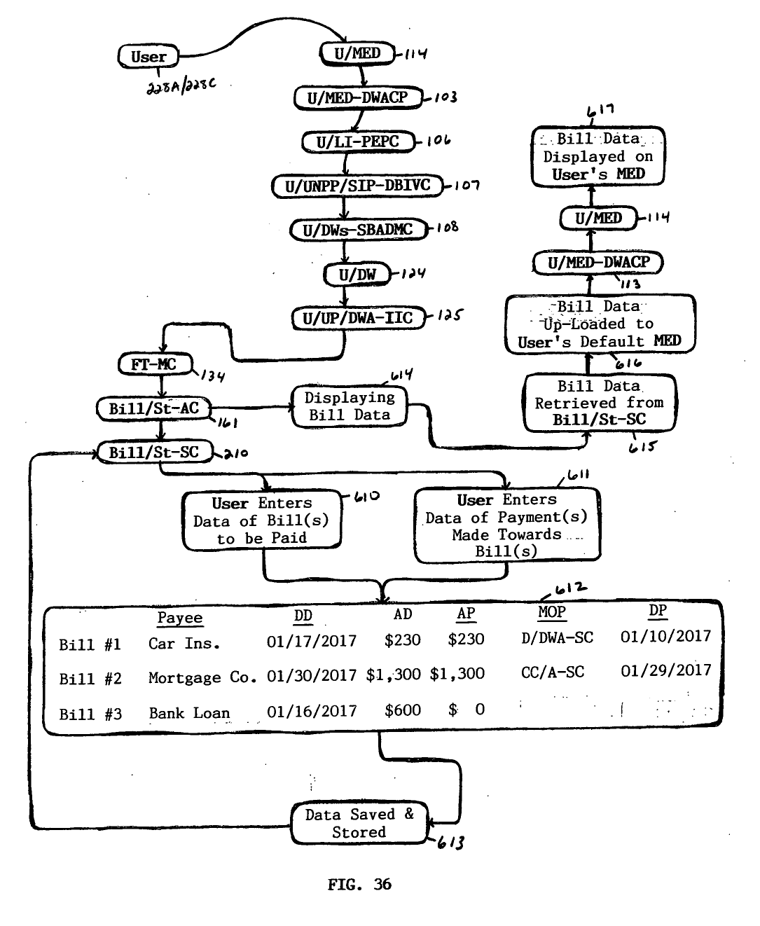

Referring to FIG. 36, there is a flow diagram of a manner of operation of an aspect of the present invention illustrating the process of an application allowing a user to record the data of bill(s) to be paid and data of payment(s) made towards a particular bill, for the purpose of tracking the status of the bill(s) that are yet to be paid, wherein all said recorded data are saved and stored in their appropriate subcomponent(s) of the said user's digital wallet, and further illustrating the said application also allowing a user to retrieve the said recorded data of bill(s) and display it on the screen of the said user's default MED.

In particular, a “User” 228A/228C LOG-IN, and selects the Bill/ST-AC 161 of the FT-MC 134, which is a software component operating an application that allows a user to manage his bills to be paid by recording and maintaining the data of the bills to be paid and payment thereof, and by displaying the said data on the screen of a user's default MED, and the user further selects the Bill/ST-SC 210, which is a software subcomponent operating to process and maintain the data of bills to be paid and payment thereof.

First, a “user enters the data of bill(s) to be paid” 610, and then “enters the data of payment(s) made toward a particular bill” 611, thus, a “statement of the bill status is created” 612, wherein the said “data is saved and stored” 613 in the Bill/ST-SC 210.

Second, to follow up with the status of his bill(s), a user selects the Bill/ST-AC 161 to further select the “Displaying of bill data functionality” 614, wherein the “bill data is retrieved from the Bill/ST-SC” 615 to be “up-loaded to the user's default MED” 616 through the U/MED-DWACP 113 and the U/MED 114, for the “bill data to be displayed on the user's default MED” 617.

A first advantage of this aspect of the present invention resides in a digital wallet operating an application that allows a user to manage his bills to be paid by creating a bill status statement that is displayable on the user's MED.

A second advantage of this aspect of the present invention is achieved through a digital wallet operating to display the data of bills to be paid only on the user's default MED, thus preventing anyone else, who fraudulently gained access to a user's digital wallet to retrieve the said data on any other MED.

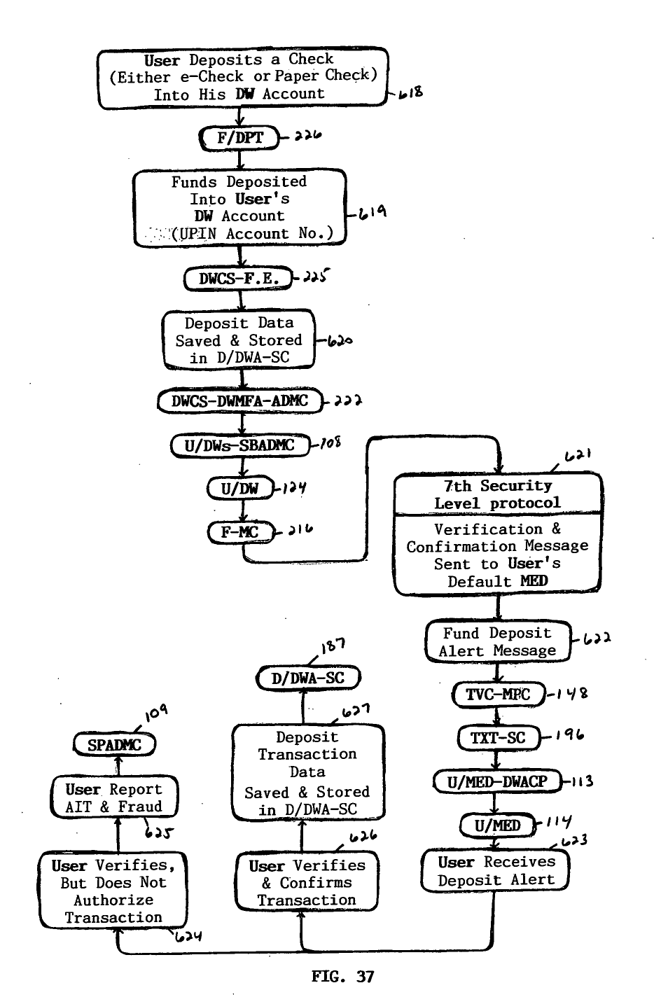

Referring to FIG. 37, there is a flow diagram of a manner of operation of an aspect of the present invention illustrating the process of an application allowing a user to deposit a check (e-check and paper check) at a financial entity user into the said user's default digital wallet account, and further illustrating the 7th security level protocol, wherein an alert text message is sent to the said user's default MED, warning him that a deposit of funds is in the process of being executed, and requiring him to verify and authorize the said deposit of funds, before its execution or cancel it and alert the DWCS customer service.

In particular, a “user deposits a check (either an e-check or paper check) into his default digital wallet account” 618, thus through the F/DPT 226, which typically is either a bank website or a bank teller, the “funds are deposited into the user's default digital wallet account designated by an account number generated using the UPIN of the user” 619, and processed by the DWCS-F.E. 225.

First, the funds are deposited and held in the user's default digital wallet account at the DWCS-F.E. 225, which in turn transmits the “funds deposit data to the user's digital wallet to be saved and stored in the D/DWA-SC” 620. Thus, the fund deposit data is transmitted through the DWCS-DWMFA-ADMC 222, the U/DWs-SBADMC 108, and the U/DW 124.

Second, the fund deposit data is further processed through the F-MC 216, which runs the “7th security level protocol, which sends a verification and confirmation text message to the user's default MED” 621, wherein the “fund deposit alert text message” 622 is transmitted through the TVC-MPC 148, the TXT-SC 196, the U/MED-DWACP 113, the U/MED 114 and “received by the user” 623.

Third, upon receiving the fund deposit alert text message, either the “user verifies, but does not authorize the deposit” 624, blocks the transaction and “report an aggravated identity theft and fraud” 625 to the SPADMC 109, or the “user verifies and confirms the deposit” 626, whereafter the “deposit transaction data is saved and stored in the D/DWA-SC” 627, wherein the transaction data is maintained in the D/DWA-SC 187.

A first advantage of this aspect of the present invention resides in a digital wallet operating an application that allows a user to deposit the funds through a check into his default digital wallet account through the DWCS financial entity user.

A second advantage of this aspect of the present invention is achieved through a digital wallet operating a security protocol, which alerts a user that funds are in the process of being deposited into his default digital wallet account, and requires the user to verify and authorize the said deposit, before its execution or cancel it and alert the DWCS customer service.

A third advantage of this aspect of the present invention further resides in a digital wallet operating a security protocol, which alerts a user of a deposit of funds being in the process of being executed through the user's default MED, thus preventing anyone else, who has access to the user's digital wallet to authorize fraudulent deposits through any other MED.

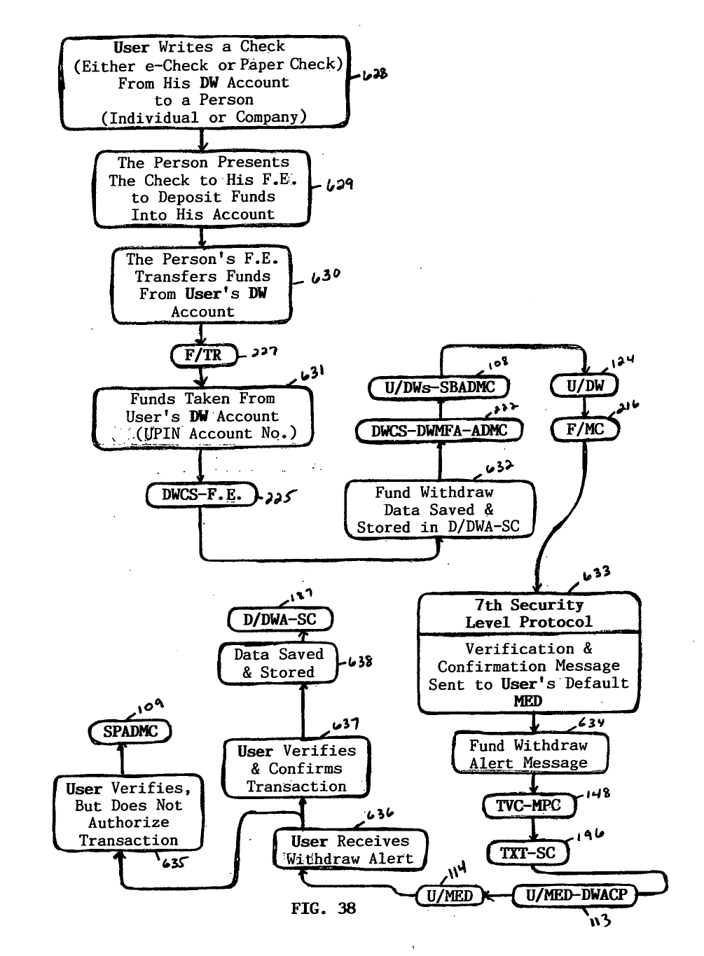

Referring to FIG. 38, there is a flow diagram of a manner of operation of an aspect of the present invention illustrating the process of an application allowing a user to write a check (e-check or paper check) from his default digital wallet account to another user and non-user of this invention, and further illustrating the 7th security level protocol, wherein an alert text message is sent to the said user's default MED, warning him that a fund transfer is in the process of being executed, and requiring him to verify and authorize the said transfer from his default digital wallet account, before its execution or cancel it and alert the DWCS customer service.

In particular, a “user writes a check (either e-check or paper check) from his default digital wallet account to a person (individual or company), who is a user or non-user of this invention” 628, wherein “the person presents the said check to his financial entity, typically a bank, to deposit the funds into his bank account” 629.

First, the “person financial entity transfers the funds from the user's default digital wallet account” 630 through the F/TR 227, which typically is an interbank request for fund transfer, wherein the “funds are taken from the user's default digital wallet account, which are held in the DWCS financial entity under an account number generated using the user's UPIN” 631.

Second, the funds held in the user's account in the DWCS-F.E. 225 is withdrawn and transferred to the person's financial entity to be deposited in his account, and the “fund withdraw data is saved and stored in the D/DWA-SC” 632 by transmitting the said data through the DWCS-DWMFA-ADMC 222, the U/DWs-SBADMC 108 and the U/DW 124.

Third, the fund withdraw data is further processed through the F-MC 216, which runs the “7th security level protocol, which sends a verification and confirmation text message to the user's default MED” 633, wherein the “fund withdraw alert message” 634 is transmitted through the TVC-MPC 148, the TXT-SC 196, the U/MED-DWACP 113, the U/MED 114, and “received by the user” 636.

Fourth, upon receiving the fund withdraw alert message, either the “user verifies, but does not authorize the said transaction” 635, blocks the transaction and alert the SPADMC 109, or the “user verifies and confirms the transaction” 637, whereafter the “fund withdraw data is saved and stored” 638 in the D/DWA-SC 187 of the user's digital wallet.

A first advantage of this aspect of the present invention resides in a digital wallet operating an application that allows a user to write a check from his default digital wallet account to another user or non-user of this invention.

A second advantage of this aspect of the present invention is achieved through a digital wallet operating a security protocol, which alerts a user that funds are in the process of being withdrawn from his default digital wallet account, and requires the user to verify and authorize the said withdrawal of funds, before its execution or cancel it and alert the DWCS customer service.

A third advantage of this aspect of the present invention further resides in a digital wallet operating a security protocol, which alerts a user of a withdraw of funds being in the process of being executed, through his default MED, thus preventing anyone else, who has access to the user's digital wallet to authorize any withdrawal of funds through any other MED.

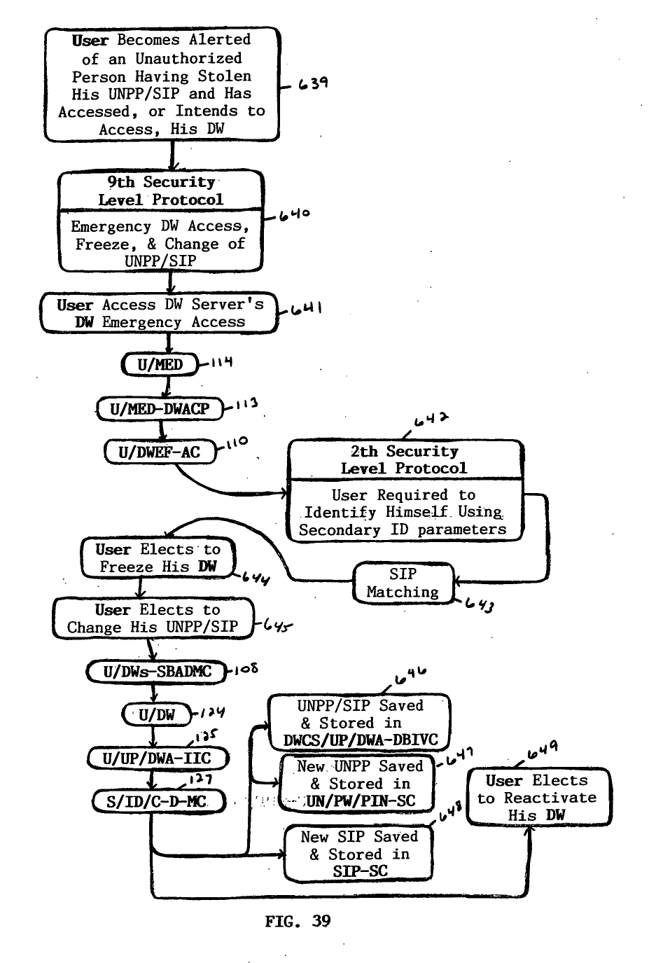

Referring to FIG. 39, there is a flow diagram of a manner of operation of an aspect of the present invention illustrating the process of an application allowing a user, who has become alerted of an unauthorized person having stolen his log-in information and has accessed or intends to access the user's digital wallet, and/or has lost his default MED, to access the DWCS' Emergency Digital Wallet Access, Freeze, and Change of User Name, Password, PIN and/or Secondary identification Parameters Application, for the purpose of allowing the said user to access his digital wallet using another MED and freeze his digital wallet even when his digital wallet is being used by the unauthorized person, which is the 9th security level protocol, and further illustrating the 2nd security level protocol, which requires the said user to identify himself using his secondary identification parameters, before allowing the said user to execute the emergency application.

In particular, a “user becomes alerted of an unauthorized person having stolen his user name, password, PIN and secondary identification parameters, being typically an ex-spouse, a child, a friend, a guest, and has accessed or intends to access the said user's digital wallet” 638, wherefore, the DWCS 100 permits such a user to log-in through a “9th security level protocol, which provides an emergency digital wallet access to freeze the digital wallet and allow such a user to change his log-in information and secondary identification parameters” 640, even when the unauthorized person is using the user's digital wallet.

First, the “user accesses the digital wallet server's (DWCS 100) Emergency Digital Wallet Access Application” 641 through his U/MED 114, the U/MED-DWACP 113, and the U/DWEF-AC 110, which is a software component operating an application that allows a user to access the server's “Emergency Digital Wallet Access Application” to freeze his digital wallet, and allows such a user to change his log-in information, secondary identification parameters and default MED, to prevent an unauthorized person to further intrude in his digital wallet, and further runs the “2nd security level protocol, which requires the user to identify himself using his secondary identification parameters” 642.

Second, upon the “secondary identification parameters matching” 643, the “user elects to freeze his digital wallet” 644 and further “elects to change his user name, password, PIN and secondary identification parameters” 645, wherein through the U/DWs-SBADMC 108, the U/DW 124, the U/UP/DWA-IIC 125 and the S/ID/C-D-MC 127, the “new user name, password, PIN and secondary identification parameters are saved and stored in the DWCS/UP/DWA-DBIVC” 646, the “new user name, password and PIN are also saved and stored in the UN/PW/PIN-SC” 647, and the “new secondary identification parameters are also saved and stored in the SIP-SC” 648, whereafter the “user elects to reactivate his digital wallet” 649.

A first advantage of this aspect of the present invention resides in a digital wallet operating in conjunction with a digital wallet administrator, typically a digital wallet server, which operates to permit a user of this invention to access an emergency digital wallet access application to freeze his digital wallet, while his digital wallet is being used by an unauthorized person, and further permit such a user to change his log-in information and secondary identification parameters to prevent further intrusion in his digital wallet.

A second advantage of this aspect of the present invention is achieved through a digital wallet server, which in addition, operates a security protocol requiring a user to identify himself using his secondary identification parameters, making the access of a user's digital wallet by anyone else more difficult.

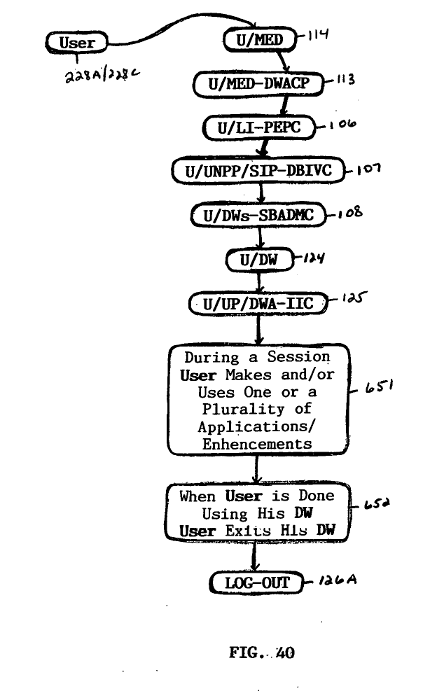

Referring to FIG. 40, there is a flow diagram of a manner of operation of an aspect of the present invention illustrating the process of an application allowing a user to log-out after having consummated a session with his digital wallet and choosing to got out of his digital wallet.

In particular, a “User” 228A/228C LOG-IN, and “after being in a session of use of his digital wallet, in which the user applied one or a plurality of applications and enhancements” 651, and “when the user is done using his digital wallet and chooses to exit it” 652, the user exits his digital wallet by selecting the LOG-OUT 126A application, which is a software component operating the shut down of the digital wallet, when the user either logs-out or forgets to timely log-out, and managing of all data thereof.

An advantage of this aspect of the present invention resides in a digital wallet operating to process the shut down of a digital wallet and to manage and maintain the accuracy and safeguard of the data therein after the user chooses to exit his digital wallet or forgets to timely log-out.

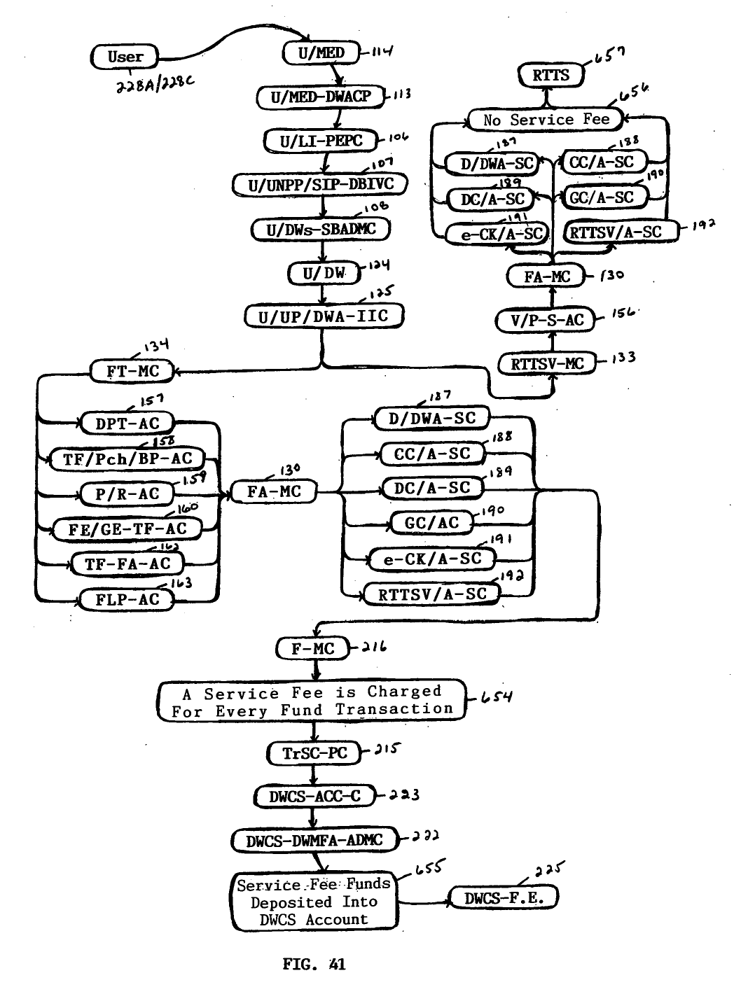

Referring to FIG. 41, there is a flow diagram of a manner of operation of an aspect of the present invention illustrating the process of an application allowing the DWCS to charge and collect a service fee for each selected transaction consummated through a user's digital wallet, and further illustrating the DWCS charging no service fee for any fund transfer related to the voting application.

In particular, a “User” 228A/228C LOG-IN.

First, for each and every fund transaction consummated through the FT-MC 134, through either the DPT-AC 157, the TF/Pch/BP-AC 158, the P/R-AC 159 the FE/GE-TF-AC 160, the TF-FA-AC 162 or the FLP-AC 163, then through the FA-MC 130 and through either the D/DWA-SC 187, the CC/A-SC 188, the DC/A-SC 189, the GC/A-SC 190, the e-CK/A-SC 191, or the RTTSV/A-SC 192, the the fund transaction is processed through the F-MC 216, which is a software component that also operates to charge a service fee to a user's financial instrument account for each and every fund transaction consummated thereof, wherein “a service fee is charged for each fund transaction” 654, thus the service fee collected is transmitted through the TrSC-PC 215, which is a software component operating to process the collection of service fees charged for fund transactions, then through the DWCS-ACC-C 223, which is a software component operating to process and maintain the data of all service fees collected from a user's financial instrument account and for each fund transaction consummated thereof, then through the DWCS-DWMFA-ADMC 222, thus the “service fee funds are deposited into the DWCS account” 655 held in the DWCS-F.E. 225.

Second, for each fund transaction executed through the RTTSV-MC 133, the V/P-S-AC 156, the FA-MC 130, and either the D/DWA-SC 187, the CC/A-SC 188, the DC/A-SC 189, the GC/A-SC 190, the e-CK/A-SC 191, or the RTTSV/A-SC 192, there is “no service fee” 656, when the fund is transferred for the purpose of a contest in a “Reality TV Talent Show” 657.

An advantage of this aspect of the present invention resides in a digital wallet operating in conjunction with a digital wallet server, to charge and collect a service fee for each and every selected fund transaction consummated through a digital wallet and its stored financial instrument accounts.

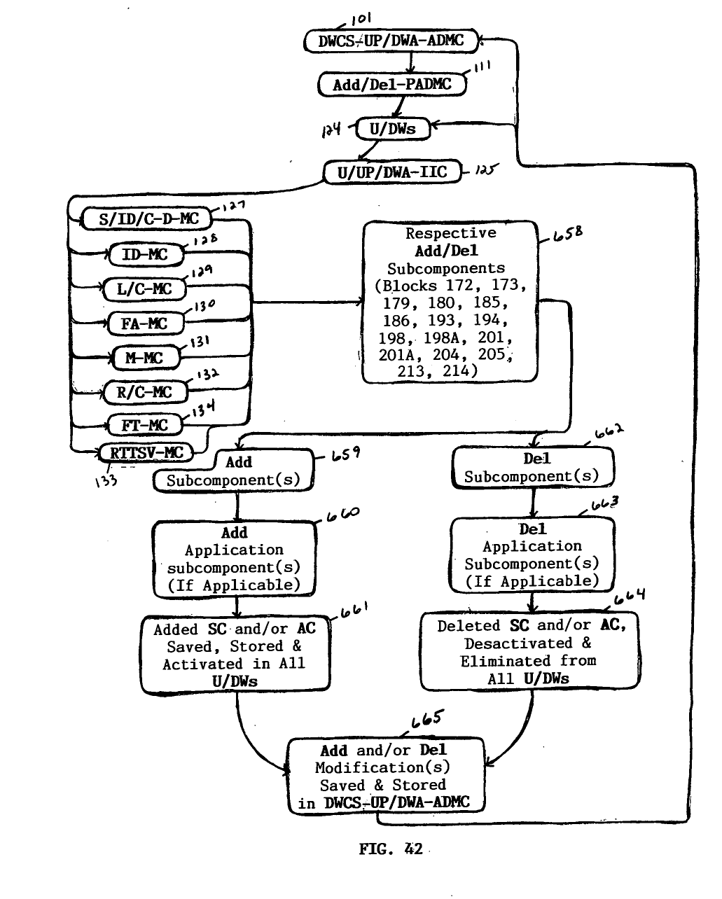

Referring to FIG. 42, there is a flow diagram of a manner of operation of an aspect of the present invention illustrating the process of an application allowing the DWCS to add/activate and/or delete/desactivate application(s) and/or enhancement(s) for the purpose of adapting the user's digital wallet to society changes, wherein the said modification(s) is saved and stored in the appropriate component(s)/subcomponent(s).

In particular, the DWCS-UP/DWA-ADMC 101 operates to add and/or delete subcomponent(s) and/or application(s) for the purpose to adapt a user's digital wallet to society changes.

First, through the Add/Del-PADMC 111, which is a software component operating to add and/or delete subcomponent(s) and/or application(s), and further through the U/DWs 124, the U/UP/DWA-IIC 125, and either the S/ID/C-D-MC 127, the ID-MC 128, the L/C-MC 129, the FA-MC 130, the M-MC 131, the R/C-MC 132, the FT-MC 134, or the RTTSV-MC 133, the server administrator may select to add and/or delete a specific subcomponent and/or application through the “respective Add/Del subcomponents 172, 173, 179, 180, 185, 186, 193, 194, 198, 198A, 201, 201A, 204, 205, 213, 214” 658.

Second, a “subcomponent may be added” 659, and “if applicable, an application is also added” 660 for the purpose of implementing the use of the enhancement maintained in the added subcomponent; wherein the “added subcomponent and/or application is saved, stored and activated in all digital wallets operated by this invention” 661.

Third, a “subcomponent may be deleted” 662, and “if applicable, the application related to the deleted subcomponent is deleted as well” 663, wherein the “deleted subcomponent and/or application are desactivated and eliminated from all digital wallets operated by this invention” 664.

Fourth, the “added and/or deleted modification(s) are saved and stored in the DWCS-UP/DWA-ADMC 101” 665 and the U/DWs 124.

An advantage of this aspect of the present invention resides in a digital wallet server operating to modify the digital wallets that it operates and administers, by adding and/or deleting subcomponent(s) and/or application(s), for the purpose to adapt the digital wallet to society changes, thus providing a user of this invention with a current and versatile digital wallet and adapted to his needs.

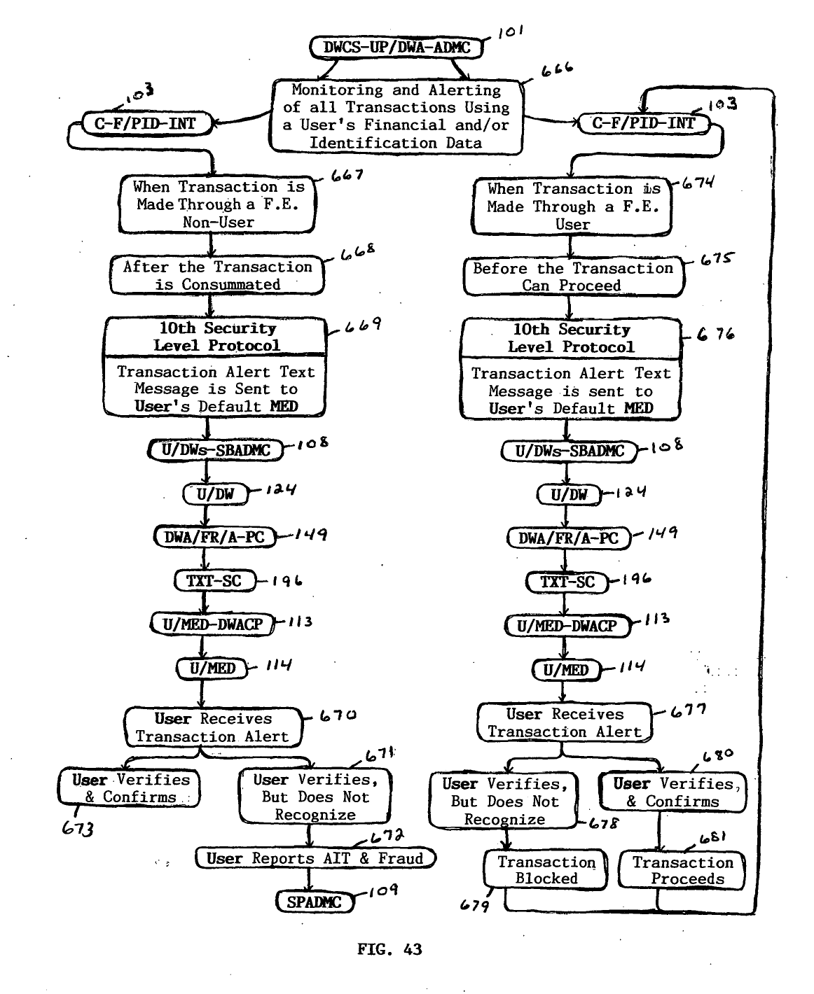

Referring to FIG. 43, there is a flow diagram of a manner of operation of an aspect of the present invention illustrating the process of the 10th security level protocol, wherein the DWCS monitors and alerts a user of all fund transactions, within and outside of the network of the users of this invention, using selected financial and personal identification data stored in the said user's digital wallet.

In particular, the DWCS-UP/DWA-ADMC 101 operates to “monitor all transactions using a user's financial and/or personal identification data, stored in his digital wallet, and to alert the said user of these transaction” 666, by connecting to the C-F/PID-INT 103.

First, “when the transaction is processed through a financial entity, which is not a user of this invention” 667, only “after the transaction is consummated” 668, the DWCS-UP/DWA-ADMC 101 runs the “10th security level protocol, which sends a transaction alert text message to the user's default MED” 669 through the U/DWs-SBADMC 108, the U/DW 124, the DWA/FR/A-PC 149, the TXT-SC 196, the U/MED-DWACP 113, and the U/MED 114, for the “transaction alert text message to be received by the user” 670, whereby either the “user verifies, but does not authorize the transaction” 671 and “reports an aggravated identity theft and fraud” 672 to the SPADMC 109, or the “user verifies and confirms the transaction” 673

Second, “when the transaction is processed through a financial entity, which is a user of this invention” 674, now “before the transaction can proceeds” 675, the DWCS-UP/DWA-ADMC 101 runs the “10th security level protocol, which sends a transaction alert text message to the user's default MED” 676 through the U/DWs-SBADMC 108, the U/DW 124, the DWA/FR/A-PC 149, the TXT-SC 196, the U/MED-DWACP 113, and the U/MED 114, for the “transaction alert text message to be received by the user” 677, whereby either the “user verifies, but does not recognize the transaction” 678, and “block the transaction” 679 by alerting the C-F/PID-INT 103, or the “user verifies and confirms the transaction” 680, and the “transaction proceeds” 681, by informing the C-F/PID-INT 103.

A first advantage of this aspect of the present invention resides in a digital wallet server operating to monitor, through the central financial and identification data base interface, and to alert a user of this invention of, all transaction processed by all financial entities, which are users and non-users of this invention, using financial and personal identification data stored in the said user's digital wallet.

A second advantage of this aspect of the present invention is achieved through a digital wallet server operating a security protocol, which sends a transaction alert text message to a user of this invention.

A third advantage of this aspect of the present invention further resides in a digital wallet server operating a security protocol, which transmits a transaction alert text message to a user's default MED.

A fourth advantage of this aspect of the present invention is further achieved through a digital wallet server operating to allow a user of this invention to either authorize or block a transaction in progress, when the transaction is processed through a financial entity, which is a user of this invention.

It should be appreciated that the various aspects of the present invention have herein been described separately. The various aspects, however, may be combined in any manner.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which falls within the limits of the claims.

### SPIRIT AND SCOPE OF THE DISCLOSURE

While the above-exemplary description of the structure, aspects and advantages of the present invention, and the manner of attaining them, are susceptible to various modifications, and alternative forms, and while the intent of the present invention is to cover all modifications, equivalents and alternatives falling within the spirit and scope of this invention, as defined by the appended claims, a descriptive overview of the spirit and scope of the present invention should be appreciated to make the said structure, aspects and advantages of the present invention, and the manner of attaining from, become further apparent and the invention further better understood.

The structure of the present invention is a multi-part digital wallet consisting of a “Mother Digital Wallet” and a plurality of “Offspring Digital Wallet”.

The “Mother Digital Wallet”, typically a software component digital wallet server, and ordinarily consisting of various subcomponent software components, modules and/or the like, is operative to generate, create, manage, edit, administer, protect, process communication exchange connections for, and provide technical and security support for, a plurality of “Offspring Digital Wallet”, hereinafter “SERVER”, as referred to in FIG. 1 (100-113, 218, 219, 222, 223, 224).

An “Offspring Digital Wallet”, typically a unique digital wallet, ordinarily consisting of various subcomponent software components, modules and/or the like, generated and created by the server, is operative to receive from various sources, create, edit, manage, save, store, maintain, and allow the retrieval, displaying and sharing of a wide variety of forms of enhancements, and provide a wide range of functionalities, hereinafter “DIGITAL WALLET”, as referred to in FIG. 1 (124).

The server generates and creates a unique digital wallet by codifying it using unique personal identification information provided by a USER, who typically is a unique natural person or a unique artificial entity (such as a financial entity, government entity, vender/provider of goods and services, company/corporation, Reality TV Talent Show, any other entity having a unique identity).

First, the server is operative to allow a new user to set up his digital wallet, typically through his “Mobile Electronic Device or Non-Mobile Electronic Device”, hereinafter “DEVICE”, and by the new user navigating in a network, preferably an electronic network such as the internet, and connecting with the server, wherein the new user is required to accept the terms and conditions for the use of his digital wallet, and provide his personal identification information, which includes, but is not limited to, his first name, middle name, last name, entity name, address, date of birth, date of registration, unique personal identification number (such as his social security number, employer identification number, and/or the like), e-mail, phone number, country code, as referred to in FIG. 2 (228A/228C, 114, 113, 102, 232, 233).

Second, during the process of the setting up of the new user's digital wallet, the server further requires the new user to provide the “Digital Address” of a device (such as a phone number, internet protocol address and/or the like), for that device to be used as a “Default Device” to which all alert messages sent to a user from the running of the plurality of security protocol are directed, whereby, the default device being the only device through which a user can operate the functionalities of his digital wallet and transact with, as referred to in FIG. 1 (234).

Third, from the personal identification information provided by the new user, the server verifies the matching of the new user's personal identification information with his “Unique Personal Identification Number”, hereinafter “UPIN”, through the Central Financial and Identification Data Interface, and further runs his personal identification information through the server's digital wallet database, wherefrom, only when the new user's personal identification information matches with his UPIN, and the new user's personal identification information has not already been used to set up a digital wallet by another user, that the server operates to allow that new user to access a digital wallet, as referred to in FIG. 2 (235, 103, 239, 104, 240, 241).

Fourth, in the event that the new user does not accept the terms and conditions for the use of a digital wallet, the server operates to cancel the setting up of a digital wallet for that new user, and denies him further access, as referred to in FIG. 2 (230, 231).

Fifth, in the event that the new user's UPIN does not exist or does not match his personal identification information, the server operates to cancel the setting up of a digital wallet for that new user, denies him further access, and register the event, as referred to in FIG. 2. (236, 237, 238, 109).

Sixth, in the event that the new user's personal identification information has already been used to set up a digital wallet by another user, and therefore already exists in the server's digital wallet database, the server operates to cancel the setting up of a digital wallet by that new user, denies him further access, and yet further send an alert message to the new user that his personal identification information has already been used, as well as send an alert message to the user of the digital wallet set up with the new user's personal identification information, as referred to in FIG. 2 (250, 251, 124, 217, 196, 252, 253).

Seventh, the server otherwise operates to allow the setting up of a digital wallet by the new user, who is further required to create a User Name, Password, and provide Secondary Identification Parameters (such as answers to 3 personal questions, fingerprints, his face for face recognition means, and/or the like), which may be used either individually or in combining two or more parameters, which may be set in different order, as a higher security level a user may need to protect the content of his digital wallet, as referred to in FIG. 2 (242, 243, 244).

Eighth, from all the data provided by the new user, the server then is operative to generate a Personal Identification Number, hereinafter “PIN”, as referred to in FIG. 2 (245).

Ninth, from the said data provided by the new user, the server is operative to generate a “Digital Wallet Number”, typically by using the new user's personal identification information, including, but not limited to, country code, area code, year of birth, month of birth and additional digit(s), and/or the like or otherwise generate a generic number, for the purpose of hiding the low-level sensitive data (such as social security number, date of birth, name, and/or the like) necessary for the consummation of a transaction between two users of this invention, and also for the purpose of identifying, locating, and connecting to, a specific digital wallet and its user, as referred to in FIG. 2 (245, 105, 246).

Tenth, from the said data provided by the new user, the server is operative to generate a “Default Digital Wallet Account Number”, typically by using the new user's UPIN and/or the like, for the purpose of using the said account number to designate a fund account held by the server company, which is user to serve, among other transaction functionalities, as the sole fund depository account of the digital wallet, whereby allowing a user of this invention to be alerted whenever funds are transferred to that account, as referred to in FIG. 2 (247).

Eleventh, the server is operative to save and store all data provided and created by the new user and generated by the server into the server's digital wallet database and into the new user's digital wallet, as referred to in FIG. 2 (248).

Finally, the server is operative to allow the new user to customize his digital wallet, as referred to in FIG. 2 (249).

In the case of a new user, who, for some reason, elects not to provide a UPIN, the server, however, is operative to skip the verification of the new user's identity, wherein it verifies the matching of the new user's UPIN with his personal identification information through the Central Financial and Identification Data Interface, as referred to in FIG. 2 (103, 236, 237, 238, 109, 239), and the generating of the Default Digital Wallet Account Number”, as referred to in FIG. 2 (247), as referred to in FIG. 3.

According to an aspect of this invention, and with reference to FIG. 4, once the setting up of a digital wallet is finalized, the server is operative to allow a new user to select a “default Digital Wallet” that best fits his needs, that it be a default digital wallet either for an individual, a company, or a user, who has elected not to provide a UPIN (273, 126, 274, 275, 276).

Once the default digital wallet selected, the digital wallet is operative to allow the new user to customize that digital wallet, wherein the new user may elect to either desactivate/eliminate from his digital wallet one or a plurality of enhancements and/or applications that do not fit his needs, or activate/add one or a plurality of forms of enhancements and/or applications, for the purpose to customize his digital wallet to further fit his needs. The new user may elects to do both (277, 278, 279, 280, 281).

To achieve a better customized digital wallet, the server is operative to make available to a new user a repertory of various forms of enhancements and applications from which a new user may elect to import into his digital wallet for the purpose to customize his digital wallet to best fit his needs. Such repertory includes, but is not limited to:
(a) various forms of identification instruments, such as passport, birth certificate, social security number, employer identification card/letter, work ID, school ID, gym ID, clud ID, library ID, and the like.
(b) various forms of license and certification instruments, such as driver's license, commercial driver's license, proof of insurance, professional license, business license, technical license, CPR certification, school/college/university diploma, post-graduate certification, school/college/university grades, any legal document, any document, and the like.
(c) various forms of financial instruments, such as a financial instrument created for the default digital wallet account and data thereof; a plurality of financial instruments for additional digital wallet accounts, to which the assigned digital wallet account number is generated by using the new user's UPIN and to which additional digit(s) is added to differentiate each additional digital wallet account (these additional digital wallet accounts may be used to manage: the budget of different departments of a company; funds to pay bills held into one-way-sub-accounts through a “Flex Pay Planner” application; funds held in simple fund accounts), for different credit cars, debit cards, gift cards, e-checks, and for different vouchers, and the like.
(d) various forms of receipt and confirmation of consummated transactions, such as typical receipt, typical confirmation, any other document related to any type of transaction, and the like.
(e) various applications that are operative to allow a user of a digital wallet to:
   (1) import and/or receive from any source, create, edit, save, store, maintain, manage, and allow the retrieval, displaying, and sharing of, personal data and the like; identification instruments, data thereof and the like; receipt/confirmation of consummated transaction, data thereof and the like; financial instruments, data thereof and the like; discount coupons, data thereof and the like.
   (2) vote free of charge or by the purchase of an item, for the purpose of a contest of sorts.
   (3) manage payrolls.
   (4) for financial and government entities, transfer funds to an entitled individual or entity.
   (5) keep track of bill(s) to be paid.
   (6) manage bills to be paid through a flex pay planner.
   (7) import/receive from various sources, create, edit, save, store, maintain, manage, and allow the retrieval, displaying, and sharing of, business cards.
   (8) use the benefits of an address book, calendar, scheduling book, calculator, watch with different time zones, and the like.

Upon the customization of a default digital wallet by the new user, the digital wallet is operative to save and store the modifications (282, 125).

Furthermore, thereafter the first customization of a digital wallet, the digital wallet is operative to allow a user to customize his digital wallet at any time, for the purpose to fit his changing needs.

According to another aspect of this invention, and with reference to FIG. 5, the server is operative to run a security protocol, wherein a user, who attempts to log-in to access his digital wallet, is given three tries to enter the correct user name, password and PIN. If a user fails to enter the correct login information, the server then is operative to require that user to identify himself using his secondary identification parameters, whereby, the server is operative to give that user three tries to provide his correct secondary identification parameters. If that user still fails to do so on the third try, the server is operative to deny further access to that user and record the event (228A/228C, 114, 113, 106, 107, 291, 292, 293, 295, 296, 297, 298, 300, 109).

Otherwise, if the user either enters the correct log-in information on the first, second or third time, or enters the correct secondary identification parameters within the three tries, upon the user accessing his digital wallet and before being allowed to use his digital wallet, the digital wallet is operative to run a security protocol, wherein a “Digital Wallet Access Alert” message is sent to the default device of the user of that digital wallet, which requires him to authorize the access of his digital wallet, whereby allowing only the user of that digital wallet to use his digital wallet-(284, 294, 299, 108, 124, 285, 217, 196, 289, 290).

In the event that the “Digital Wallet Access Alert” message is sent to the default device of the user of that digital wallet, who is not the person who is attempting to access the digital wallet, the user of that digital wallet may elect to deny such access by not authorizing the access upon receiving the said alert message, if the user of that digital wallet did not previously agreed to allow the person, who is attempting to access his digital wallet, to access his digital wallet and use it for some reasons (287, 288).

According to another aspect of this invention, and with reference to FIG. 6, in the event that a user has forgotten his log-in information (user name, password and/or PIN), the server is operative to run a security protocol, wherein three tries are given to a user to enter the correct secondary identification parameters. If the secondary identification parameters match with the ones under that digital wallet, the server is operative to allow that user to access his digital wallet and edit/change his user name, password, and/or PIN, which are then saved and stored in the server's digital wallet database and in the user's digital wallet. Thereafter, that user is allowed to use his digital wallet (228A/228C, 114, 113, 106, 107, 302, 303, 304, 108, 124, 125, 127, 136, 166, 305, 306, 307, 314).

In the event that in addition of having forgotten his login information, a user has forgotten his secondary identification parameters and/or the order thereof, the server is operative to require that user to contact a server's customer service agent (live person) to certify the identity of that user through different means of identification, and upon such certification, the said agent allows that user to access his digital wallet in order for the user to edit/change his log-in information and set up different secondary identification parameters, which are then saved and stored in the server's digital wallet database and in the user's digital wallet. Thereafter, the user is allowed to use his digital wallet (308, 309, 310, 311, 108, 124, 125, 127, 136, 166, 167, 312, 313, 314).

According to another aspect of this invention, and with reference to FIG. 7, in the event that either a user or an unauthorized person accesses a digital wallet and elects to change the log-in information and/or the secondary identification parameters, the digital wallet is operative to run a security protocol, which gives three tries to such a user or person to enter the correct secondary identification parameters-(315, 114, 113, 106, 107, 108, 124, 125, 127, 136, 166, 167, 316, 317, 322, 323).

In the event that on the third try the said user or person fails to enter the correct secondary identification parameters, that digital wallet is operative to send an “Aggravated Identity. Theft and Fraud Alert” message to the default device of the user of that digital wallet (318, 319, 320, 108, 124, 217, 196, 321).

In the event that the secondary identification parameters entered by the said user or person match, the digital wallet is operative to allow the said user or person to enter new log-in information and set up new secondary identification parameters, which are then saved and stored in the server's digital wallet database and in that digital wallet. Thereafter, the said user or person is allowed to use that digital wallet (324, 325, 326, 327, 166, 167, 107, 328).

According to another aspect of this invention, and with reference to FIG. 8, a digital wallet is operative to allow a user to edit, change, and modify any data imported, received, saved, stored, and maintained in his digital wallet, and before the user is allowed to execute the editing, changing, or modifying of any said data, the digital wallet is operative to run a security protocol, wherein the user is required to identify himself using secondary identification parameters (228A/228C, 114, 113, 106, 107, 108, 124, 125, 330, 127, 128, 129, 130, 131, 132, 331).

In the event that, after the third try, the user fails to enter the correct secondary identification parameters, the digital wallet is further operative to send an Aggravated identity Theft and Fraud Alert message to the default device of the user of that digital wallet (332, 333, 334, 335, 336).

In the event that the user has forgotten his secondary identification parameters, the digital wallet is operative to require the user to contact a server's customer service agent (live person) to certify his identity, whereafter the said agent certifies the user's identity, the data to be edited, change, or modified is displayed on the default device of the user of that digital wallet (337, 338, 339, 341).

In the event that the user's secondary identification parameters match, the data to be edited, changed, or modified, is displayed on the default device of the user of that digital wallet (340, 341).

Once the data to be edited, changed, or modified is displayed on the default device of the user of that digital wallet, the user edits, changes, or modifies the data, which is thereafter saved and stored in that digital wallet, and when the user edits, changes, or modifies the log-in information (user name, password, and/or PIN) and the secondary identification parameters, this data is additionally saved and stored in the server's digital wallet database (342, 343, 344, 167, 166, 345, 107).

According to another aspect of this invention, and with reference to FIG. 9, a digital wallet is operative to allow a user to import personal data, such as name, address, UPIN, date of birth, date of registration, shipping address, company name, wedding date, spouse birth date, children birth dates, and the like, from his device by keying-in the data, and before the user is allowed to execute the import of any data into his digital wallet, the digital wallet is operative to run a security protocol, which requires the user to identify himself using his secondary identification parameters (228A/228C, 114, 113, 106, 107, 108, 124, 125, 127, 135, 347).

Upon entering the matching secondary identification parameters, the user executes the import of data by using the keys of his device, whereafter the digital wallet is operative to save and store the imported data in that digital wallet (348, 113, 114, 116, 349, 350, 117, 351).

According to another aspect of this invention, and with reference to FIG. 10, a digital wallet is operative to allow a user to import various forms of identification instrument (228A/228C, 114, 113, 106, 107, 108, 124, 125, 128, 137, 353).

To achieve the import of an identification instrument, the digital wallet is operative to allow a user to either use the camera of his device to take a picture of the identification instrument, or download a graphic of a blank: identification instrument from the server's graphic library, and then use the keys of his device to key-in the pertinent data over the said blank graphic (113, 114, 115, 354, 112, 353A, 113, 114, 116, 355).

Thereafter, the imported identification instrument is saved and stored in that digital wallet (118, 356, 357).

According to another aspect of this invention, and with reference to FIG. 11, a digital wallet is operative to allow a user to have an identification instrument, that he previously requested from either another user or non-user of this invention, sent to his digital wallet (358, 359, 360, 219, 108, 361, 224, 220).

Thus, the other user or non-user, who processed the user's request, sends the identification instrument to the user's digital wallet, through the server, wherein the server is operative to run a security protocol, whereby the server is operative to receive the said identification instrument, temporarily holds it awaiting for the user's authorization or delete, and further sends an “ID-Ready-For-Pick-Up alert” message to the default device of the user of that digital wallet (362, 218, 363, 124, 148, 196, 113, 114).

Upon receiving the said alert message, the user accesses his digital wallet by logging-in to review the identification instrument held by the server (364, 365, 114, 113, 106, 107, 108, 124, 125, 128, 137, 366, 218).

Upon the review of the said instrument, the user either authorizes it, whereafter the digital wallet is operative to upload the identification instrument, save and store it, or does not authorize it and deletes it (118, 367, 368, 369, 370).

According to another aspect of this invention, and with reference to FIG. 12, a digital wallet is operative to allow a user to export a selected identification instrument saved, stored and maintained in his digital wallet. Thus, the digital wallet is operative to allow a user to send a selected identification instrument to either another user or a non-user of this invention, and before allowing the user to execute the export of any identification instrument, the digital wallet is operative to run at security protocol, wherein an “ID Export Alert” message is sent to the default device of the user of that digital wallet, which requires the user to authorize the said export, before its execution (228A/228C, 114, 113, 106, 107, 108, 124, 125, 128, 137, 372, 149, 196, 113, 114).

Upon receiving the “ID Export Alert” message, the user either elects not to authorize the export, or to authorize it, whereafter the selected identification instrument is only then retrieved from the digital wallet, displayed on the default device of the user of that digital wallet, and sent to either another user or a non-user of this invention (373, 374, 375, 376, 377, 219, 108, 380, 228A/228C, 221, 224, 378, 228B/228C).

According to another aspect of this invention, and with reference to FIG. 13, a digital wallet is operative to allow a user to retrieve a selected identification instrument saved, stored and maintained in his digital wallet, and display it on the screen of the default device of the user of that digital wallet.

According to another aspect of this invention, and with reference to FIG. 14, a digital wallet is operative to allow a user to import various forms of license/certification instruments (228A/228C, 114, 113, 106, 107, 108, 124, 125, 129, 140, 387).

To achieve the import of a license/certification instrument, the digital wallet is operative to allow a user to use the camera of his device to take a picture of the license/certification (113, 114, 115, 388).

Thereafter, the imported license/certification instrument is saved and stored in that digital wallet (119, 389, 390).

According to another aspect of this invention, and with reference to FIG. 15, a digital wallet is operative to allow a user to have a license/certification instrument, that he previously requested either from another user or non-user of this invention, sent to his digital wallet (391, 392, 393, 219, 108, 394, 224, 220).

Thus, the other user or non-user, who processed the user's request, sends the license/certification instrument to the user's digital wallet, through the server, wherein the server is operative to run a security protocol, whereby the server is operative to receive the said license/certification instrument, temporarily holds it awaiting for the user's authorization or delete, and further sends a “License/certification Instrument-Ready-For-Pick Up Alert” message to the default device of the user of that digital wallet (395, 218, 396, 124, 148, 196, 113, 114).

Upon receiving the said alert message, the user accesses his digital wallet by logging-in to review the license/certification instrument held by the server (397, 398, 114, 113, 106, 107, 108, 124, 125, 129, 140, 399, 218).

Upon the review of the said instrument, the user either authorizes it, whereafter the digital wallet is operative to up-load the license/certification instrument, save and store it, or does not authorize it and deletes it (400, 401, 402, 403).

According to another aspect of this invention, and with reference to FIG. 16, a digital wallet is operative to allow a user to export a selected license/certification instrument saved, stored and maintained in his digital wallet. Thus, the digital wallet is operative to allow the user to send a selected license/certification instrument to either another user or a non-user of this invention, and before allowing the user to execute the export of any license/certification instrument, the digital wallet is operative to run a security protocol, wherein a “license/certification instrument Export Alert” message is sent to the default device of the user of that digital wallet, which requires the user to authorize the said export, before its execution (228A/228C, 114, 113, 106, 107, 108, 124, 125, 129, 140, 405, 149, 196, 113, 114).

Upon receiving the “license/certification Instrument Export Alert” message, the user either elects not to authorize the export, or to authorize it, whereafter the selected license/certification instrument is only then retrieved from the digital wallet, displayed on the default device of the user of that digital wallet, and sent to either another user or a non-user of this invention (406, 407, 408, 409, 410, 219, 108, 413, 228A/228C, 221, 224, 411, 228B/228C).

According to another aspect of this invention, and with reference to FIG. 17, a digital wallet is operative to allow a user to retrieve a selected license/certification instrument saved, stored and maintained in his digital wallet, and display it on the screen of the default device of the user of that digital wallet.

According to another aspect of this invention, and with reference to FIG. 18, a digital wallet is operative to allow a user to import into his digital wallet various forms of financial instrument (228A/228C, 114, 113, 106, 107, 108, 124, 125, 130, 143, 421).

To achieve the import of a financial instrument, the digital wallet is operative to allow a user to either use the camera of his device to take a picture of the financial instrument and use the keys of the device to enter the pertinent data, or download a graphic of a blank financial instrument from the server's graphic library, and then use the keys of his device to key-in the pertinent data over the said blank graphic (113, 114, 115, 116, 422, 423, 112, 424, 113, 114, 116, 425).

When the financial instrument is a check, the digital wallet is operative to save and store it in the appropriate compartment (426, 427, 191).

When the financial instrument is either a credit card, debit car, gift card, voucher, and the like, the digital wallet is operative to generate a bar code and/or any other means of communicating the data of the financial instrument, whereafter the digital wallet is operative to save and store the financial instrument in the appropriate compartment (428, 429, 430, 188, 189, 190, 192).

For the default digital wallet account and its account number generated by the server, and for any other digital wallet account and its account number generated by the server, the digital wallet is operative to allow a user to create a financial instrument using a blank graphic from the server's graphic library, and using the keys of the user's device to key-in the data over the blank graphic, and then is further operative to generate a bar code and/or any other means of communicating the pertinent data, whereafter the digital wallet is operative to save and store the financial instrument in the appropriate compartment (105, 431, 112, 424, 113, 114, 116, 425, 429, 430, 187).

According to another aspect of this invention, and with reference to FIG. 19, a digital wallet is operative to allow a user to have a financial instrument that he previously requested either from another user or a non-user of this invention sent to his digital wallet (432, 433, 434, 219, 108, 435, 224, 220).

Thus, the other user or non-user, who processed the user's request, sends the financial instrument to the user's digital wallet, through the server, wherein the server is operative to run a security protocol, whereby the server is operative to receive the said financial instrument, temporarily holds it awaiting for the user's authorization or delete, and further sends a “Financial Instrument-Ready-For-Pick-Up Alert” message to the default device of the user of that digital wallet (435A, 218, 436, 124, 148, 196, 113, 114).

Upon receiving the said alert message, the user accesses his digital wallet by logging-in to review the financial instrument held by the server (437, 438, 114, 113, 106, 107, 108, 124, 125, 130, 143, 439, 218).

Upon the review of the said instrument, the user either does not authorize it and delete it, or authorizes it, whereafter the digital wallet is operative to save and store a digital check into the appropriate compartment, and to generate a bar code and/or any other means of communicating data for a digital credit card, debit card, gift card, voucher and the like and then further save and store each digital instrument in the appropriate compartment (120, 446, 447, 440, 441, 442, 191, 443, 444, 445).

According to another aspect of this invention, and with reference to FIG. 20, a digital wallet is operative to allow a user to retrieve a selected financial instrument saved, stored and maintained in his digital wallet, and display it on the screen of the default device of the user of that digital wallet (228A/228C, 114, 113, 106, 107, 108, 124, 125, 130, 145, 449, 450, 451, 452, 113, 114, 229).

Furthermore, a digital wallet is operative to allow a user to retrieve the transaction statement and balance of the fund account of a selected financial instrument saved, stored and maintained in the user's digital wallet, by connecting to the Central Financial and Identification Information Interface, and display the said financial data on the screen of the default device of the user of that digital wallet (283, 103, 301, 329; 346, 113, 114, 352).

According to another aspect of this invention, and with reference to FIG. 21, a digital wallet is operative to allow a user to communicate with another user of this invention, through their respective default device and through a session of use of their respective digital wallet (228A/228C, 114, 113, 106, 107, 108, 124, 125, 131, 146).

Thus, a digital wallet is operative to allow a user to either talk to, send text messages to, or chat live with, another user of this invention, by connecting the other user's default device through their respective digital wallet using their respective digital wallet number (195, 196, 197, 371, 219, 108, 381, 382, 404, 414, 415).

According to another aspect of this invention, and with reference to FIG. 22, a digital wallet is operative to allow a user to import various forms of receipt/confirmation of consummated transaction (228A/228C, 114, 113, 106, 107, 108, 124, 125, 132, 151, 454).

To achieve the import of a receipt/confirmation of a consummated transaction, the digital wallet is operative to allow a user either to use the camera of his device to take a picture of a paper receipt/confirmation of a consummated transaction, or, after an online transaction, to receive a digital receipt/confirmation of a consummated transaction through his digital wallet by connecting to either another user or non-user of this invention (113, 114, 115, 455, 228A/228C, 219, 108, 228B/228C, 224, 220, 459).

Thereafter, the imported receipt/confirmation of a consummated transaction is saved and stored in that digital wallet (121, 460, 461).

According to another aspect of this invention, and with reference to FIG. 23, a digital wallet is operative to allow a user to export a selected receipt/confirmation of a consummated transaction saved, stored, and maintained in his digital wallet (228A/228C, 114, 113, 106, 107, 108, 124, 125, 132, 151, 463).

Thus, the digital wallet is operative to allow a user to send a selected receipt/confirmation of a consummated transaction to either a user or non-user of this invention (464, 219, 108, 467, 228A/228C, 221, 224, 228B/228C).

According to another aspect of this invention, and with reference to FIG. 24, a digital wallet is operative to allow a user to retrieve a selected receipt/confirmation of a consummated transaction saved, stored, and maintained in his digital wallet, and display it on the screen of the default device of the user of that digital wallet.

According to another aspect of this invention, and with reference to FIG. 25, a digital wallet is operative to allow a user to create a receipt/confirmation of a consummated transaction (228A/228C, 114, 113, 106, 107, 108, 124, 125, 132, 152, 475).

To achieve the creation of a receipt/confirmation of a consummated transaction, a digital wallet is operative to allow a user to download a graphic of a blank receipt/confirmation, and then use the keys of his device to enter the pertinent data over the blank graphic (112, 476, 113, 114, 116, 477).

Thereafter, the digital wallet is operative to save, store and maintain the receipt/confirmation of a consummated transaction that has been created in that digital wallet (121, 478, 479).

According to another aspect of this invention, and with reference to FIG. 26, a digital wallet is operative to receive funds from another user and a non-user of this invention, and before the execution of such deposit of funds into the user's digital wallet account, the digital wallet is operative to run a security protocol, wherein a verification and confirmation message is sent to the default device of the user of that digital wallet (480, 481, 228A/228C, 219, 108, 228B/228C, 224, 220, 124, 216, 484, 485, 148, 196, 113, 114).

Upon receiving the “fund deposit alert message”, the user verifies the transaction, and if the user does not recognize it, the digital wallet is operative to allow the user to cancel the transaction and alert the server's customer service to report the event, or if the user confirms the said transaction, the digital wallet is operative to recognize the user's confirmation based on which the digital wallet is operative to proceed to the deposit of the funds into the server's master fund account held by the server's financial entity, and further record the data of the deposit into the user's default digital wallet account (486, 487, 488, 109, 489, 490, 222, 225, 491, 130, 187).

According to another aspect of this invention, and with reference to FIG. 27, a digital wallet is operative to allow a user to transfer funds either to purchase goods and services, pay bills, or to simply transfer funds to either another user or non-user of this invention (228A/228C, 114, 113, 106, 107, 108, 124, 125, 134, 158, 207).

Thus, the digital wallet is operative to allow a user to select the account from which the funds is to be withdrawn to be transferred to either make a purchase, pay a bill, or simply send funds to someone else (493, 130, 187, 188, 189, 190, 191, 192; 494, 216).

Upon selecting the account and entering the amount of funds to be transferred and before executing the transfer of the funds, the digital wallet is operative to run a security protocol, wherein a verification and confirmation message is sent to the default device of the user of that digital wallet (495, 496, 148, 196, 113, 114).

Upon receiving the “fund transfer alert message”, the user verifies the transaction, and if the user does not recognize it, the digital wallet is operative to allow the user to cancel the transaction and alert the server's customer service to report the event, or if the user confirms the said transaction, the digital wallet is operative to proceed to the transfer of the funds, where after the funds are transferred to either another user or nonuser of this invention (497, 498, 499, 109, 500, 501, 219, 108, 502, 503, 221, 224, 504).

According to another aspect of this invention, and with reference to FIG. 28, a digital wallet is operative to allow a user to manage his bill(s) to be paid through a “Flex Pay Planner”, wherein the digital wallet is operative to allow the user to enter the data of bill(s) to be paid and for each particular bill, the digital wallet is operative to generate/create a “one-way-sub-account” that is assigned to that particular bill (228A/228C, 114, 113, 106, 107, 108, 124, 125, 134, 163, 211, 506).

Thus, the digital wallet is operative to generate/create a “one-way-sub-account”, which is for payoff purpose only, where once the funds is deposited into a one-way-sub-account, the funds therein can only be used to pay the bill to which it has been assigned.

Thus, the digital wallet is operative to allow a user to select a financial instrument account saved, stored and maintained in his digital wallet, from which the funds is withdrawn to be transferred into a particular one-way-sub-account (507, 130, 187, 188, 189, 190, 191, 192).

Periodically, or at one time, the digital wallet is operative to allow the user to transfer funds from any financial instrument account into one or a plurality of one-way-sub-accounts, until the funds in a particular one-way-sub-account is available to pay the bill thereto in full, whereafter the funds is automatically transferred to the payee's bank account (508, 509, 510, 216).

Before the execution of the automatic transfer of funds from any one-way-sub-account, the digital wallet is operative to run a security protocol, wherein a verification and confirmation message is sent to the default device of the user of that digital wallet (511, 512, 148, 196, 113, 114).

Upon receiving the “fund transfer alert message”, the user verifies the transaction, and if the user does not recognize it, the digital wallet is operative to allow the user to cancel the transaction and alert the server's customer service to report the event, or if the user confirms the said transaction, the digital wallet is operative to proceed to the automatic transfer of funds, whereafter the funds is transferred to the bank account of the payee, who is either another user or non-user of this invention (513, 514, 515, 109, 516, 517, 219, 108, 518, 221, 224, 520).

According to another aspect of this invention, and with reference to FIG. 29, a digital wallet is operative to allow a user to import discount coupons (228A/288C, 114, 113, 106, 107, 108, 124, 125, 134, 165, 526).

Thus, the digital wallet is operative to allow a user to import discount coupon(s), by connecting to either another user through their respective digital wallet, or a non-user through an electronic network such as the internet, to download a particular discount coupon (527, 528, 219, 108, 228A/228C, 530, 531, 532, 533, 220, 224, 228B/228C, 535, 536).

Upon the download of a discount coupon, the digital wallet is operative to save, store and maintain the discount coupon in that digital wallet (212).

According to another aspect of this invention, and with reference to FIG. 30, a digital wallet is operative to allow a user to export any discount coupon saved, stored and maintained in his digital wallet (228A/228C, 114, 113, 106, 107, 108, 124, 125, 134, 165, 212, 538).

Thus, the digital wallet is operative to retrieve a selected discount coupon for the purpose of consummating it through the purchase of goods or services, transacted either with another user or non-user of this invention, or at a vender/provider retailer's site cash register (539, 543, 547).

Thus, the digital wallet is operative to either connect with either another user or non-user of this invention to transfer the selected discount coupon and data thereof to consummate it, or up-load a selected discount coupon on the user's default device to consummate it at a vender/provider retailer's site cash register (540, 219, 108, 228A/228C, 542, 544, 221, 224, 228B/228C, 546, 548, 113, 114, 549, 550).

According to another aspect of this invention, and with reference to FIG. 31, a digital wallet is operative to allow a user to retrieve a selected discount coupon saved, stored and maintained in his digital wallet, and display it on the screen of the default device of the user of that digital wallet.

According to another aspect of this invention, and with reference to FIG. 32, a digital wallet is operative to allow a user to submit a vote, free of charge, for the purpose of a contest of sorts, by selecting one of the available options (228A/228C, 114, 113, 106, 107, 108, 124, 125, 133, 155, 202, 557).

Thus, the digital wallet is operative to transmit the user's selected option to either another user or non-user of this invention, whereafter, the said selected option is received by the other user or non-user, who stores and processes it (558, 559, 219, 108, 228A/228C, 561, 562, 221, 224, 228B/228C, 564).

According to another aspect of this invention, and with reference to FIG. 33, a digital wallet is operative to allow a user to submit a vote, by making a purchase of an e-product from one of the available options (228A/228C, 114, 113, 106, 107, 108, 124, 125, 133, 156, 203, 566).

To transmit the said purchase, the digital wallet is operative to allow the user to select a financial instrument account from which the funds are to be withdrawn and transferred to make the purchase (134, 158, 567, 130, 568, 216).

Before the execution of the transaction, the digital wallet is operative to run a security protocol, wherein a verification and certification message is sent to the default device of the user of that digital wallet (569, 570, 148, 196, 113, 114).

Upon receiving the “funs transfer alert message”, the user verifies the transaction, and if the user does not recognize it, the digital wallet is operative to allow the user to cancel the transaction and alert the server's customer service to report the event, or if the user confirms the said transaction, the digital wallet is operative to proceed to the transfer of the vote and funds, whereafter the vote and funds are either transferred to the other user or the non-user of this invention (571, 572, 573, 109, 574, 575, 219, 108, 576, 228A/228C, 577, 221, 224, 578, 228B/228C).

According to another aspect of this invention, and with reference to FIG. 34, a digital wallet is operative to allow a company user, such as a company, corporation, financial entity, government entity, and the like, to manage its payrolls (228A/228C, 114, 113, 106, 107, 108, 124, 125, 134, 159, 208).

Thus, the digital wallet is operative to allow the company user to select a financial instrument account saved, stored, and maintained in its digital wallet, from which the funds are to be withdrawn to pay its employees' salary and deductions thereof and transfer the salaries to its employees and the deductions to the appropriate government entities (581, 130, 187, 188, 189, 190, 191, 192, 582, 216).

Upon selecting the financial instrument account from which the funds are to be withdrawn and transferred to the company user's employees and appropriate government entities, and before the execution of the transfers of funds, the digital wallet is operative to run a security protocol, wherein a verification and certification message is sent to the default device of the user of that digital wallet (583, 584, 148, 196, 113, 114).

Upon receiving the “fund transfer alert message”, the company user verifies the transaction, and if the company user does not recognize the transaction, the digital wallet is operative to allow the user to cancel the said transaction and alert the server's customer service to report the event, and if the company user confirms the said transaction, the digital wallet is operative to proceed to the transfers of funds, whereafter the funds are transferred to the company user's employees, who are either other users or nonusers of this invention, and to the appropriate government entities (584A, 585, 586, 109, 587, 588, 219, 108, 589, 590, 221, 224, 591).

According to another aspect of this invention, and with reference to FIG. 35, a digital wallet is operative to allow a financial entity and government entity user (FE/GE user) to transfer funds through its digital wallet to an entitled person or entity, who is another user of this invention (228A/228C, 114, 113, 106, 107, 108, 124, 125, 134, 160, 209).

Before the execution of the transaction of the funds, the digital wallet is operative to run a security protocol, wherein the FE/GE user is required to verify the identity of the recipient of the funds, who is another user of this invention, by running the personal identification information of the said recipient of the funds through the Central Financial and Identification Information Interface, and through the server's digital wallet database, wherefrom, if the personal identification information of the said recipient does not match, the digital wallet is operative to allow the FE/GE user to cancel the transaction, or if the said information is matching, the digital wallet is further operative to send a “fund transaction alert message inquiry” to the default device of the recipient of the funds (593, 103, 104, 594, 595, 596, 597, 219, 108, 124, 148, 196, 113, 114).

Upon receiving the “funds transfer alert message with inquiry”, the recipient of the funds verifies the transaction, and if the recipient does not recognize the said transaction, the digital wallet is operative to allow the recipient of the funds to cancel the said transaction and alert the server's customer service to report the event, or if the recipient of the funds confirms the said transaction and responds to the inquiry, the digital wallet is operative to send back the confirmation and response of the inquiry to the FE/GE user (598, 599, 109, 600, 601).

Thus, upon receiving the recipient's confirmation and response of the inquiry, the FE/GE user verifies the recipient's response, and if the response is not confirmed by the FE/GE user, the digital wallet is operative to allow the FE/GE user to cancel the said transaction, or if the FE/GE User confirms the recipient's response, the digital wallet is operative to proceed to the transfer of the funds (602, 603, 604, 216).

Before the execution of the transfer of the funds to the said recipient, the digital wallet is operative to run a security protocol, wherein a verification and confirmation message is sent to the default device of the FE/GE user of that digital wallet, whereby, upon receiving the said “funds transfer alert message”, if the FE/GE user does not recognize the transaction, the digital wallet is operative to allow the FE/GE user to cancel the said transaction and alert the server's customer service to report the event, or if the FE/GE user confirms the said transaction, the digital wallet is operative to proceed to the transfer of the funds to the recipient's digital wallet (605, 606, 607, 219, 108, 608).

According to another aspect of this invention, and with reference to FIG. 36, a digital wallet is operative to allow a user to manage his bill(s) for the purpose to keep track of his bill(s) that are yet to be paid (228A/228C, 114, 113, 106, 107, 108, 124, 125, 134, 161, 210).

Thus, the digital wallet is operative to allow a user to enter the data of bill(s) to be paid, and the data of payment(s) made towards each particular bill, by creating a list thereto (610, 611, 612).

Thereafter, the digital wallet is operative to save and store the said data in that digital wallet (613, 210).

Furthermore, the digital wallet is operative to allow a user to retrieve the data of the said bill(s) and payment(s) made thereto, and display it on the default device of the user of that digital wallet (614, 615, 616, 113, 114, 617).

According to another aspect of this invention, and with reference to FIG. 37, a digital wallet is operative to allow a user to deposit the funds from either a digital check or paper check, directly through the server's financial entity, into the user's default digital wallet account, designated by an account number generated by using his UPIN (618, 226, 619).

Upon receiving the funds and before the execution of the deposit of funds into the user's default digital wallet account, the server's financial entity transmits the data of the deposit to the user's digital wallet to be saved and stored into the digital wallet, and through this process, the digital wallet is operative to run a security protocol, wherein a verification and certification message is sent to the default device of the user of that digital wallet (620, 222, 108, 124, 216, 621, 622, 148, 196, 113, 114).

Upon receiving the “funds transfer alert message”, the user verifies the transaction, and if the user does not recognize it, the digital wallet is operative to allow the user to cancel the said transaction and alert the server's customer service to report the event, or if the user confirms the said transaction, the . . . digital wallet is operative to cause the funds to be deposited into the user's default digital wallet account held by the server's financial entity, and is further operative to save and store the deposit transaction data into the user's digital wallet (623, 624, 625, 109, 626, 627, 187).

According to another aspect of this invention, and with reference to FIG. 38, a digital wallet is operative to allow a user to write a check, either digital or paper, from his default digital wallet account to a person (natural or artificial entity), wherein that person presents the user's check to his financial entity (typically a bank) to deposit the funds thereof into his bank account (628, 629).

Thus, that person's financial entity causes the transfer of funds of the said check from the user's default digital wallet account, wherein the funds held by the server's financial entity into the user's digital wallet account, designated by an account number generated using the user's UPIN, is withdrawn and transferred to that person's bank account (603, 227, 631, 225).

Before the execution of the transfer of funds, the digital wallet is operative to save and store the data of the transfer into the default digital wallet account of the user's digital wallet, and through that process, the digital wallet is operative to run a security protocol, wherein a verification and confirmation message is sent to the default device of the user of that digital wallet (632, 222, 108, 124, 216, 633, 634, 148, 196, 113, 114).

Upon receiving the “Fund Withdraw Alert Message”, the user verifies the transaction, and if the user does not recognize it, the digital wallet is operative to allow the user to cancel the said transaction and alert the server's customer service to report the event, or if the user confirms the said transaction, the digital wallet is operative to cause the funds to be transferred to the person's financial entity into his bank account, and is further operative to save and store the withdraw transaction data into the user's digital wallet (636, 635, 109, 637, 638, 187).

According to another aspect of this invention, and with reference to FIG. 39, a digital wallet is operative to allow a user, who has become alerted of an unauthorized person having stolen his log-in information and secondary identification parameters, and has accessed or intends to access his digital wallet, to go through a security protocol, wherein the user accesses the Server's Digital Wallet Emergency Freeze and Change of Log-In Information and Secondary Identification parameters (639, 640, 641, 114, 113, 110).

Upon accessing the Server's Digital Wallet Emergency application, the digital wallet is operative to require the user to identify himself using his secondary identification parameters, wherein upon the matching of the said parameters, the digital wallet is further operative to allow the user to freeze his digital wallet, and/or change his log-in information and/or secondary identification parameters (642, 643, 644, 645, 108, 124, 125, 127).

Thereafter, the digital wallet is operative to save and store the new log-in information and . . . secondary identification parameters (646, 647, 648, 649).

According to another aspect of this invention, and with reference to FIG. 40, a digital wallet is operative to allow a user, who has consummated a session of use of his digital wallet, wherein he has used one or a plurality of enhancements and applications, to terminate his session and log-out of his digital wallet.

According to another aspect of this invention, and with reference to FIG. 41, a digital wallet is operative to allow: (1) a user to deposit funds, from various sources, into his default digital wallet account; (2) a user to transfer funds from any financial instrument account, saved, stored and maintained in his digital wallet, to make a purchase, pay bills, and simply transfer funds to someone else; (3) a company user to transfer funds from any financial instrument account, saved, stored and maintained in its digital wallet, to its employees for payrolls; (4) a financial entity and government entity user to transfer funds from any financial instrument account, saved, stored and maintained in its digital wallet, to an entitled recipient (another user of this invention only); (5) a user to transfer funds from one of the financial instrument accounts, saved, stored and maintained in his digital wallet, into another one; and (6) a user to automatically transfer funds held into a One-Way-Sub-Account to pay-off bills, and for each of the above transactions, the digital wallet is further operative to allow the Server to charge a service fee (228A/228C, 114, 113, 106, 107, 108, 125, 125, 134, 157, 158, 159, 160, 162, 163, 130, 187, 188, 189, 190, 191, 192, 216, 654).

Thus, the digital wallet is operative to transfer the service fee charged for each transaction consummated through a user's digital wallet, to the Server's master fund account held by the Server's financial entity (215, 223, 222, 655, 225).

Additionally, a digital wallet is operative to allow a user to submit a vote by the purchase of an e-product for the purpose of a contest of sorts, without a service fee being charged by the Server (133, 156, 130, 187, 188, 189, 190, 191, 192, 656, 657).

According to another aspect of this invention, and with reference to FIG. 42, the Server is operative to add/activate and/or delete/desactive any program instruction implementation of enhancements and applications for the purpose of adapting all generated, created, and set-up, digital wallets with program instruction implementation of enhancements and functionalities that best fits the needs of the network of user of this invention based on society changes, such as when new developed means of identification and financial instruments are introduced to the public and the like (101, 111, 124, 125).

Thus, the Server is operative to add/activate and/or delete/desactivate a program instruction implementation for personal data, identification instruments, license/certification instruments, financial instruments, messaging, receipt/confirmation of consummated transaction, fund transfer and voting (127, 128, 129, 130, 131, 132, 133, 134, 658, 659, 660, 662, 663).

Thereafter, the Server is operative to save and stored all modifications into all the generated, created, and set-up digital wallets, as well as in the Server's operational program instruction implementation (661, 664, 665, 101, 124).

According to another aspect of this invention, and with reference to FIG. 43, a Server is operative to connect to the Central Financial and Identification Information Interface for the purpose to monitor all transactions using any of its user's financial and/or identification data (101, 666, 103).

When the Server detects a transaction using the financial and/or identification information of a user of this invention that is made through a financial entity, which is not a user of this invention, only after the transaction is consummated, the Server is operative to run a security protocol, where a transaction alert message is sent to the default device of that user (667, 668, 669, 108, 124, 149, 196, 113, 114).

Upon receiving the “Transaction Alert Message”, the user verifies the transaction and if the user does not recognize the transaction, the Server is operative to allow that user to report an aggravated identity theft and fraud to the Server's Customer Service, or if the user recognizes the said transaction, no action needs to be taken (670, 671, 672, 109, 673).

When the Server detects a transaction using the financial and/or identification information of a user of this invention that is made through a financial entity, which is a user of this invention, before the transaction can go through and be consummated, the Server is operative to run a security protocol, wherein a transaction alert message is sent to the default device of that user (674, 675, 676, 108, 124, 149, 196, 113, 114).

Upon receiving the “Transaction Alert Message”, the user verifies the transaction, and if the user does not recognize the transaction, the Server is operative to allow the user to block the transaction, and the Server is further operative to cause the transaction to be canceled through the Central Financial and Identification Information Interface, or if the used recognizes the said transaction, the server is operative to cause the transaction to proceed through the Central Financial and Identification Information Interface (677, 678, 679, 680, 681, 103).

### Additional Aspects of Embodiment

The previously described structure of a digital wallet and its various aspects being a preferred embodiment of the present invention, various aspects could be varied and/or additional related aspects could be added to improve the functionality of the digital wallet. These additional modifications, equivalents, and alternatives include:

Referring to FIG. 2 and FIG. 3, the Server may be operative to generate and create a unique digital wallet without generating the PIN (245, 264).

Referring to FIG. 3, when a new user chooses not to provide a UPIN, the Server may be operative to generate a generic Unique Number for the purpose of generating a default digital wallet account number.

Referring to FIG. 4, in addition to the 3 generic type of default digital wallet described therein (274, 275, 276), the Server may be operative to generate default wallet specific to different business, occupations, and types of individual.

Referring to FIG. 8, a digital wallet may be operative to allow a user to edit the digital address of his default device, for the purpose to allow a user to change his default device for another device or a newer device, or the like.

Referring to FIG. 26, a digital wallet may be operative to allow a user of this invention to transfer funds from a selected financial instrument account, saved, stored and maintained in his digital wallet, by directing the funds to be deposited into a . . . selected financial instrument account, saved, stored and maintained in another user's digital wallet, by connecting both user's digital wallet to each other using their respective Digital Wallet Number, under which, the pertinent information necessary to consummate such transaction is provided, but hidden.

Referring to FIG. 26, a digital wallet may be operative to allow a non-user of this invention to send funds to a user of this invention, typically through an electronic network such as internet, by directing the funds to be deposited through the non-user's financial entity (typically a bank), by using the user's default digital wallet account number and the routine number of the user's financial entity, whereafter the user's financial entity forwards the data of the deposit to the digital wallet of that user, wherein the digital wallet is operative to save and store the said data.

Referring to FIG. 26, a digital wallet may be operative to allow a user to deposit funds, through his digital wallet, into any financial instrument account, saved, stored and maintained therein.

Referring to FIG. 28, (507, 130, 187, 188, 189, 190, 191, 192, 508, 509), a digital wallet may be operative to connect, through the Server, to the Central Financial and Identification Information Interface (Central Banking System) to retrieve the actual balance of a financial instrument account, saved, stored and maintained in a user's digital wallet and from which funds are to be transferred into a particular One-Way-Sub-Account, for the purpose to allow a user to better manage his money, and to prevent an overdraft and resulting service fee, which may be achieved by integrating and/or connecting this “Flex Pay Planner” application with the display application described in FIG. 20 (283, 103, 301, 329, 346).

Referring to FIG. 28 (509, 510), a digital wallet may be operative to allow a user to enter the due date of his bill and select the date the user wishes that the funds, held in a One-Way-Sub-Account available to pay a particular bill in full, be automatically transferred to the payee.

Referring to FIG. 28 (510), a digital wallet may be operative to allow a user to manually transfer the funds, held in a One-Way-Sub-Account, to a payee, when the funds therein are available to pay a particular bill in full, and when the user chooses to pay that particular bill before its due date.

Referring to FIG. 28, a plurality of days before a particular bill is due to be automatically paid, a digital wallet may be operative to alert a user of a particular bill being due to be paid, for the purpose to help a user from falling behind with his bills.

In addition to a “Flex Pay Planner” application, as described in FIG. 28, a digital wallet may be operative to provide a user with an “automatic Pay Bill” application, wherein the digital wallet is operative to allow a user to enter the data of a plurality of bills, such as the payee's name and address, payee's bank account and routing number, bill due date, and the like, and to set up a “Pay Bill Account” designated by an account number generated by using the user's UPIN and additional digit(s), and held by the Server's financial entity, into which a user deposits a large amount of funds, sufficient to pay all his monthly bills, such as car payment, mortgage, child support, loans, and the like, and from which, at the due date of each particular bill, or otherwise, at a prior date chosen by the user, the funds is automatically transferred to the payee.

In addition to the “Flex Pay Planner” application, as described at FIG. 28, a digital wallet may be operative to provide a user with “Automatic Funds Transfer” applications, wherein the digital wallet is operative to allow a user to set up a plurality of saving accounts, each designated by an account number generated by using the user's UPIN and additional digit(s), and held by the Server's financial entity, into which the user set up an amount of funds to be automatically transferred either monthly or otherwise at different temporal intervals, as the user may choose, from a selected financial instrument account, saved, stored and maintained in his digital wallet, for the purpose of saving money for college, retirement, and the like.

Referring to FIG. 29, a digital wallet may be operative to allow a user to import a discount coupon by using the camera of his device and take a picture of it and by using the keys of the device to enter the pertinent data of the said discount coupon, whereafter, the digital wallet is operative to generate a bar code and/or any other means of communicating data, to facilitate the consummation of the discount coupon.

Referring to FIG. 33, a digital wallet may be operative to allow a user to vote, for the purpose of a contest of sorts, by making the purchase of a product from one of the available options and have the product shipped to him.

Referring to FIG. 37, a digital wallet may be operative to allow a user to deposit the funds of a check by presenting that check to the teller of any financial entity, which is a user of this invention and has its banking system integrated to use the UPIN of users of this invention as bank account, and further use the digital wallet number to communicate between users to transact, whereafter the financial entity user forwards the data of the said transaction to the user's digital wallet to be saved and stored.

Referring to FIG. 39, a Server of digital wallets may be operative to allow a user to access his digital wallet through the “Emergency Digital Wallet Access and Freeze” application for the purpose of changing the digital address of his default device, when the default device of that user has been lost or has been stolen, in order for the user to set up a different device as his default device.

Referring to FIGS. 11, 12, 15, 16, 18, 19, 22, 23, 26, 27, 28, 29, 30, 32, 33, 34, 35, 37, and FIG. 38, a digital wallet may be operative to allow a user to:

(1) import and export identification instruments, license and certification instruments, financial instruments, receipt and confirmation of consummated transaction, and discount coupons;
(2) deposit funds into his default digital wallet account, saved, stored and maintained in his digital wallet;
(3) transfer funds from any of the financial instrument accounts, saved, stored and maintained in his digital wallet for the purpose to purchase goods and service, pay bills, and simply transfer funds to another party; pay bills through the “Flex Pay Planner” application; vote by purchasing a product for the purpose of a contest of sorts; to pay employees through Payrolls, pay, refund, reimburse, compensate and the like, an entitled recipient user; transferring funds through a electronic check; pay bills through an “Automatic Bill Pay” application;
(4) vote, free of charge, for the purpose of a contest of sorts;
(5) deposit funds through a digital check from someone else,
by using his default device to consummate any of the said transactions, electronically, either through electronic network such as the internet; by touching; taping; waiving at; aiming at, another electronic device, or by any other means of consummating an e-commerce transaction, now existing and later developed, and the digital wallet is further operative to allow a user to use his default device to consummate the said transaction through either another user or non-user of this invention.

Referring to the financial entity and government entity users, as cited in FIG. 35, a digital wallet may be operative to allow the said entity users to provide their different services and products through the filling and filing of pertinent application(s) through the digital wallet, wherein the digital wallet is operative to allow a user to fill out and file the said application(s) through a session of use of his digital wallet, the digital wallet is further operative to customize a user's digital wallet by integrating any of the said services and products in order to be entitled to its benefits, and the digital wallet is yet further operative to allow the said entity users and other users to transact by connecting through their respective digital wallet by using their respective digital wallet number, which hides all the pertinent data necessary to consummate such transaction.

Referring to the present invention, at the beginning of its creation, the Server may be operative to generate, create, and set up a plurality of digital wallet that are operative to process one or a plurality of aspects of this invention, wherein each digital wallet is operative to allow a user of this invention to use a partial number of enhancements and functionalities, until the Server has integrated all the aspects of this invention herein described.

I claim:

1. A primary digital wallet comprising one or a plurality of program instruction operative to generate, create, and set up a plurality of unique subordinate digital wallet, and to further run a plurality of security protocol to protect the plurality of unique subordinate digital wallet and content therein.

2. The primary digital wallet in claim 1, wherein each unique subordinate digital wallet is generated, created, and set up to be used/operated by its original user/operator.

3. A unique subordinate digital wallet in claim 2, wherein comprising one or a plurality of program instruction operative to receive from various sources, now existing and later developed, save, store, maintain, create, edit, manage, and allow the retrieval, displaying, and the sharing through various data exchange methods, now existing and later developed, of, various data and forms of enhancements and data thereof.

4. The unique subordinate digital wallet in claim 3, wherein comprising one or a plurality of program instruction operative to process and execute various applications using the various data and forms of enhancements and data thereof, saved, stored, and maintained therein.

5. The unique subordinate digital wallet in claim 4, wherein comprising one or a plurality of program instruction operative to run a plurality of security protocol to protect the data saved, stored, and maintained therein.

6. The primary digital wallet in claim 2, wherein one or a plurality of program instruction are operative to require a user/operator to provide, enter, and save his personal identification information and other related information, and further operative to utilize the user/operator's personal identification information and other related information to generate, create, and set up that user/operator's unique subordinate digital wallet.

7. The primary digital wallet in claim 6, wherein one or a plurality of program instruction are operative to set up a “Default Mobile Electronic Device (or Non-Mobile Electronic Device) for each unique subordinate digital wallet, by requiring a user/operator to provide, enter, and save the digital address of a mobile electronic device (or non-mobile electronic device) of his choice, for the purpose to be used, among other communicative functionalities, as the sole destination of all security alert messages sent to a user/operator as part of the running of a plurality of security protocol by the primary digital wallet and by a user/operator's unique subordinate digital wallet, in order to protect the user/operator's data saved, stored, and maintained in his unique subordinate digital wallet, against aggravated identity theft and fraud, and to alert a user/operator of specific applications and/or transactions being executed and/or in the process of being executed within the user/operator's unique subordinate digital wallet and through the Central Financial and Personal Identification Information Interface (through the banking system).

8. The primary digital wallet in claim 7, wherein one or a plurality of program instruction are operative to generate and set up a “Digital Wallet Number” assigned to each unique subordinate digital wallet, by requiring a user/operator to provide, enter, and save his personal identification information, and other related information, including, but not limited to, country code, area code and date of birth, and by further utilizing and combining that user/operator's country code, area code, year of birth, month of birth and additional digit(s), the additional digit(s) being number(s) and/or letter(s), to create the “Digital Wallet Number”.

9. The primary digital wallet in claim 8, wherein one for a plurality of program instruction are operative to generate a “Default Digital Wallet Account Number” to designate and be assigned to a specific bank account that is set up for each unique subordinate digital wallet, by requiring a user/operator to provide, enter, and save his personal identification information, and other related information, including, but not limited to, his Unique Personal identification Number, such as his social security number, his employer identification number, and any other unique number assigned to a user/operator by a government body, and by further utilizing and combining that user/operator's Unique Personal Identification Number and additional digit(s), the additional digit(s) being number(s) and/or letter(s), to create the “Default Digital Wallet Account Number”.

10. The primary digital wallet in claim 8, wherein one or a plurality of program instruction are operative to generate a “Default Digital Wallet Account Number” to designate and be assigned to a bank account that is set up for each unique subordinate digital wallet, by requiring a user/operator to provide, enter, and save his personal identification information, and other related information, and by further utilizing and combining different data from the user/operator's personal identification information and other related information to formulate a Unique Personal Identification Number, and by yet further combining that Unique Personal Identification Number and additional digit(s), the additional digit(s) being number(s) and/or letter(s), to create the “Default Digital Wallet Account Number”.

11. The primary digital wallet in claim 8, wherein one or a plurality of program instruction are operative to generate a “Default Digital Wallet Account Number” to designate and be assigned to a bank account that is set up for each unique subordinate digital wallet, by utilizing a generic number to serve as a Unique Personal Identification Number, and by further utilizing and combining that generic number and additional digit(s), the additional digit(s) being number(s) and/or letter(s), to create the “Default Digital Wallet Account Number”.

12. The primary digital wallet in claims 9, 10, and 11.

13. The primary digital wallet in claim 12, wherein one or a plurality of program instruction are operative to run a security protocol, before the generating and setting up of a unique subordinate digital wallet, which verifies the authenticity of the personal identification information and other related information provided, entered, and saved by a user/operator, by connecting to the Central Financial and Personal identification Information Interface and by comparing that information with the information saved, stored, and maintained in the primary digital wallet database related to the unique subordinate digital wallet already generated, created and set up, and to further generate, create, and set up a unique subordinate digital wallet only when a use/operator's personal identification information and other related information are authenticated and has not already been used to generate, create, and set up another user/operator's unique subordinate digital wallet.

14. The primary digital wallet in claim 13, wherein one or a plurality of program instruction are operative to run a security protocol that, when the personal identification information and other related information of a user/operator has already been used to generate, create, and set up another user/operator's unique subordinate digital wallet, sends an alert message to both the default mobile electronic device (or non-mobile electronic device) of the user/operator of that unique subordinate digital wallet generated, created, and set up utilizing that personal identification information and other related information, and the mobile electronic device (or non-mobile electronic device) of the user/operator, who is attempting to generate, create, and set up a unique subordinate digital wallet by utilizing the same personal identification information and other related information, that his personal identification information and other related information are being used by another user/operator to attempt to, and has already been used to, generate, create, and set up a unique subordinate digital wallet.

15. The primary digital wallet in claim 14, wherein one or a plurality of program instruction are operative to require a user/operator to choose, enter, and save a “User Name”, “Password”, “Personal Identification Number”, and “Secondary Identification parameters, such as the answer to 3 personal questions, the user/operator's face or fingerprint, or any other means of identification, now existing and later developed, and to further require a user/operator to utilize and enter his user name, password, and/or personal identification number, and/or secondary identification parameters to log-in through the primary digital wallet to gain access to that user/operator's unique subordinate digital wallet.

16. The primary digital wallet in claim 15, wherein one or a plurality of program instruction are operative to run a security protocol that gives a user/operator one or a plurality of tries to correctly enter his user name, password, and/or personal identification number, and/or a combination thereof, and further only grant that user/operator access to that unique subordinate digital wallet upon entering the correct user name, password and/or personal identification number, and/or a combination thereof, within the set number of tries.

17. The primary digital wallet in claim 16, wherein one or a plurality of program instruction are operative to run a security protocol that gives a user/operator, who, after the set number of tries, has failed to correctly enter his user name, password, and/or personal identification number, and/or combination thereof, a plurality of tries to correctly enter his secondary identification parameters, and to further only grant that user/operator access to that unique subordinate digital wallet upon entering the correct secondary identification parameters within the set number of tries.

18. The primary digital wallet in claim 17, wherein one or a plurality of program instruction are operative to run a security protocol that requires a user/operator, who either has forgotten his user name, password, and/or personal identification number, and/or a combination thereof, and his secondary identification parameters, or failed to correctly enter the said means of identification within the set number of tries, to contact a primary digital wallet agent (live person) to certify the identity of that user/operator, and to further only grant that user/operator access to that unique subordinate digital wallet upon the certification of that user/operator's identity by the said agent.

19. The primary digital wallet in claim 18, wherein one or a plurality of program instruction are operative to permit a user/operator to log-in/access his unique subordinate digital wallet through a primary digital wallet application, wherein one or a plurality of program instruction are operative to freeze the user/operator's unique subordinate digital wallet, and further permit the user/operator to change his user name, password, personal identification number, secondary identification parameters, and/or the digital address of the default mobile electronic device (or non-mobile electronic device).

20. The primary digital wallet in claim 19, wherein one or a plurality of program instruction are operative to run a security protocol, wherein when a user/operator access the primary digital wallet to freeze his unique subordinate digital wallet and change his means of identification, before the primary digital wallet executes the instruction, the user/operator is required to correctly enter his secondary identification parameters within a set number of tries.

21. The primary digital wallet in claim 20, wherein one or a plurality of program instruction are operative to generate, create, and set up a plurality of “Default” subordinate digital wallet, comprising different enhancements and applications that fit the needs of different types of user/operator, and from which a user/operator chooses to set up his unique subordinate digital wallet, and from which the user/operator may either immediately or later customize a default subordinate digital wallet by either importing and activating one or a plurality of enhancements and/or application from the enhancements and applications available in the primary digital wallet repertory, and/or deactivating and deleting one or a plurality of enhancement and/or application, wherein all modifications are saved, stored, and maintained in that user/operator's unique subordinate digital wallet.

22. The primary digital wallet in claim 21, wherein one or a plurality of program instruction are operative to receive, from various sources, now existing and later developed, save, store, maintain, create, edit, manage, and allow the retrieval, displaying, and sharing with a unique subordinate digital wallet, of, graphics of blank identification instruments, license and certification instruments, financial instruments and receipt and confirmation of consummated transactions.

23. The unique subordinate digital wallet in claim 5, wherein one or a plurality of program instruction are operative to run a security protocol that, upon to access of a unique subordinate digital wallet, sends an alert message to the default mobile electronic device (or non-mobile electronic device) of the user/operator of that unique subordinate digital wallet to alert him that his unique subordinate digital wallet is in the process of being accessed, and to further require the authorization of the user/operator of that unique subordinate digital wallet before granting access.

24. The unique subordinate digital wallet in claim 23, wherein one or a plurality of program instruction are operative to receive, from various sources, now existing and later developed, save, store, maintain, create, edit, manage, and allow the retrieval, displaying, and sharing through various data exchange methods, now existing and later developed, of, personal data and other related data.

25. The unique subordinate digital wallet in claim 24, wherein one or a plurality of program instruction are operative to receive, from various sources, now existing and later developed, save, store, maintain, create, edit, manage, and allow the retrieval, displaying, and sharing through various data exchange methods, now existing and later developed, of, various forms of identification instruments, now existing and later developed, and data thereof.

26. The unique subordinate digital wallet in claim 25, wherein one or a plurality of program instruction are operative to receive, from various sources, now existing and later developed, save, store, maintain, create, edit, manage, and allow the retrieval, displaying, and sharing through various data exchange methods, now existing and later developed, of, various forms of license and certification instruments, now existing and later developed and/or created, and data thereof.

27. The unique subordinate digital wallet in claim 26, wherein one or a plurality of program instruction are operative to receive, from various sources, now existing and later developed, save, store, maintain, create, edit, manage, and allow the retrieval, displaying, and sharing through various data exchange methods, now existing and later developed, of, various forms of financial instruments, now existing and later developed, and data thereof.

28. The unique subordinate digital wallet in claim 27, wherein one or a plurality of program instruction are operative to receive, from various sources, now existing and later developed, save, store, maintain, create, edit, manage, and allow the retrieval, displaying, and sharing through various data exchange methods, now existing and later developed, of, various forms of receipt and confirmation of consummated transaction, now existing and later developed and/or created, and data thereof.

29. The unique subordinate digital wallet in claim 28, wherein one or a plurality of program instruction are operative to receive, from various sources, now existing and later developed, save, store, maintain, create, edit, manage, and allow the retrieval, displaying, and sharing through various data exchange methods, now existing and later developed, of, various forms of discount coupons, now existing and later developed, and data thereof.

30. The unique subordinate digital wallet in claim 29, wherein one or a plurality of program instruction are operative to retrieved, from various sources, now existing and later developed, and display an accurate bank statement and balance of a selected financial instrument account, saved, stored, and maintained in a user/operator's unique subordinate digital wallet, by connecting to the Central Financial and Personal Identification Information Interface (the banking system).

31. The unique subordinate digital wallet in claims 24, 25, 26, 27, 28, 29, and 30.

32. The unique subordinate digital wallet in claim 31, wherein one or a plurality of program instruction are operative to run a security protocol, wherein an alert message is sent to the default mobile electronic device (or non-mobile electronic device) of a user/operator of that unique subordinate digital wallet, to alert that user/operator that his unique digital wallet has been activated to receive, save, store, create, edit, retrieve, display, and/or share data saved, stored, and maintained in his unique subordinate digital wallet, and/or to receive and display data related to financial instrument accounts saved, stored, and maintained therein.

33. The unique subordinate digital wallet in claim 32, wherein one or a plurality of program instruction are operative to process and execute the deposit of funds that originate from various sources, now existing and later developed, into the bank account of any financial instrument, saved, stored, and maintained in a unique subordinate digital wallet.

34. The unique subordinate digital wallet in claim 33, wherein one or a plurality of program instruction are operative to process and execute the deposit of funds that originate from various sources, now existing and later developed, into the bank account that is set up for a unique subordinate digital wallet, as recited in claim 12.

35. The unique subordinate digital wallet in claim 34, wherein one or a plurality of program instruction are operative to process and execute the transfer of funds from the bank account of any financial instrument saved, stored, and maintained in a unique subordinate digital wallet, including from the bank account set up for a unique subordinate digital wallet, into any bank account held by any financial entity . . . and through various transfer/payment methods, now existing and later developed.

36. The unique subordinate digital wallet in claim 35, wherein one or a plurality of program instruction are operative to receive, from any sources, now existing and later developed, save, store, maintain, create, edit, manage, and allow the retrieval, displaying and sharing through data exchange methods, now existing and later developed, of, data related to the processing and executing of employee payroll, and to further process and execute the transfer of funds from the bank account of any financial instrument saved, stored, and maintained in a unique subordinate digital wallet, including from the bank account set up for a unique subordinate digital wallet, into any bank account held by any financial entity that is assigned to each employee, and through various transfer/payment methods, now existing and later developed.

37. The unique subordinate digital wallet in claim 36, wherein one or a plurality of program instruction are operative to receive, from various sources, now existing and later developed, save, store, maintain, create, edit, manage, and allow the retrieval, displaying, and sharing through various data exchange methods, now existing and later developed, of, data related to bills to be paid; to set up pay-out-only-subaccount(s) that is generated, created and set up by utilizing and combining the “Default Digital Wallet Account Number”, as recited in claim 12, and additional digit(s), the additional digit(s) being number(s) and/or letter(s), for each bill to be paid; to periodically and/or at one time, transfer funds from the bank account of any financial instrument saved, stored, and maintained in a unique subordinate digital wallet, including from the bank account set up for a unique subordinate digital wallet, into any of the “pay-out-only-subaccount(s)” assigned to a particular bill; to record all transfer of funds thereto; and, at a time set by a user/operator, and once the funds in a “pay-out-only-subaccount” is available to pay a particular bill in full, to automatically process and execute the transfer of the funds from a “pay-out-only-subaccount” into the payee's bank account.

38. The unique subordinate digital wallet in claim 37, wherein one or a plurality of program instruction are operative to receive, from various sources, now existing and later developed, save, store, maintain, manage, and allow the retrieval and displaying of options of products to be purchased for the purpose of voting in a contest of sorts; and to process and execute the transfer of funds from the bank account of any financial instrument saved, stored, and maintained in a unique subordinate digital wallet, including from the bank account set up for a unique subordinate digital wallet, into the bank account of the host of a contest of sorts, in order to pay for the product purchased.

39. The unique subordinate digital wallet in claims 33, 34, 35, 36, 37, and 38.

40. The unique subordinate digital wallet in claim 39, wherein one or a plurality of program instruction are operative to run a security protocol, wherein an alert message is sent to the default mobile electronic device (or non-mobile electronic device) of the user/operator of that unique subordinate digital wallet, alerting that user/operator that a fund transaction is in the process of being executed, and requiring the authorization of the user/operator before executing the transaction.

41. The unique subordinate digital wallet in claim 40, wherein one or a plurality of program instruction are operative to receive, from various sources, now existing and later developed, save, store, maintain, and allow the retrieval and displaying of options for the purpose of voting in a contest of sorts, and to process and execute the transfer of the data of the selected option to the host of the contest of sorts.

42. The unique subordinate digital wallet in claim 41, wherein, one or a plurality of program instruction are operative to process and execute the transfer of funds from the bank account of any financial instrument saved, stored, and maintained in the unique subordinate digital wallet of a sender, including from the bank account set up for his unique subordinate digital wallet, into the bank account of any financial instrument saved, stored, and maintained in the unique subordinate digital wallet of a recipient, including into the bank account set up for his subordinate digital wallet.

43. The unique subordinate digital wallet in claim 42, wherein one or a plurality of program instruction are operative to run a security protocol, wherein the sender of the funds verifies the authenticity of the recipient's identity through the Central Financial and Personal Identification Information Interface (through the banking system) and the primary digital wallet database of unique subordinate digital wallets, whereby upon the verification of the authenticity of the recipient's identity, a “fund transfer alert message with inquiry” is sent to the default mobile electronic device (or non-mobile electronic device) of the recipient, requiring the recipient to confirm his entitlement to the funds and correctly respond to the inquiry, whereafter upon the sender confirming the recipient's entitlement to the funds, the funds is transferred to the bank account of any financial instrument saved, stored, and maintained in the recipient's unique subordinate digital wallet, including the bank account set up for his unique subordinate digital wallet, wherein through this process, a “fund transfer alert message” is sent to the default mobile electronic device (or non-mobile electronic device) of the sender of the funds requiring his authorization before the execution of the transaction.

44. The unique subordinate digital wallet in claim 43, wherein one or a plurality of program instruction are operative to receive, from various sources, now existing and later developed, save, store, maintain, create, edit, manage, and allow the retrieval, displaying, and sharing through data exchange methods, now existing and later developed, of, data of bills to be paid and payment(s) made toward these bills, to keep tack of bill(s) left to be paid.

45. The unique subordinate digital wallet in claim 44, wherein one or a plurality of program instruction are operative to connect the default mobile electronic device (or non-mobile electronic device) of a user/operator to the default mobile electronic device (or non-mobile electronic device) of another user/operator through their respective unique subordinate digital wallet and by using their respective digital wallet number, to communicate with each other through talking, texting and live chatting.

46. The unique subordinate digital wallet in claim 45, wherein one or a plurality of program instruction are operative to process and execute the log-out of a unique subordinate digital wallet, when its user/operator is done using it.

47. The primary digital wallet in claim 22, wherein one or a plurality of program instruction are operative to connect to the Central Financial and Personal Identification Information Interface (the banking system) and monitor all transactions either in process and/or consummated through any financial entity, using any financial and personal identification information saved, stored, and maintained in a unique subordinate digital wallet, and to further send a transaction alert message to the default mobile electronic device (or non-mobile electronic device) of the user/operator of a unique subordinate digital wallet whenever a transaction using his financial and/or personal identification information either is in the process of being executed or has been consummated, and to yet further require the authorization of the user/operator before a transaction in process to be executed is executed.

48. The primary digital wallet in claim 47, wherein one or a plurality of program instruction are operative to customize all generated, created, and set up unique subordinate digital wallets, by adding/activating and/or deleting/deactivating selected program instruction of enhancement and application to adapt the unique subordinate digital wallets to society changes, and to further save, store, and maintain all modifications into the primary digital wallet and all unique subordinate digital wallets.

49. The primary digital wallet in claim 48, wherein one or a plurality of program instruction are operative to process and execute the transfer of funds in the amount of a set service fee from a designated bank account of any financial instrument saved, stored, and maintained in a unique subordinate digital wallet, including from the bank account set up for a unique subordinate digital wallet, into the bank account designated by the primary digital wallet, whenever a transfer of funds is consummated through a unique subordinate digital wallet.
